(19) United States
(12) Patent Application Publication
(10) Pub. No.: US 2007/0266553 A1
(43) Pub. Date: Nov. 22, 2007

(54) Process And System For Joining Battery Plates To Form Packs And For Inserting These Packs Into Cassettes

(75) Inventor: Markus Schlogl, Hartberg (AT)

Correspondence Address: YOUNG & THOMPSON, 745 SOUTH 23RD STREET, 2ND FLOOR, ARLINGTON, VA, 22202, US

(73) Assignee: GD TECHNOLOGIES MASCHINEBAU GMBH, Ebersdorf Bei Hartberg (AT)

(21) Appl. No.: 11/667,569

(22) PCT Filed: Nov. 7, 2005
(86) PCT No.: PCT/AT05/00437

§ 371 Date: May 11, 2007

(30) Foreign Application Priority Data
Nov. 22, 2004 (AT) A 1956/2004

(51) Int. Cl. H01M 6/00; B23P 19/00

(52) U.S. Cl. 29/623.1; 29/284; 29/650

(57) ABSTRACT

A system in which bridges (16, 18) with flanges (17, 19) for intercell connectors (24) connect positive lugs (12), on the one hand, and negative lugs (14), on the other, are, in a casting station (270), cast onto the lugs (12, 14) of positive and negative battery plates, which are assembled to form packs (10), after subjecting the lugs (12, 14) to a pretreatment by brushing and with flux. The packs (10), which are comprised of battery plates and which are provided with bridges (16, 18) in the aforementioned manner, are placed inside compartments (22) for cells in battery cases (20) while being arranged in groups each consisting of three packs. Cassettes (30) are used for moving the packs (10) of battery plates, and the packs (10) are held in these cassettes while being squeezed between fixed and moving partitions (305, 307). The packs (10) are placed inside these cassettes (30) in such a manner that solely lugs (12) of positive plates are placed on one longitudinal side, and solely lugs (14) of negative plates are place don the other longitudinal side.

The invention relates to a process and a system for connecting lugs of battery plates (positive and negative plates) by bridges, in which the packs of battery plates obtained in this way, with lugs which are interconnected by bridges, can be inserted into battery cases.

Various systems are known for connecting lugs of battery plates by bridges. A system from DAGA S.r.1. in Centro Colleoni Palazzo Andromeda, I-20041 Agrate Brianza, Milan (IT) (“COS/2000 & 1000 CAST ONE STRAP SYSTEM”) is known with which the battery plates which have been inserted into holders are moved step by step from station to station in order to execute individual working steps with the objective of connecting the lugs by bridges.

For connection of lugs of battery plates by bridges, which are then inserted into battery cases, round cyclic tables are known (manufacturer: TBS Engineering, Ltd. Cheltenham, U.K. and Sovema S.p.A in Villafranca, Italy). These known round cyclic tables have four carriers for the battery plates which are to be machined and which continue to be moved step by step.

The disadvantage in the known processes and systems is that their efficiency is limited and they can only be adapted with difficulty to different battery types (passenger car batteries, truck batteries or batteries for industrial purposes such as fork lifts and the like).

The object of the invention is to present a process and a system with which the efficiency can be increased and production of packs of battery plates with lugs which are to be connected to one another by bridges, and their insertion into battery cases can be made more efficient and done more quickly.

This object is achieved first of all with a process which has the features of the independent process claims.

To the extent the system as claimed in the invention is affected, this object is achieved with a system (device) which has the features of the independent apparatus claim.

Preferred and advantageous embodiments of the process and the system of the invention are the subject matter of the dependent claims.

With the process as claimed in the invention, performance of up to six (6) to nine (9) batteries per minute is possible. Moreover the invention allows simple integration of all working steps into the process and the system.

The process and system of the invention can be easily adapted to user requirements by the linear and modular concept preferably implemented in the invention.

In the invention it is advantageous that the individual steps can be easily performed, that all stations of the system are easily and efficiently accessible and that both the process and also the system can be made flexible. This is especially the case when the transport cassettes proposed as a preferred component of the invention can be used for transport of the plate packs in the execution of the process as claimed in the invention.

In one sample embodiment the system as claimed in the invention comprises a stable machine frame with integrated ventilation channels and safety covers. In the optionally provided machine frame of the system as claimed in the invention all components for transport of cassettes into which the battery plates are inserted, the ventilation channels and wiring can be integrated.

For safety reasons most regions can be covered with protective covers (for example polycarbonate disks with aluminum frames) which can be provided with safety switches. This versions allows simple access to all system parts for cleaning and maintenance.

In one sample embodiment, in the invention there is an inherently closed path of movement with four (straight) movement segments, on the comers of which there are transfer stations for the preferably used cassettes in which the plate packs are transported.

For example, the first segment of the path of movement transports empty cassettes into one or two loading stations and out of the latter via a lug and plate alignment station to the first transfer station. In the first transfer station the direction of travel of the cassettes is changed by 900 so that they can be transported along the second path of movement.

The second segment of the path of movement is for example divided into four partial sections. The first partial section moves the plate-loaded cassettes in steps out of the first transfer station to a lug bending station, to a rotation station and to a station for brushing the lugs of the battery plates.

In one embodiment the second partial section of the second segment of the path of movement moves the cassette—if there is free space in one or two downstream buffer stations—out of the station for treating the lugs with flux (flux station) into one buffer region and moves one cassette at a time out of the lug brushing station for treatment with flux. In the next working step the second partial section of the second path of movement moves one, two or three cassettes into a casting station in which the bridges are cast onto the lugs.

The third partial section of the second segment of the path of motion moves the cassettes in one sample embodiment into two or three casting stations and moves them each farther by two or three steps.

The fourth section of the second segment of the path of movement in one sample embodiment transports the cassettes individually through a buffer region and via a turning station to the second corner transfer station.

The third segment of the path of movement in a sample embodiment conveys the cassettes from the second transfer station to the third transfer station. In this third segment of the path of movement there is one station for removing packs from transport cassettes. This station can have two parallel transfer devices (gripper sets) which each remove three plate packs. The removed plate packs are inserted from the parallel transfer devices into compartments for the cells in the battery cases in this example.

The empty cassettes from the third transfer station are moved via the fourth segment of the path of movement back to the first segment of the path of movement in one sample embodiment. This fourth segment of the path of movement closes the circuit via a fourth transfer station and conveys empty cassettes back to the first segment of the path of movement.

The cassettes preferably inserted within the framework of the invention are designed for example either for passenger car batteries, truck batteries or VRLA batteries. The cassettes for truck batteries are set up such that they can be loaded with plate packs for six cells with a thickness of 22 to 55 mm. The cassettes for truck batteries can be loaded with plate packs for six cells of 50 to 120 mm. Both cassette sizes can also be used for so-called VRLA (valve-regulated lead acid) batteries.

In one preferred embodiment of the invention the cassettes in the loading station are automatically opened for loading with plate packs by moving spring-loaded walls in order to move then away from fixed walls of the cassettes. After loading, the cassette is closed and the plate packs are clamped between the spring-loaded movable walls and the fixed walls. Similar movements of the movable walls for releasing or fixing of plate packs in the cassettes are carried out in stations for alignment of the lugs and battery plates, and in the unloading station in order to “release” the plates.

In one embodiment in the loading station six grippers are used to pick up the packs of battery plates (positive plates and negative plates) from the conveyor and to insert them into the cassettes. The layout of the loading station can be equipped for example either as a parallel gripper or for example with a pivoting arm depending on circumstances. In one preferred embodiment for the loading station as claimed in the invention matching to different plate widths is not necessary. Different plate heights are equalized by for example adjusting the table underneath the cassettes according to the plate height.

To handle plates for passenger vehicle batteries on the one hand and truck batteries or VRLA batteries on the other the grippers of the loading station can be interchanged. The station for aligning the lugs and battery plates can be easily adapted to the different lug positions. In addition to this adjustment, in certain cases adjustment with respect to plate height is necessary so that all top lug edges are located at the same height (flush with the top edge). No adjustment is necessary for different plate widths.

The six plate packs in one sample embodiment are aligned not only to the sides, but also on the lugs in order to ensure correct alignment. A vertically adjustable table on which the plates rest during alignment can be made with an (electrical or pneumatic) vibration generator. The adapter plate for different plate heights can interchanged in one embodiment without a tool.

In the station for bending of lugs which can be equipped differently for passenger car batteries on the one hand and for truck batteries on the other, in one sample embodiment the outer lugs of each plate pack are bent so that they can be easily inserted into a casting mold later. In this station adjustment for different lug positions or alignments is not necessary.

In one sample embodiment in the next station the cassettes with the plate packs which have been clamped are again turned by 180° so that the lugs now point down.

In one sample embodiment, in an underlying station the lugs of the plates are brushed bare with two rotating round brushes (steel brushes).

In one sample embodiment, in the next station the lugs are treated with flux by their being immersed into a flux bath. The flux bath is preferably contained in foam plastic, i.e. the foam is impregnated with flux. The level of the flux in the foam plastic (elastic foam plastic) is automatically monitored. Optionally in this station there is also a means for drying the lugs after their treatment with fluxes (“fluxing”).

If necessary there can additionally be a tin-plating station in which the lugs are tin-plated.

In one sample embodiment in the next station the bridges which interconnect the lugs of the positive plates on the one hand and the lugs of the negative plates on the other are cast on. Here it is provided that all lugs of positive plates are located on one side and all lugs of negative plates are located on the other side of the mold. All molds for casting-on of the connecting bridges work independently of one another. Preferably the molds are preheated on a preheating table.

Lead (or a lead alloy) for casting the connecting bridges to the plate packs can be melted electrically or by heating with gas. Proportioning of the molten lead when coating the casting molds can also proceed completely automatically.

In one sample embodiment, after casting-on of the bridges (preferably of lead or a lead alloy) the cassettes are conveyed into the next station in which the cassettes are turned again, so that the lugs which now are interconnected via (lead) bridges point up again.

In one sample embodiment, in the subsequent unloading station three and three packs at a time for cells are removed in succession by gripper sets. Each gripper set of the station for removing plate packs is equipped for example with three (slender) grippers. In one sample embodiment the grippers move parallel and ensure in this way reliable gripping and insertion of the finished plate packs into battery cases. It is preferable here that the first three cells are removed from the cassette by the first three grippers of the first parallel transfer device of the unloading station and are inserted into a battery case into its compartments for cells 1, 3 and 5. The plate packs for cells 6, 4 and 2 are removed from the cassette by the second parallel transfer device of the unloading station and are inserted into the battery cases into the compartments for cells 6, 4 and 2.

In order to ensure insertion of the plate pack into the compartments for the cells in the battery case, there can be a guide, especially one of sheet metal (steel sheet) or plastic, above the battery case.

A transport device for supplying battery cases provides for the battery cases into which the plate packs are to be inserted to be each located exactly in the region of the unloading stations.

The system as claimed in the invention can be provided with a bucket belt-like vertical storage for changing from cassettes for plates for passenger car batteries on the one hand to cassettes for truck batteries on the other and vice versa. Examples include stacking devices (bucket belt-like vertical storages) for these cassettes.

Embodiments of a system as claimed in the invention with which the process of the invention can be implemented are described below.

First Station:

Insertion of six plate packs into holders (transport cassettes) by means of a 6-x gripper system (either parallel offset of plate packs or by means of a 90° pivoting gripper).

Second Station:

In this station the plates and their lugs are aligned, for alignment of the plates their clamping being partially canceled in the cassettes and the plates being knocked by strips (straightening strips) in order to align them flush with one another. The analogous is done with the lugs by other straightening strips. The plate packs are clamped again in the cassettes again after alignment.

Third Station:

Corner transfer device: here the direction of motion is changed by 90° (clockwise).

Fourth Station:

In this station the (two) outermost lugs of each plate pack at a time are bent inward; this is important for casting-on of the bridges. For this purpose there are bending strips with wedge surfaces and with a stop, the two outer lugs being bent inwardly by the wedge surfaces, so that they are “sloped”.

Fifth Station:

In this station the cassettes are turned with the plate packs clamped therein such that the lugs point now down. For this purpose there is a hoop-shaped holder with two cone-like pins which fit into the corresponding recesses on the narrow side of the cassettes, a rotary drive being assigned to the cone which engages positively.

Sixth Station:

In this station the lugs are brushed so that they are bare. To do this there are two elongated brush rollers (wire brush rollers) which are driven in opposite directions. Underneath the brush rollers there is a catch trough with suction for the material which has been brushed off the lugs.

Seventh Station:

In this station, before casting on the bridges, the lugs are treated with flux. For this purpose, in the station there is a trough in which a sponge is held which is impregnated with flux. This trough is raised until the lugs are immersed into the sponge with the flux. After lowering the trough, hot air is blown through side pipes onto the lugs to dry them.

Alternatively, a flux can also be applied by (slowly) rotating (plastic) brushes. These brushes which can be especially round brushes are supported such that their sections (bristles) which point down dip into at least one trough with flux.

Eighth Station:

In this buffer station cassettes with plate packs with lugs which have been treated with flux are combined so that two and two or three and three cassettes are always moved forward.

Ninth Station:

In this station the bridges with the flanges for intercell connectors and the pole pins are cast on. Here it is such that the plates are inserted into the cassettes such that on one lengthwise side there are only lugs of positive battery plates and on the other side only lugs of negative battery plates. This makes it possible to take into account the different thicknesses and sizes of the positive lugs on the one hand and the negative lugs on the other when the bridges are being cast on by the different cooling behavior of the lugs which is due to the different masses of the lugs being taken into account.

Tenth Station:

This is a buffer station similar to the eighth station.

Eleventh Station:

In this station the cassettes are again turned such that the lugs with the now cast-on bridges, flanges for intercell connectors and pole pins point up.

Twelfth Station:

The direction of movement is changed by 90° in this corner transfer device (clockwise).

Thirteenth Station:

In this station the plate packs with lugs which are each connected by bridges are inserted into battery cases. The procedure here is such that the FIRST, SECOND and THIRD plate pack is picked up by the first parallel transfer device from the cassettes and inserted into a battery case (into compartments ONE, THREE and FIVE) for cells. With the second parallel transfer device the FOURTH, FIFTH and SIXTH plate pack are inserted into battery cases turned around the vertical axis by 180° into compartments SIX, FOUR and TWO for cells. This results in that, as provided in batteries, alternatingly on one (lengthwise) side there are positive lugs connected by bridges and on the other (lengthwise) side there are negative lugs connected by bridges so that the bridges can be interconnected correctly in terms of poles via the intercell connectors which penetrate the partition between the compartments for the cells of the battery cases.

The grippers of the parallel transfer devices of these thirteen stations are set up such that they can each pick up three plate packs. For this purpose the grippers are made narrow and have two tongues, one movable and the other fixed. The movable tongue is moved by a wedge which can be moved up and down into the clamp position and back (return motion via spring force). For picking up a plate pack the three grippers are inserted into the cassette, first for the first, second and third pack, there being play of roughly 5 mm between the stationary tongues of the grippers on the plate pack. Then there is movement by 5 mm so that the fixed tongues adjoin the plate packs. Then the movable tongues are moved so that the plate packs are clamped between the tongues of the grippers. In order to align the plate packs which are being held by the grippers at a mutual distance which corresponds to the distance of the compartments for the cells in a battery case, two of the three grippers are movable, in a ratio 1:2, i.e. the middle gripper has feed movements half as large as the outer gripper which is opposite the stationary gripper. To insert the (battery) plate pack funnel-shaped sheet metal arrangements are seated on the battery case as insertion aids.

The raising of the battery case upon insertion is limited vertically by step-shaped stops to be able to take into account different sizes of the plates.

For turning the battery case by 180° (vertical axis) part of the (roller) conveyor can be raised and turned by 180°.

Fourteenth Station:

Corner transfer device

Fifteen Station:

Cassette return system with integrated bucket belts for automatic changing of cassettes (passenger car battery—truck battery).

Sixteenth Station:

Corner transfer device

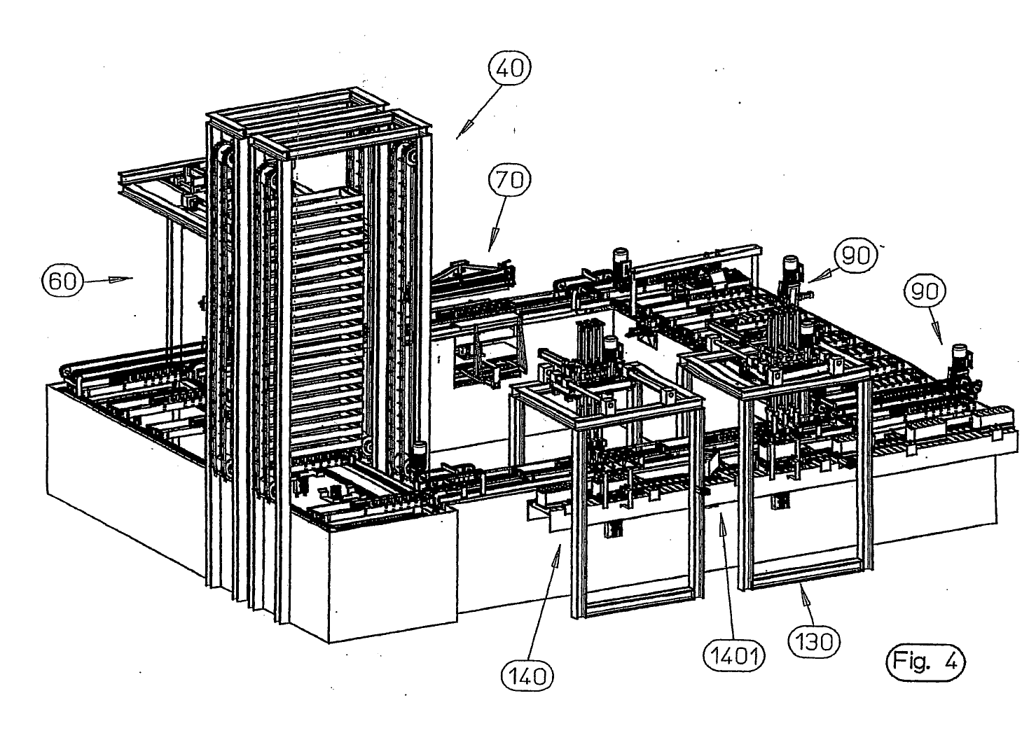

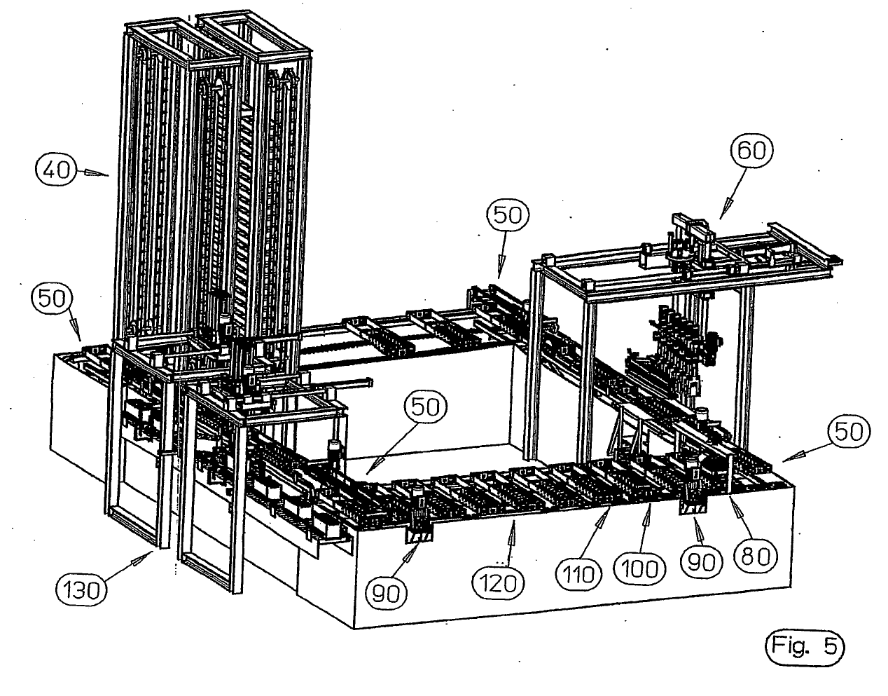

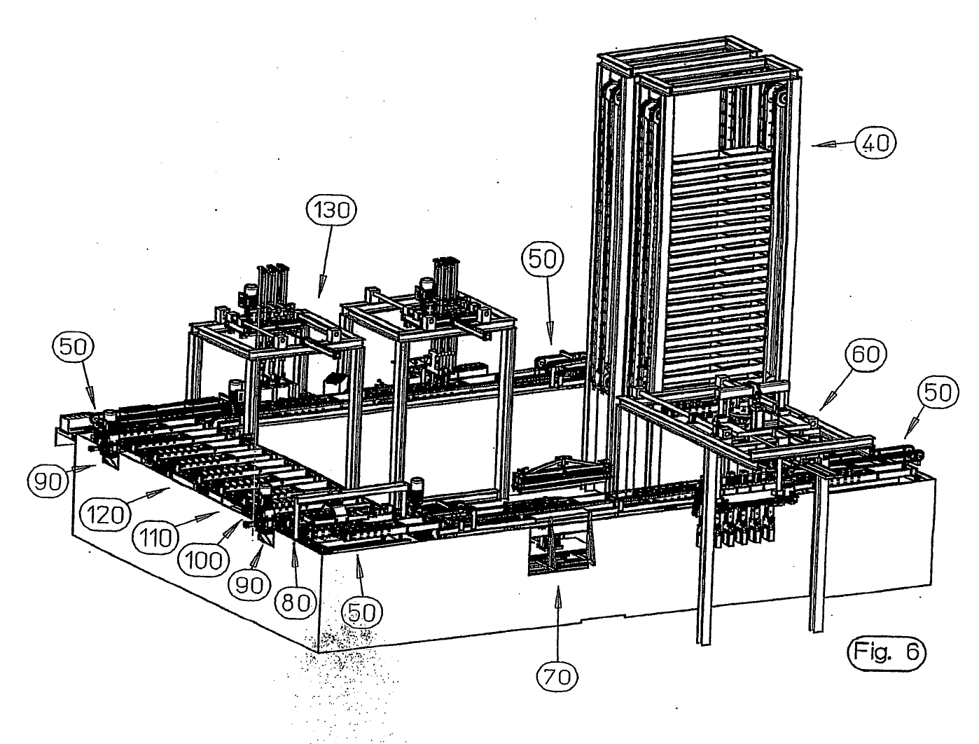

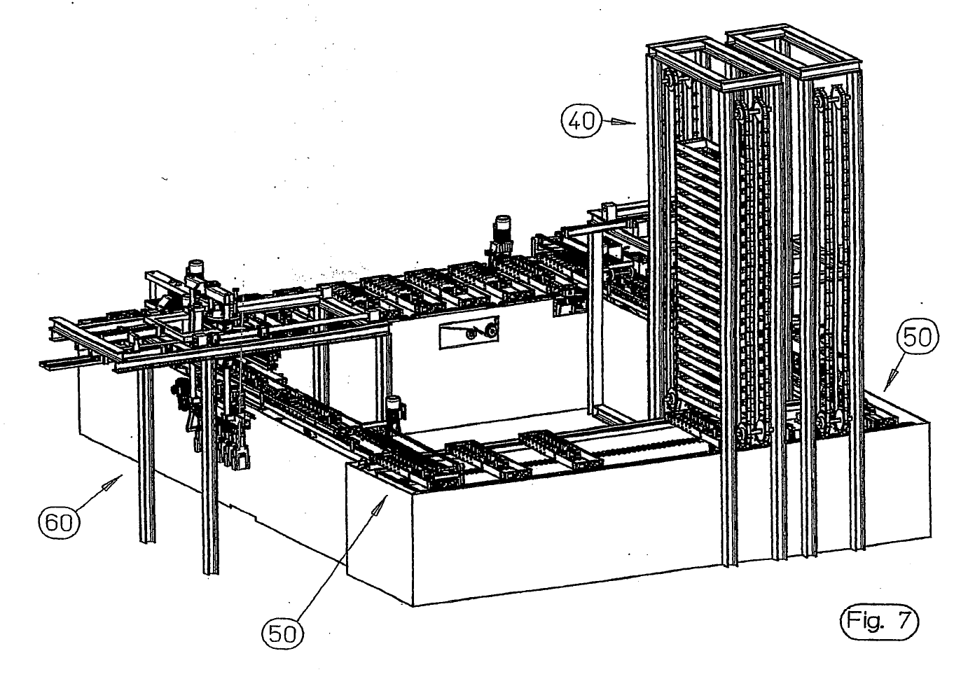

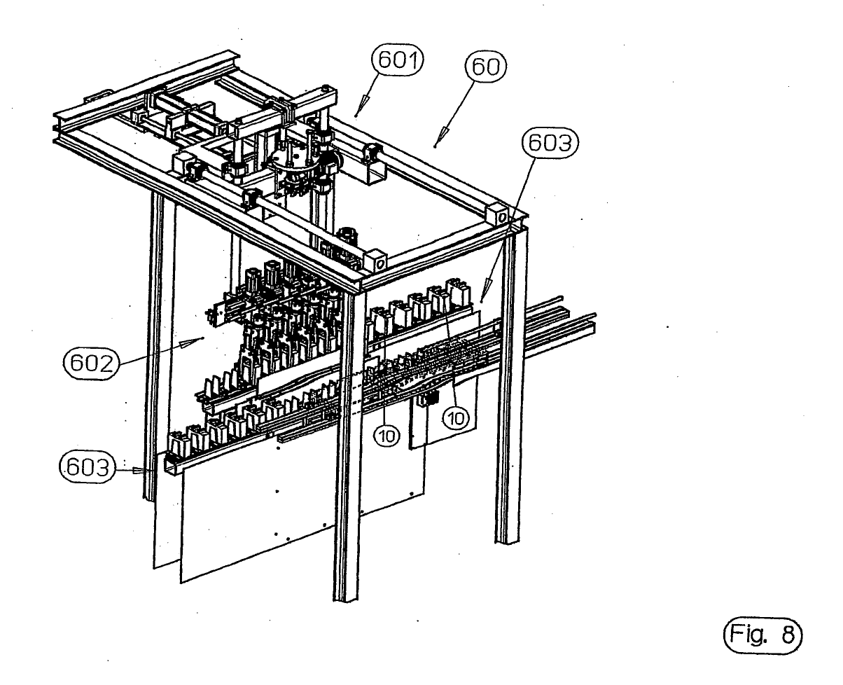

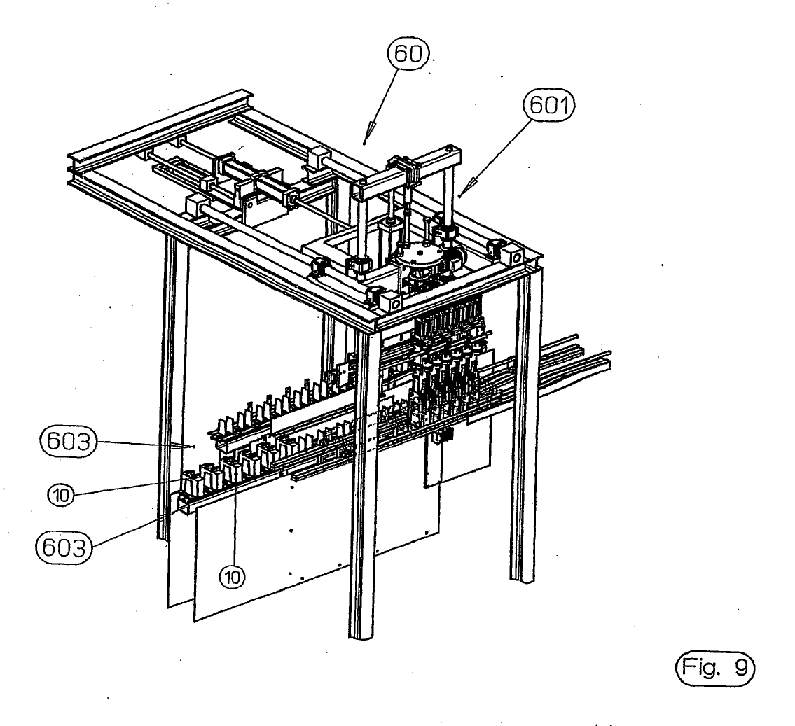

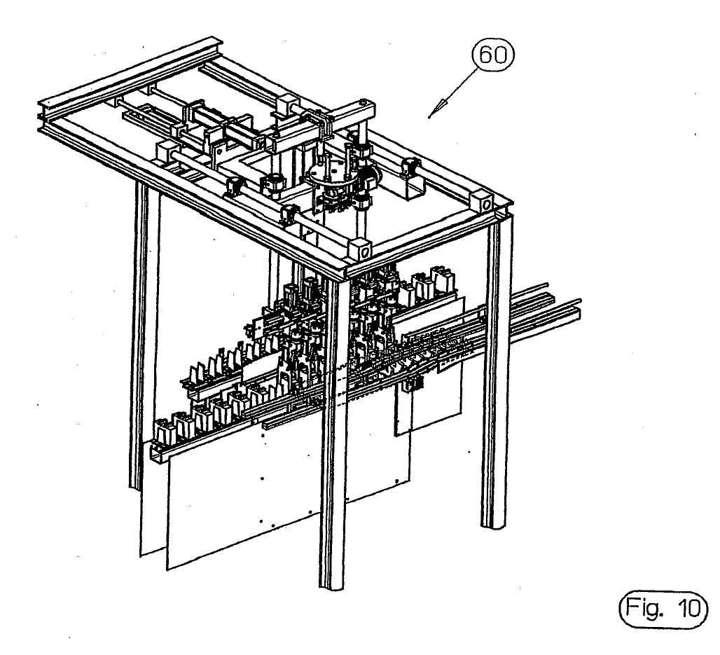

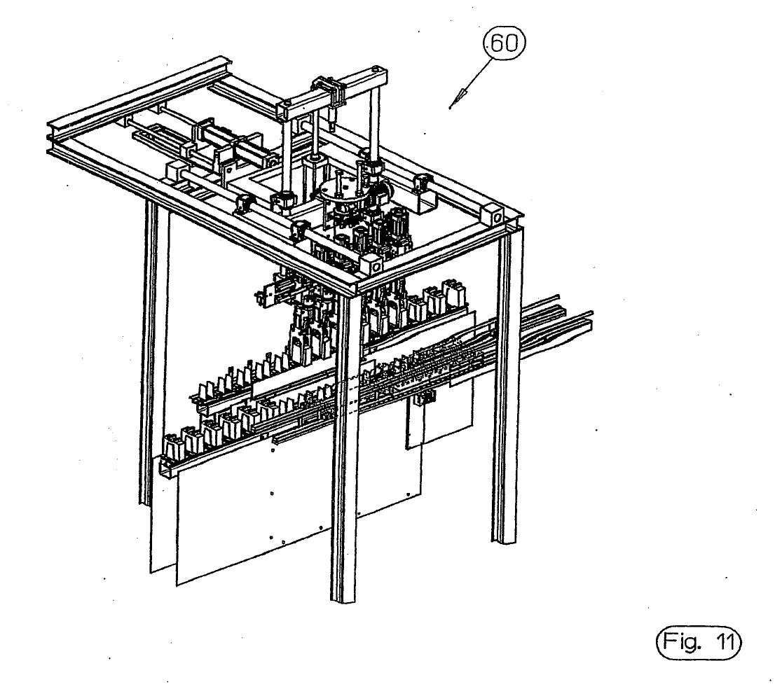

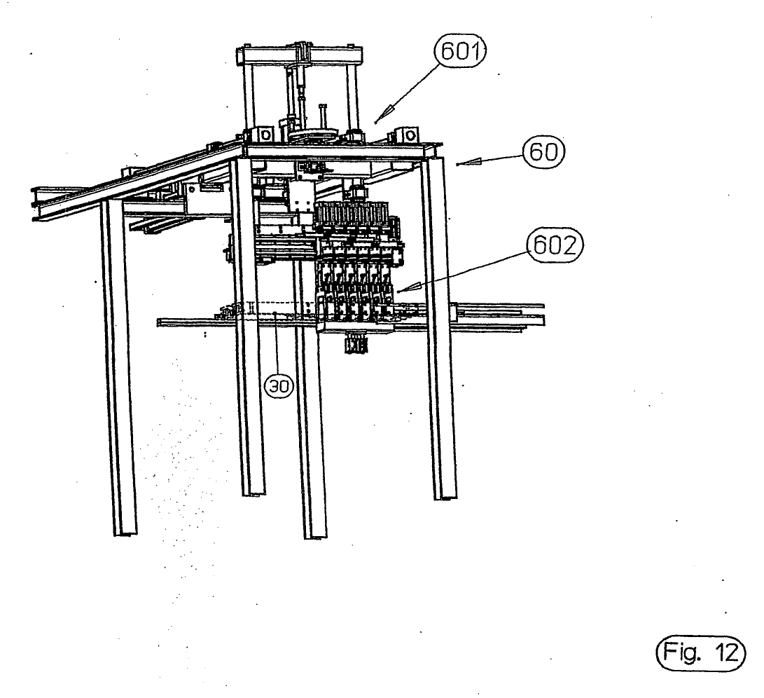

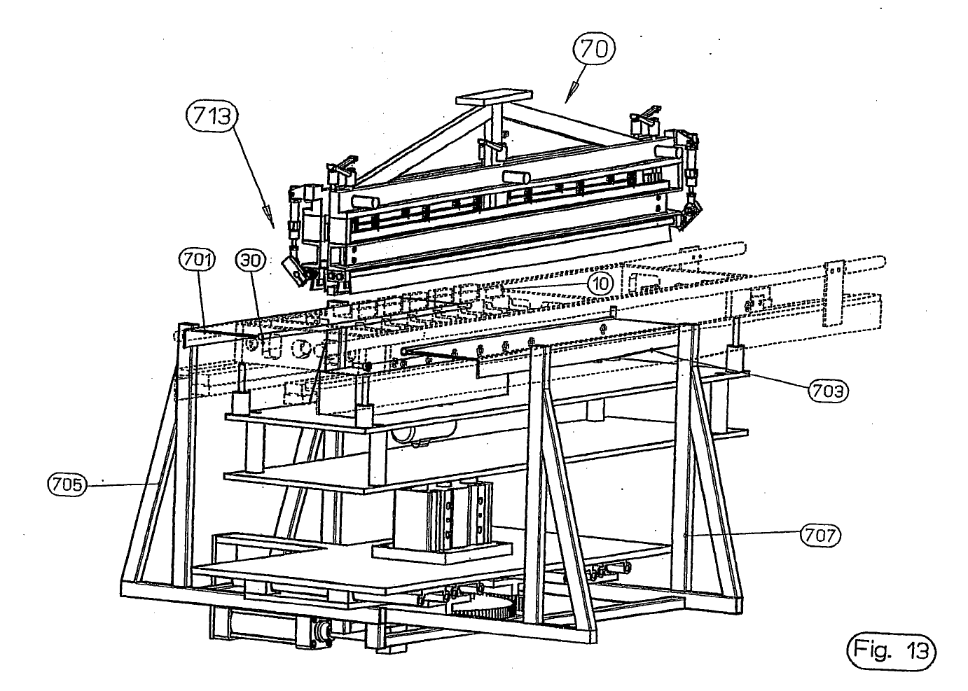

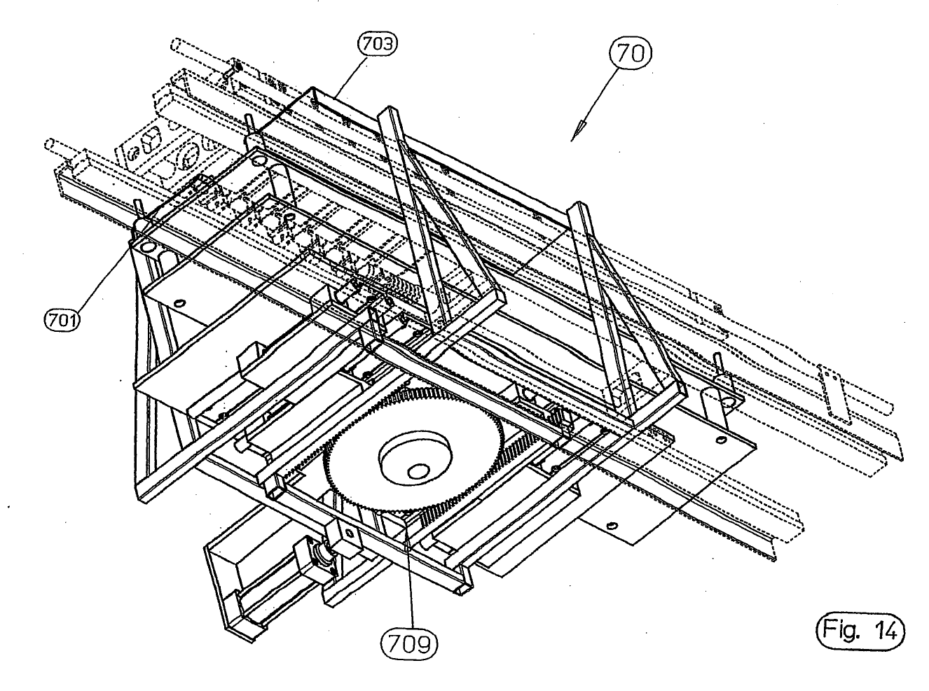

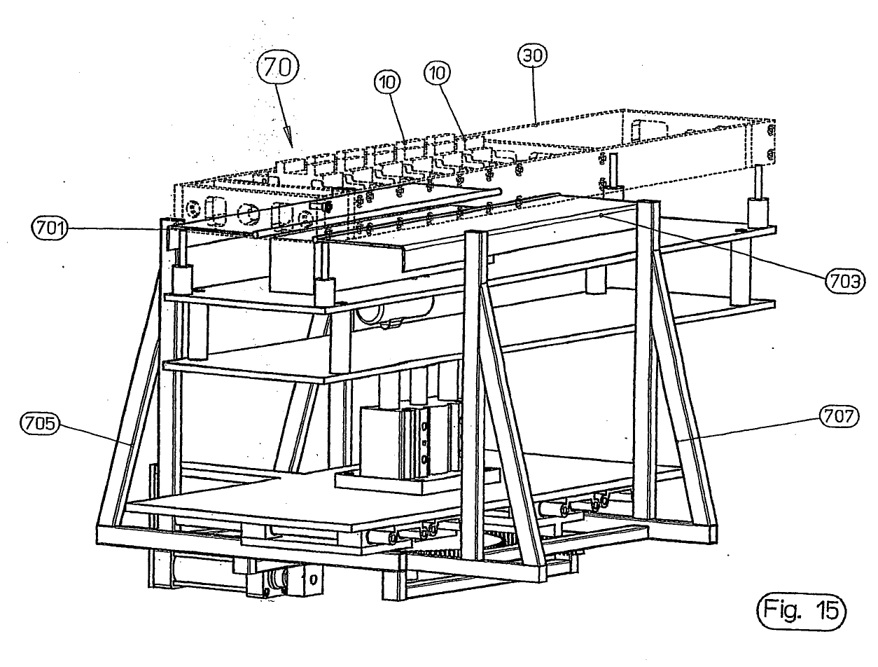

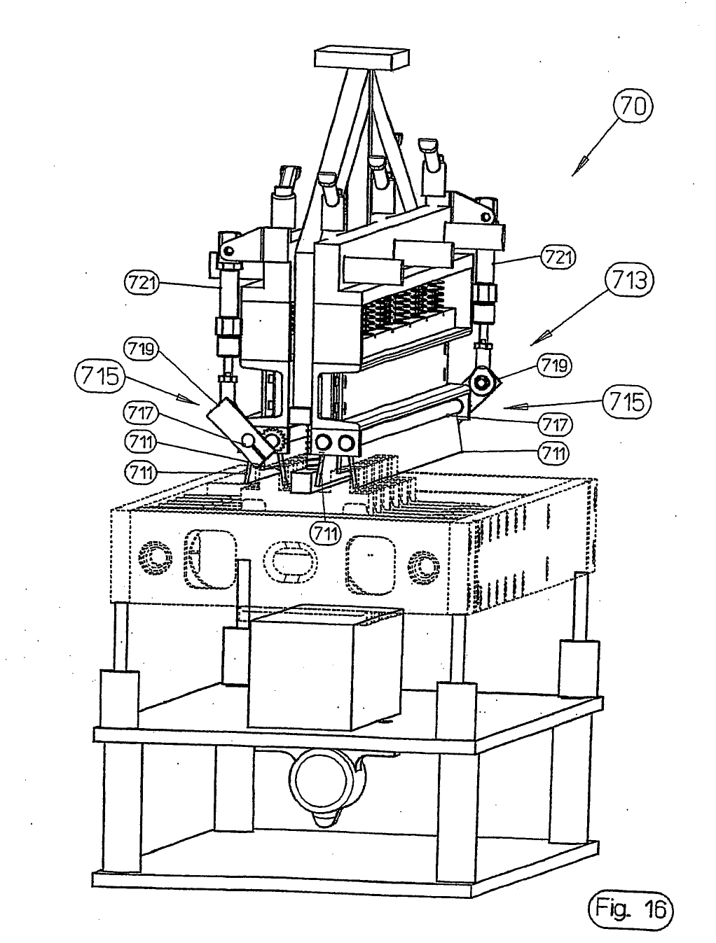

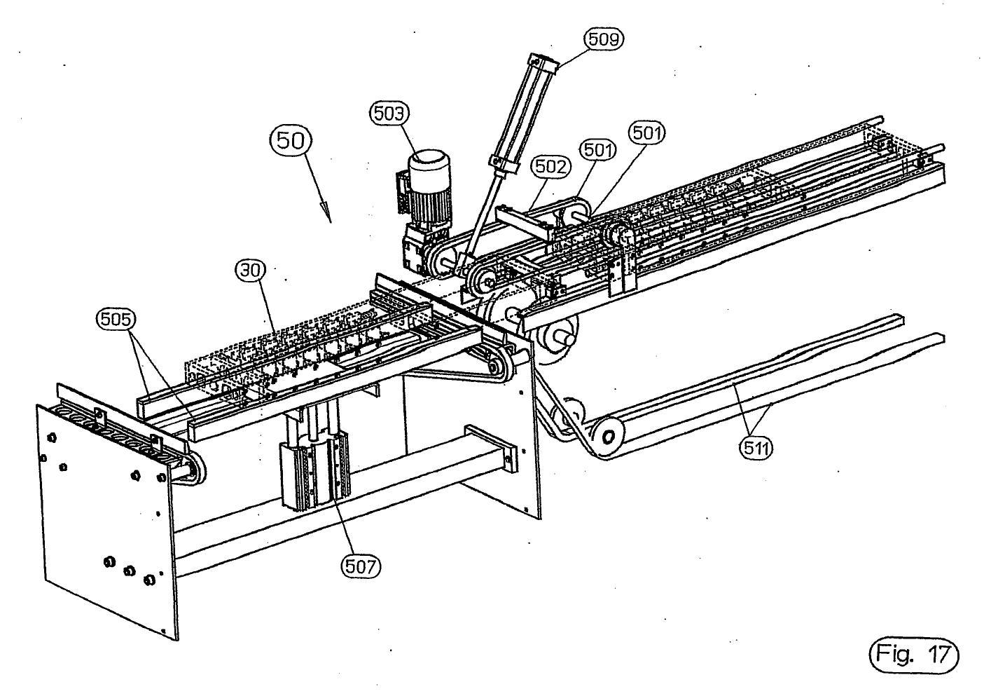

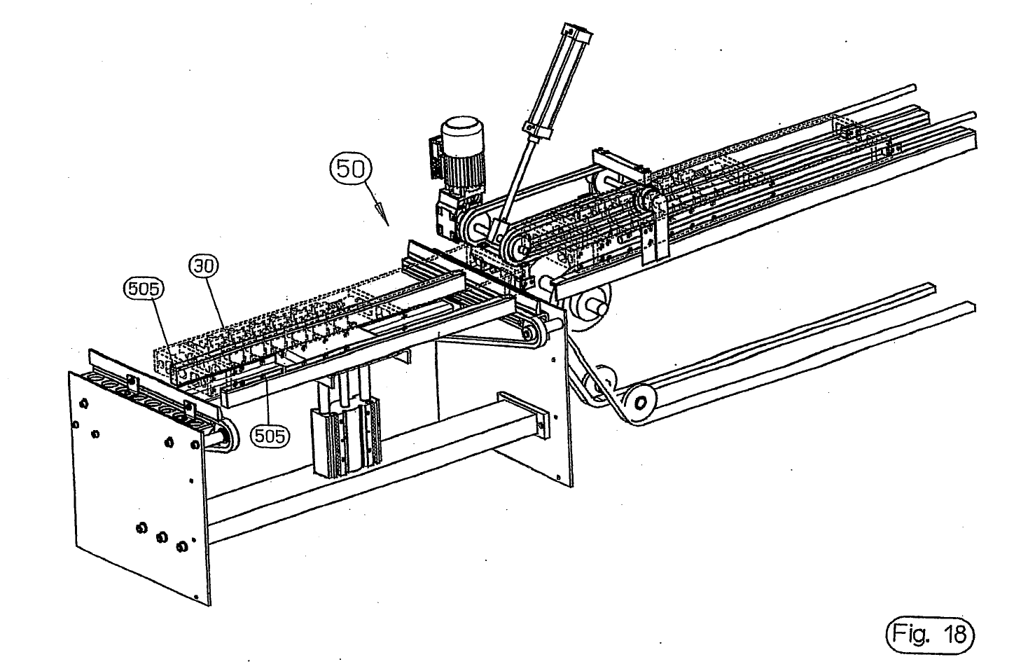

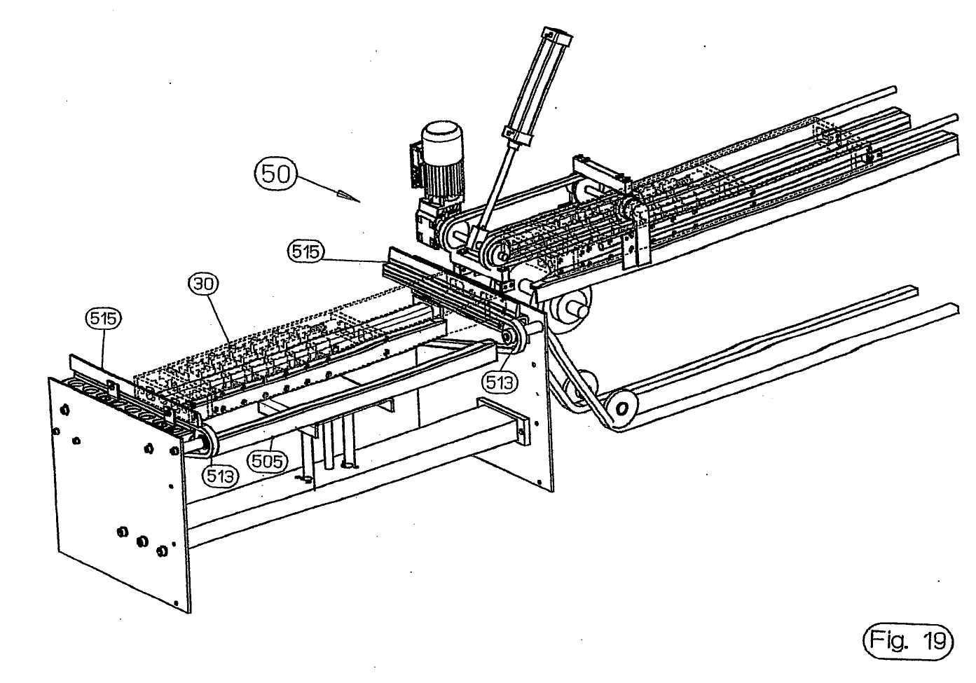

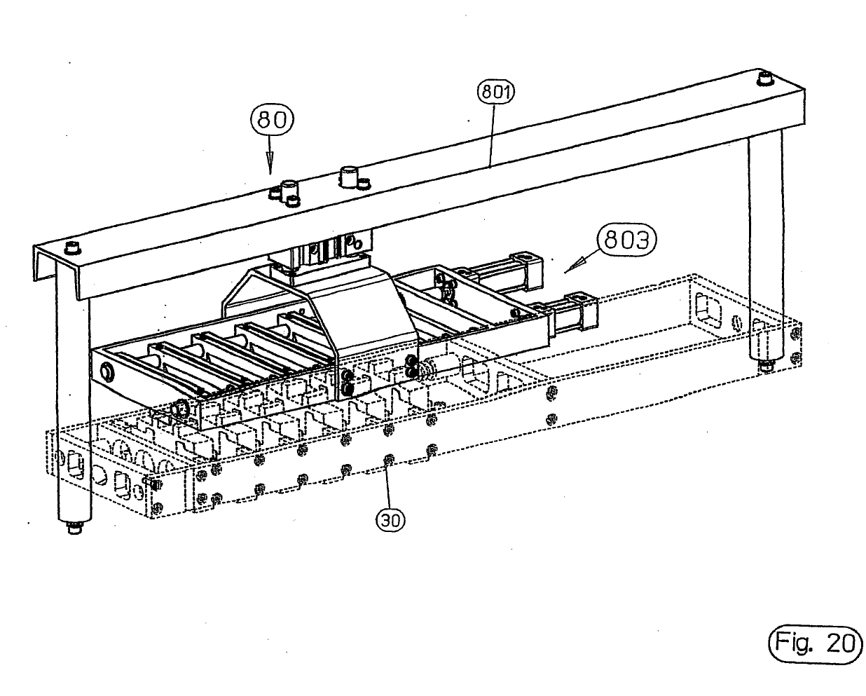

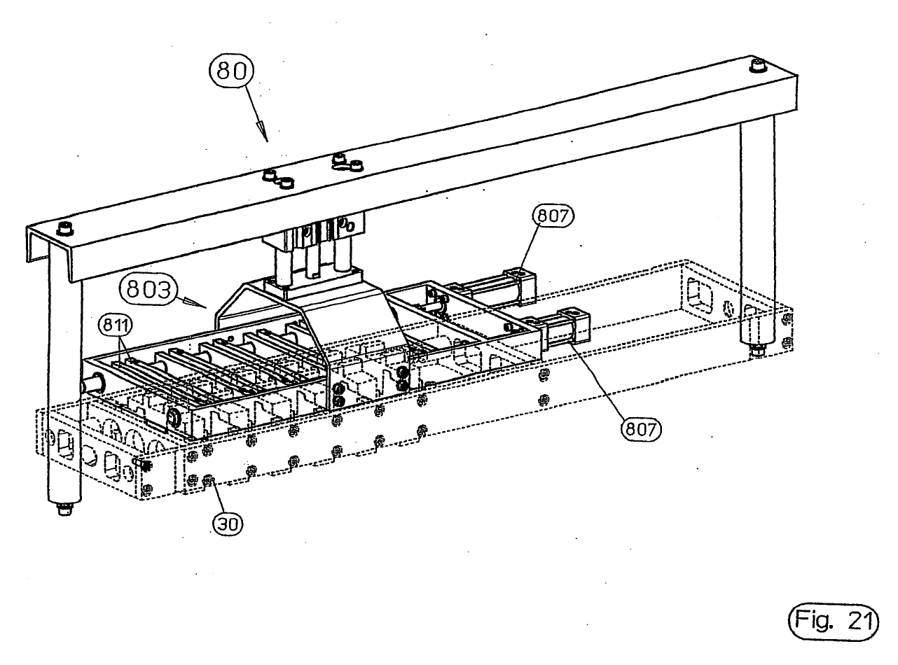

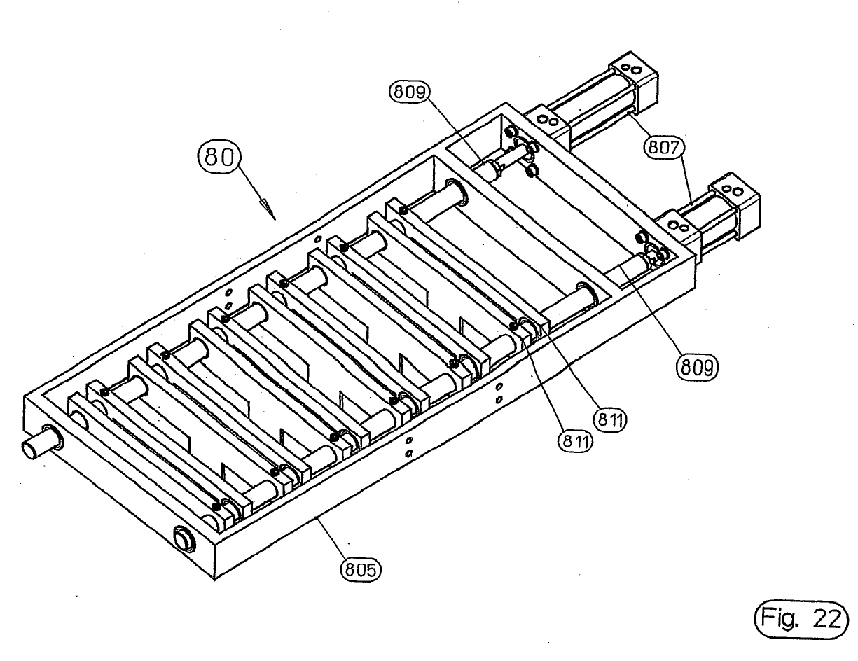

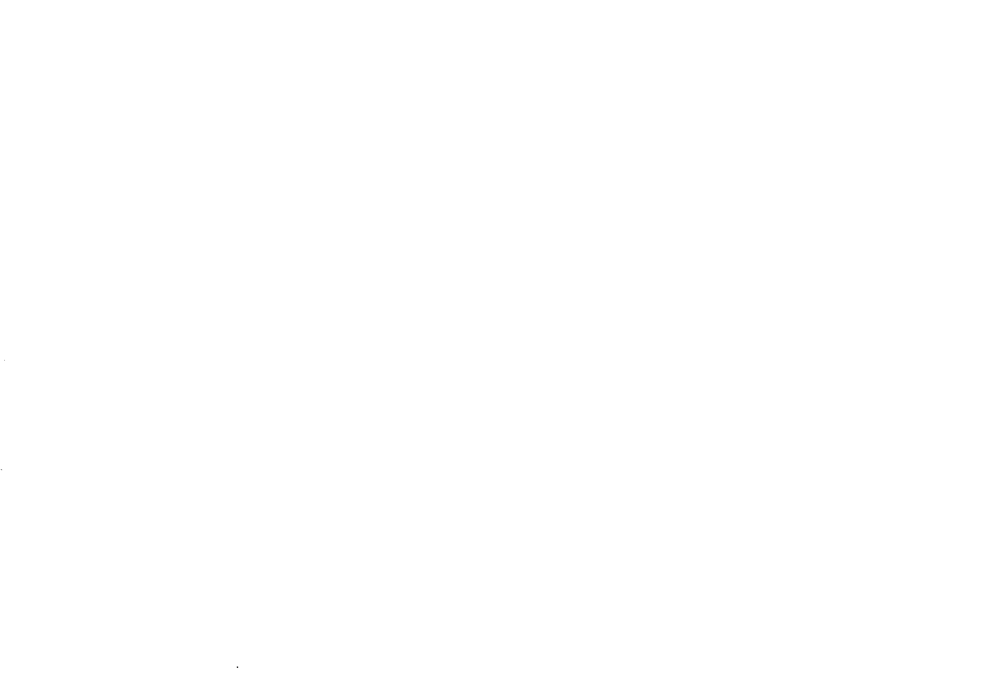

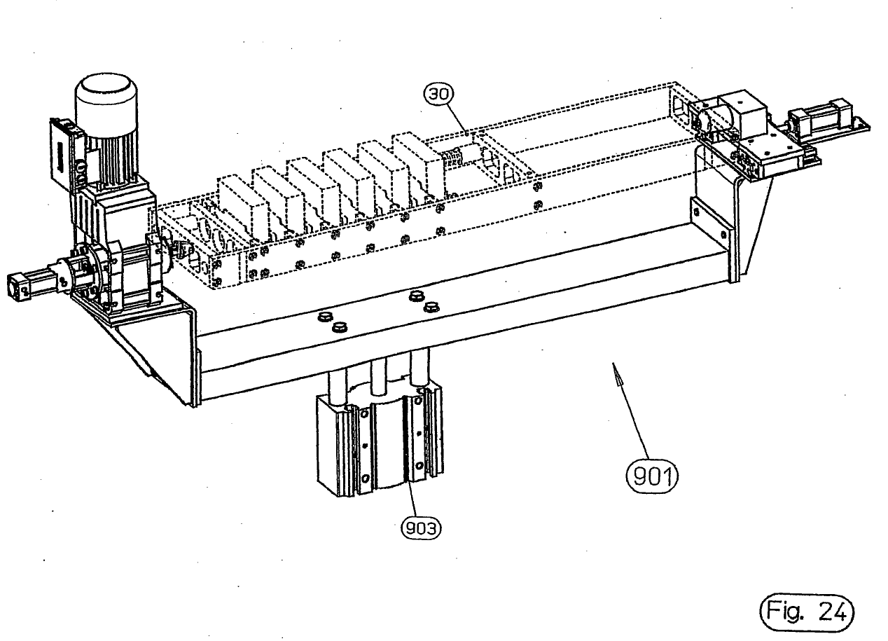

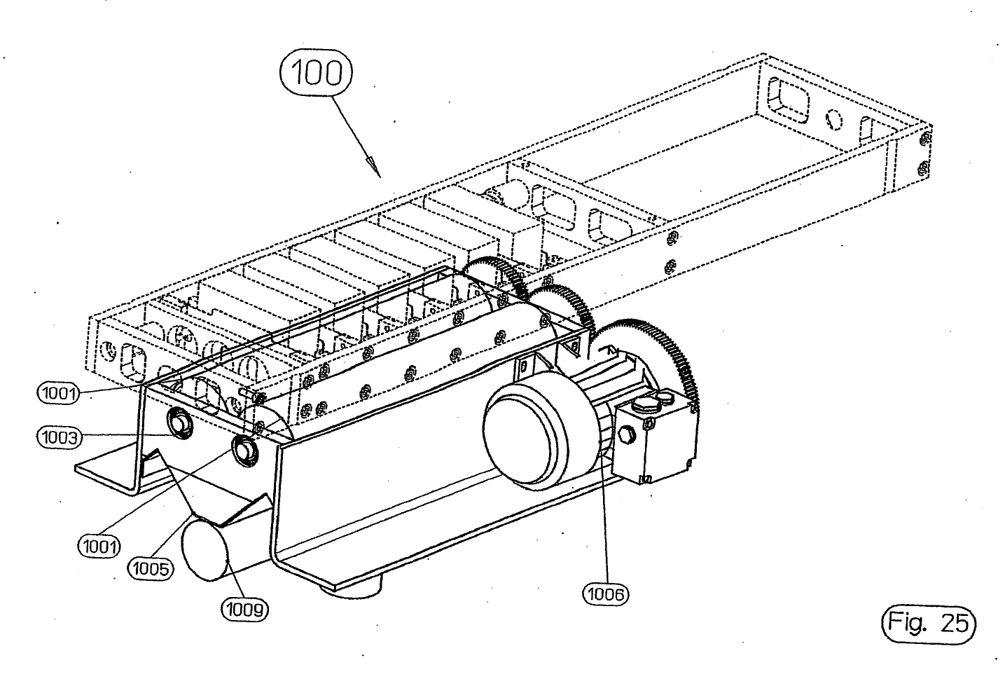

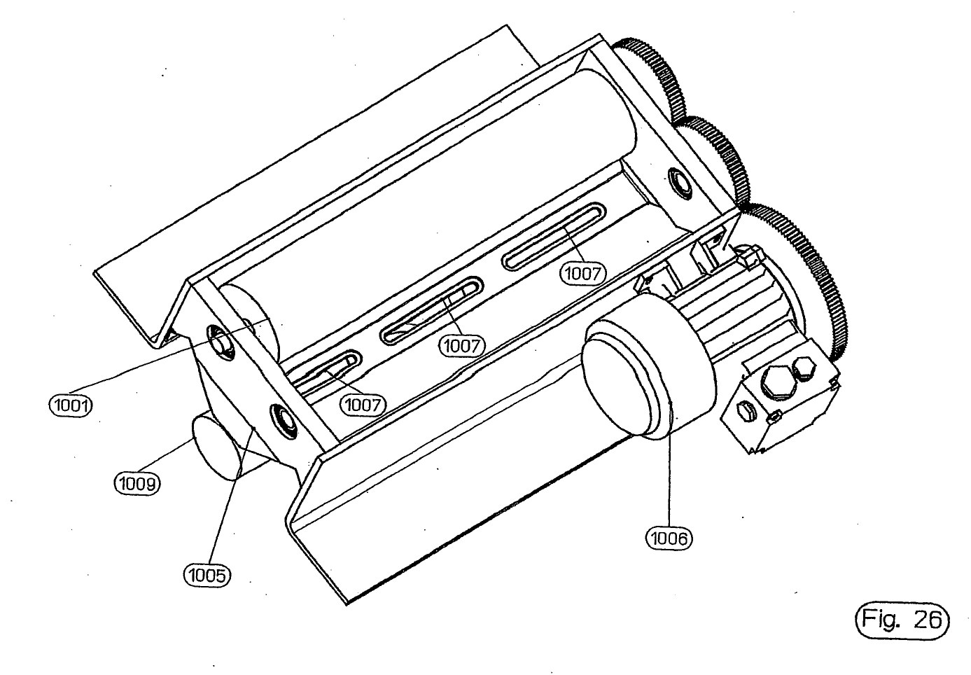

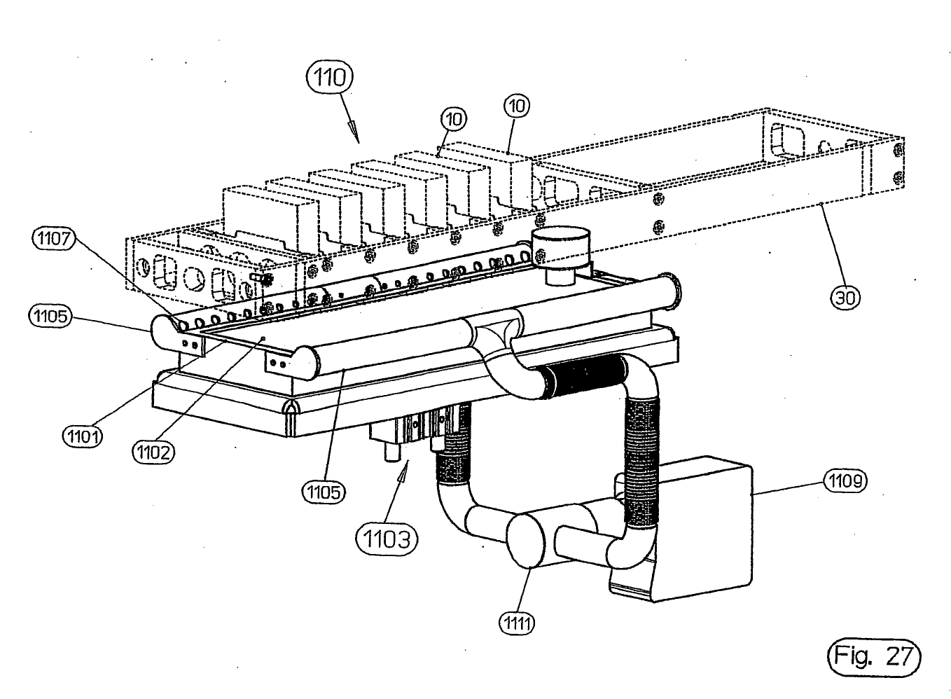

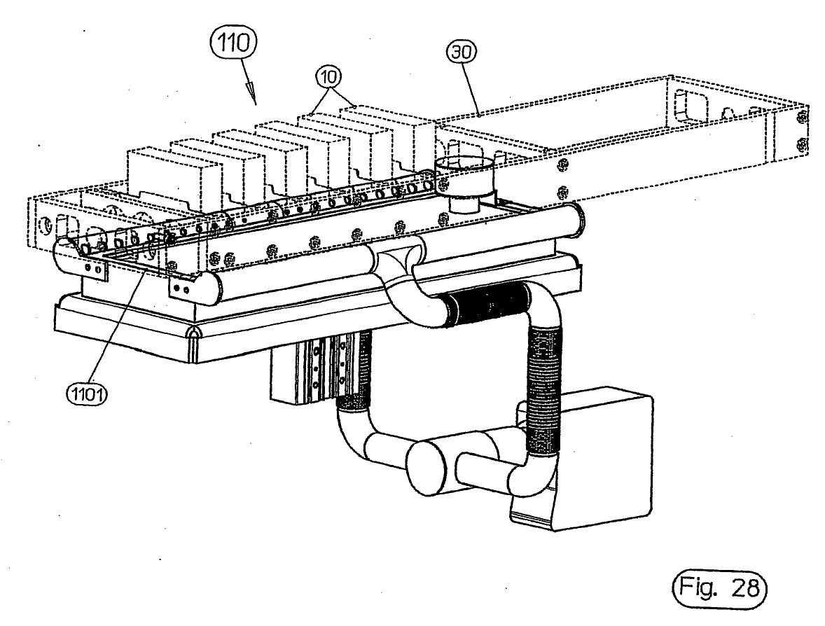

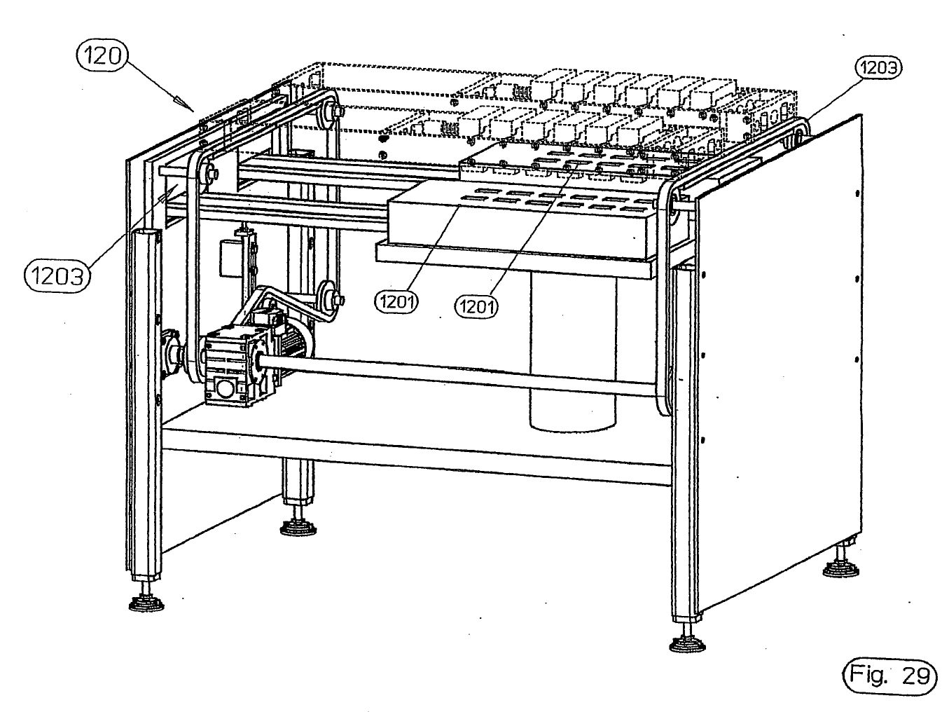

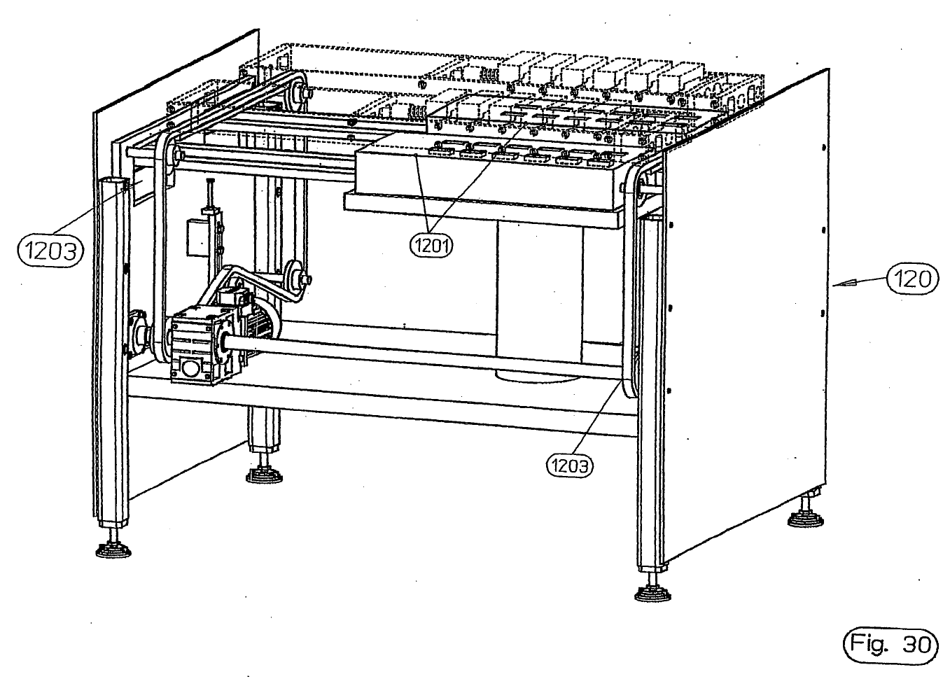

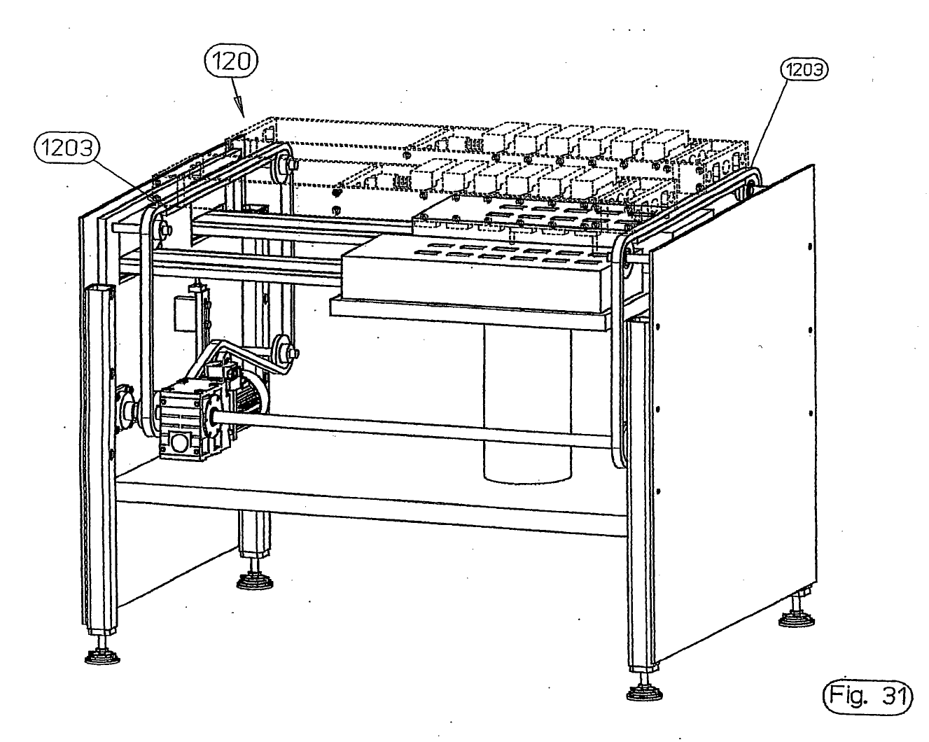

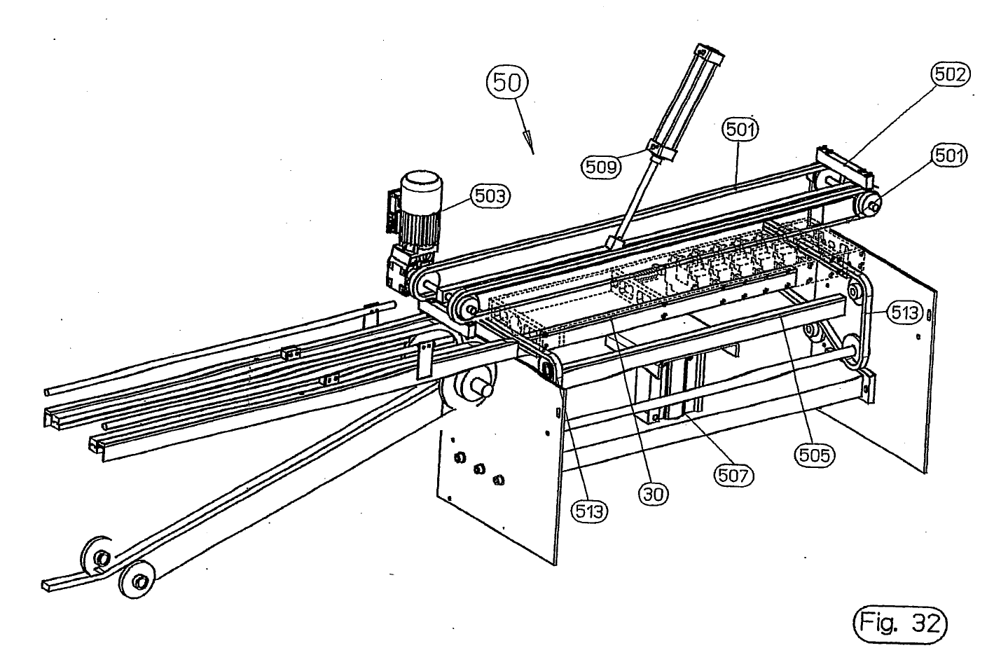

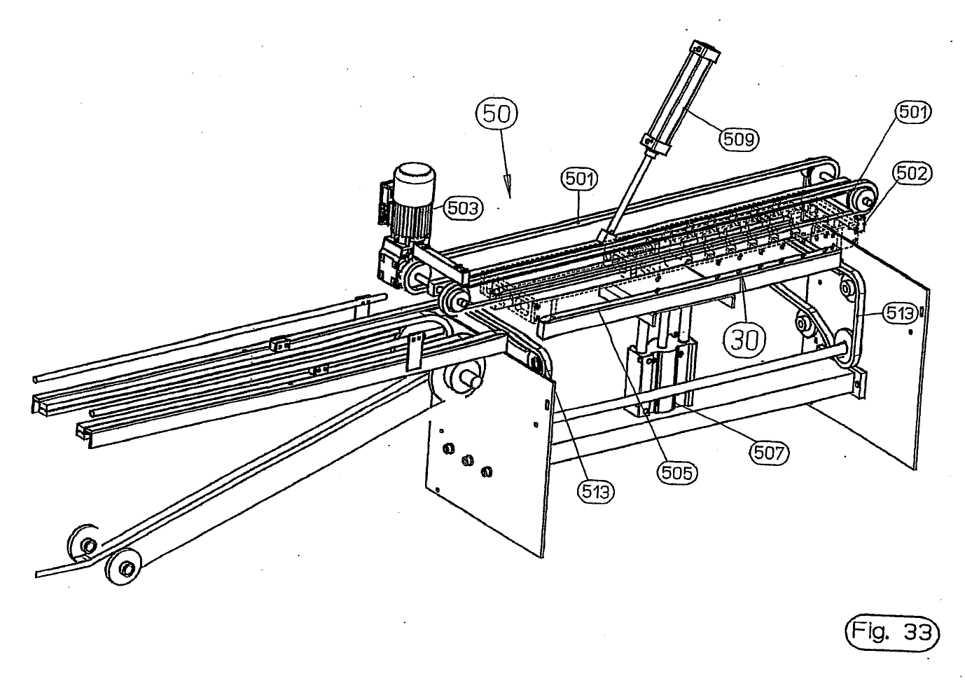

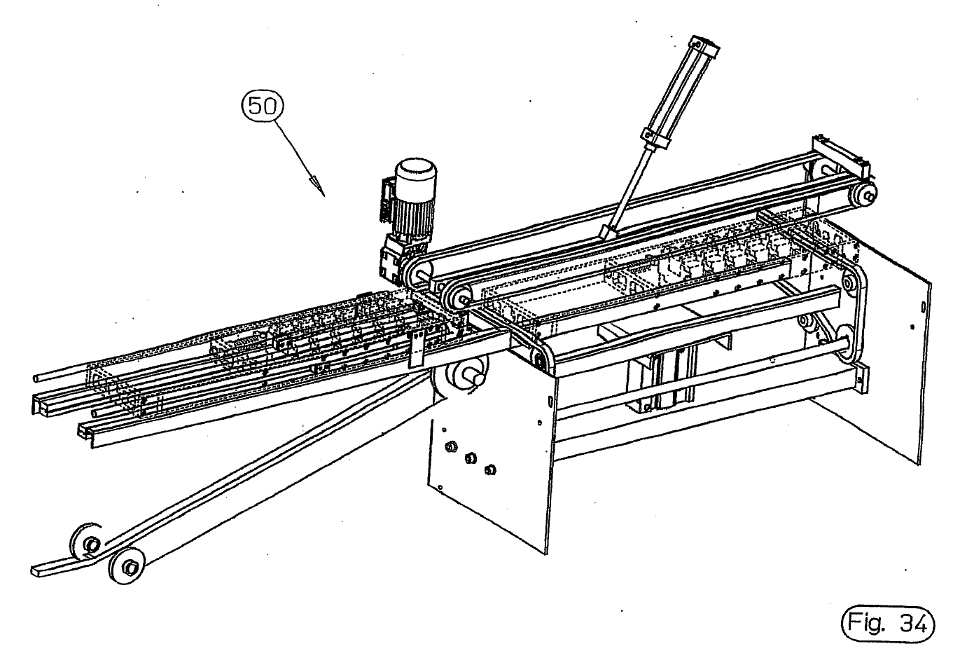

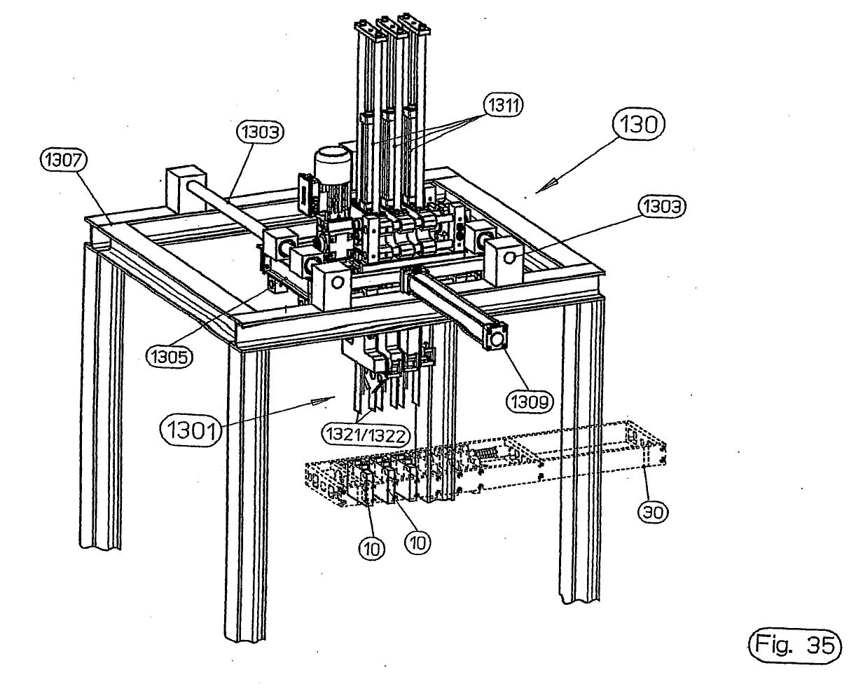

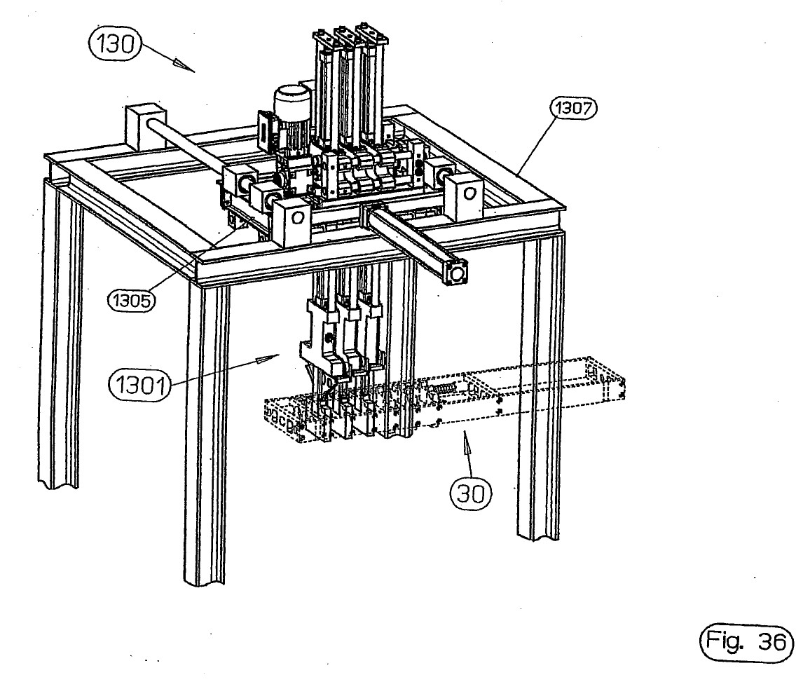

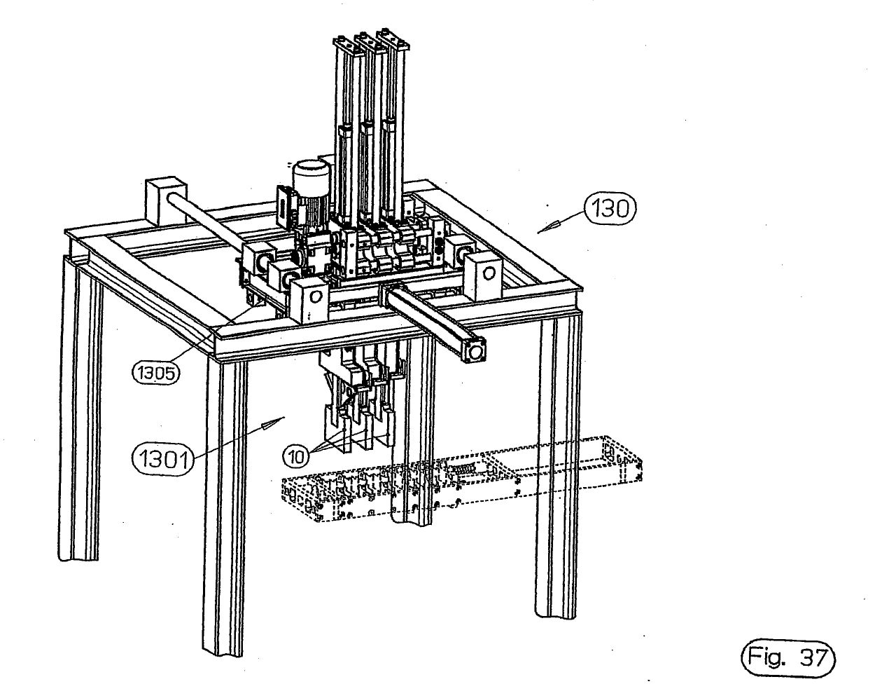

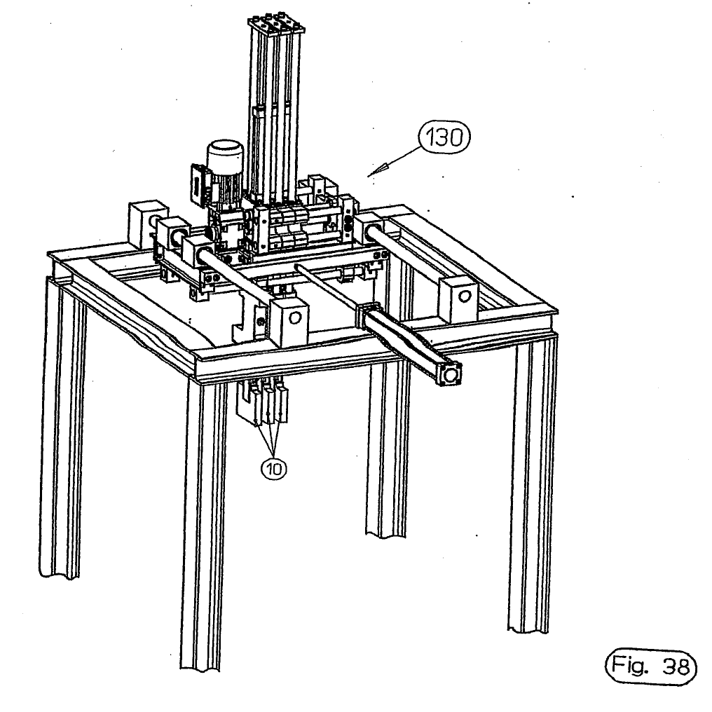

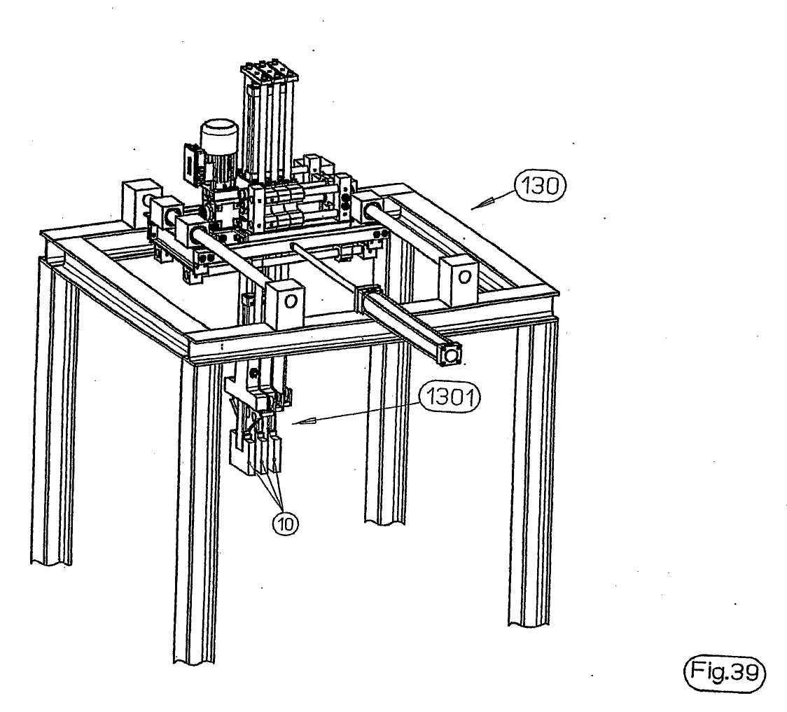

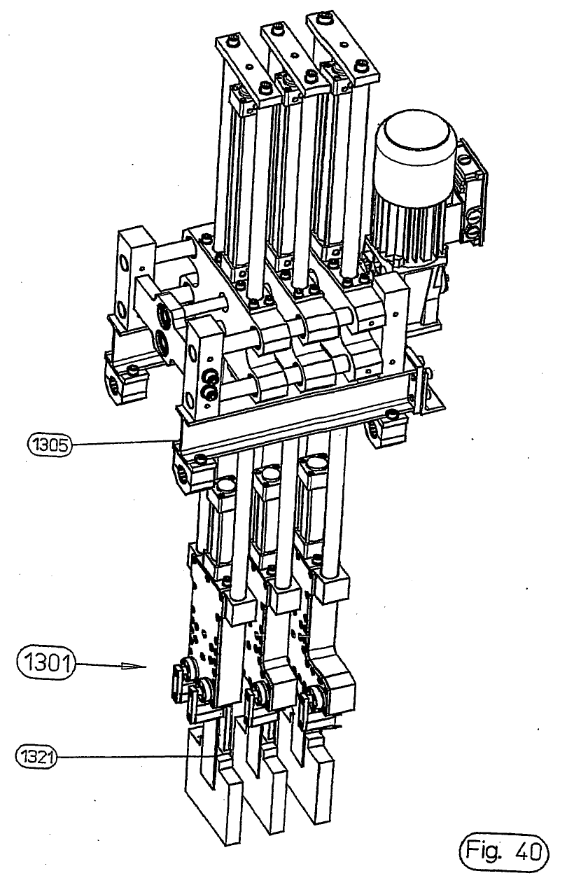

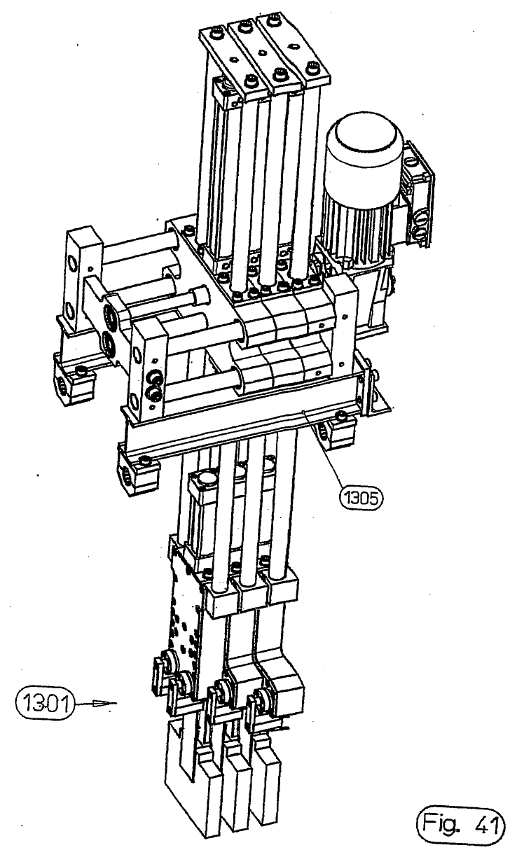

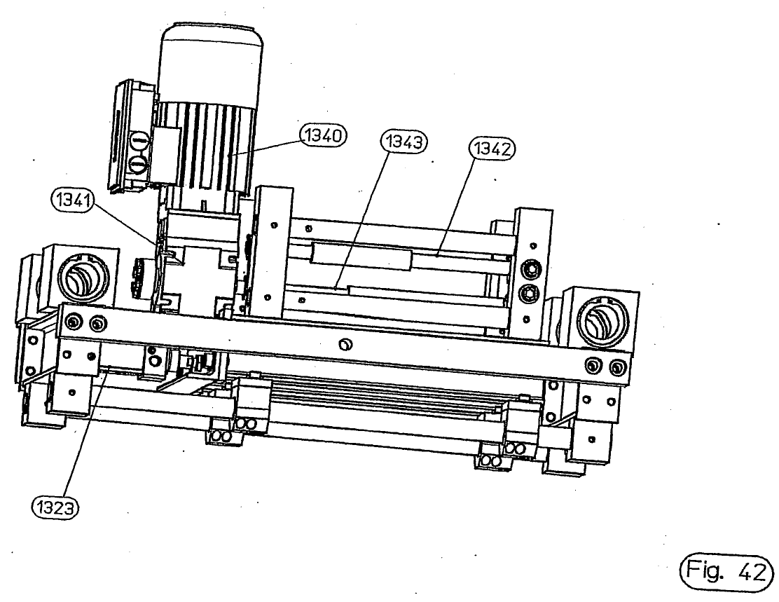

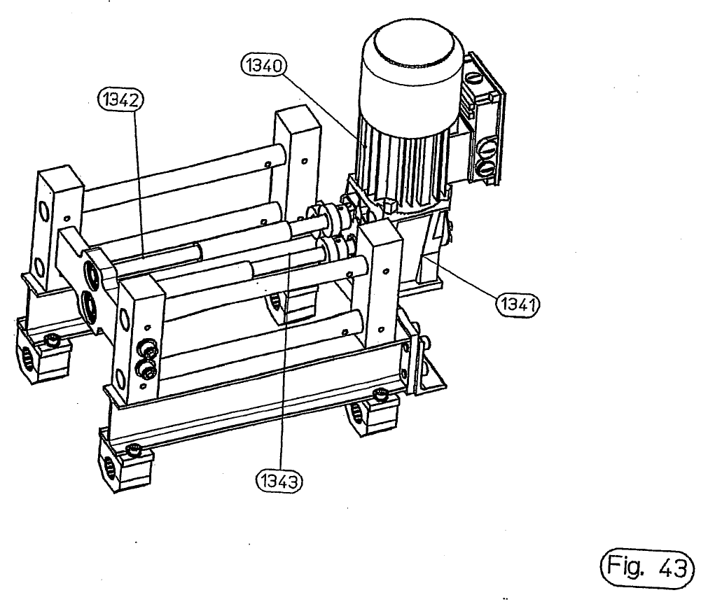

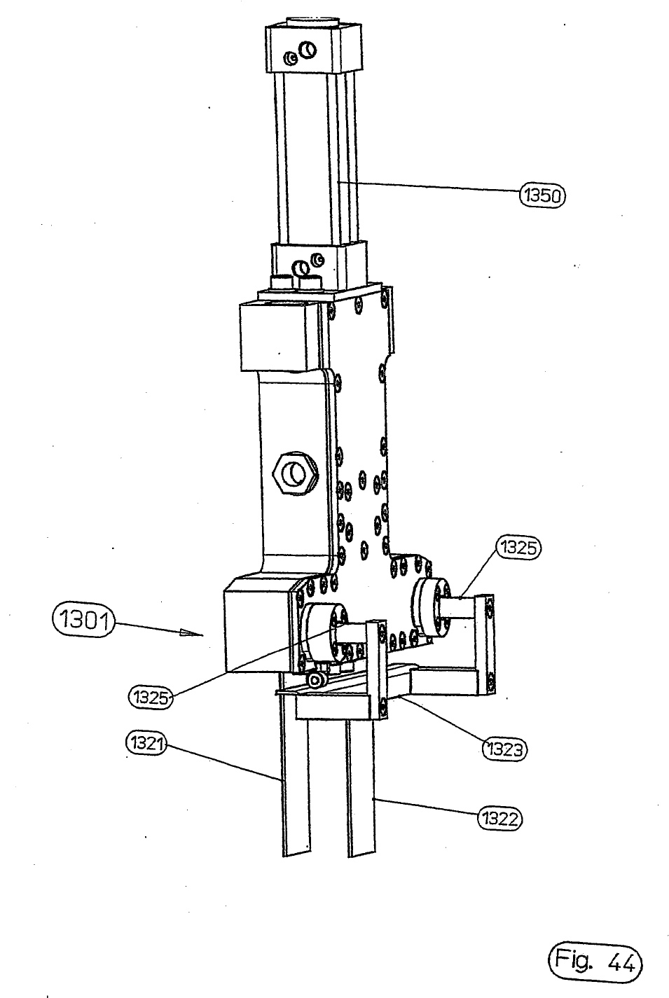

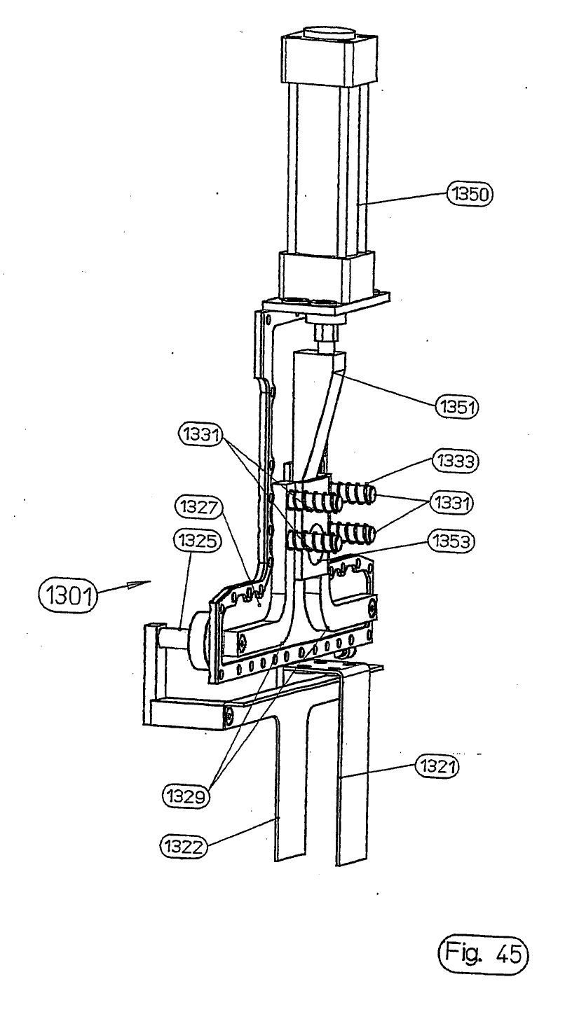

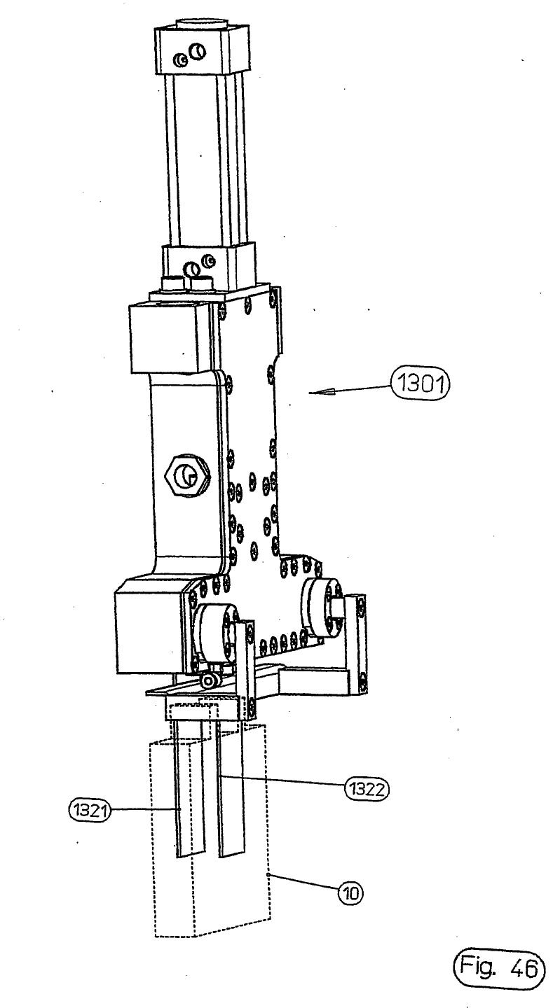

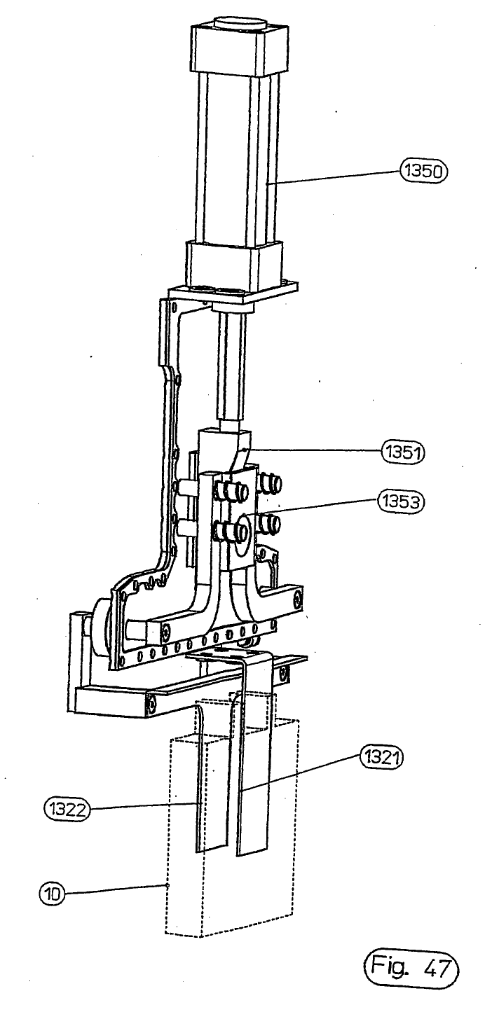

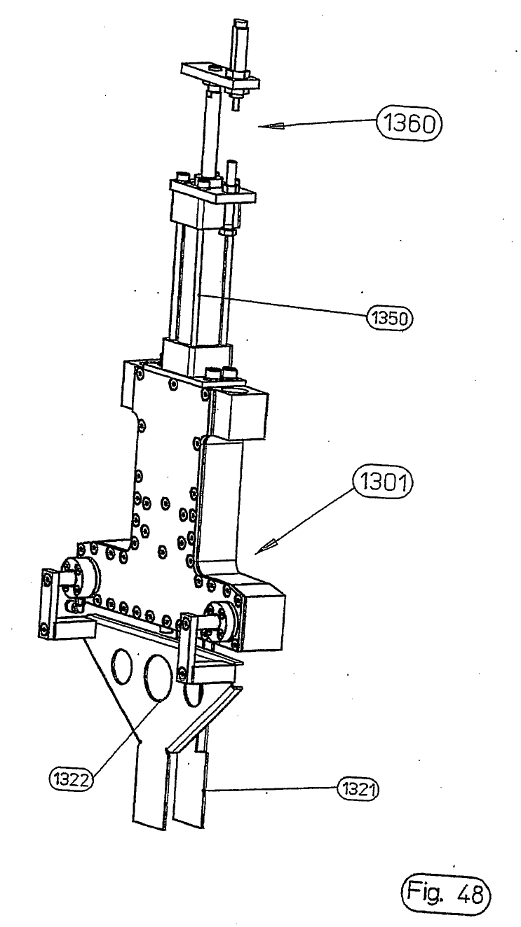

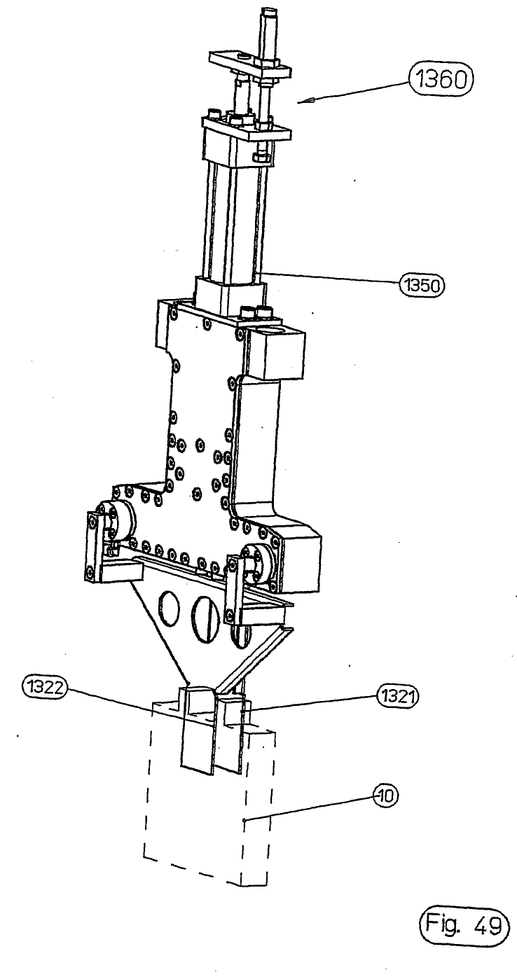

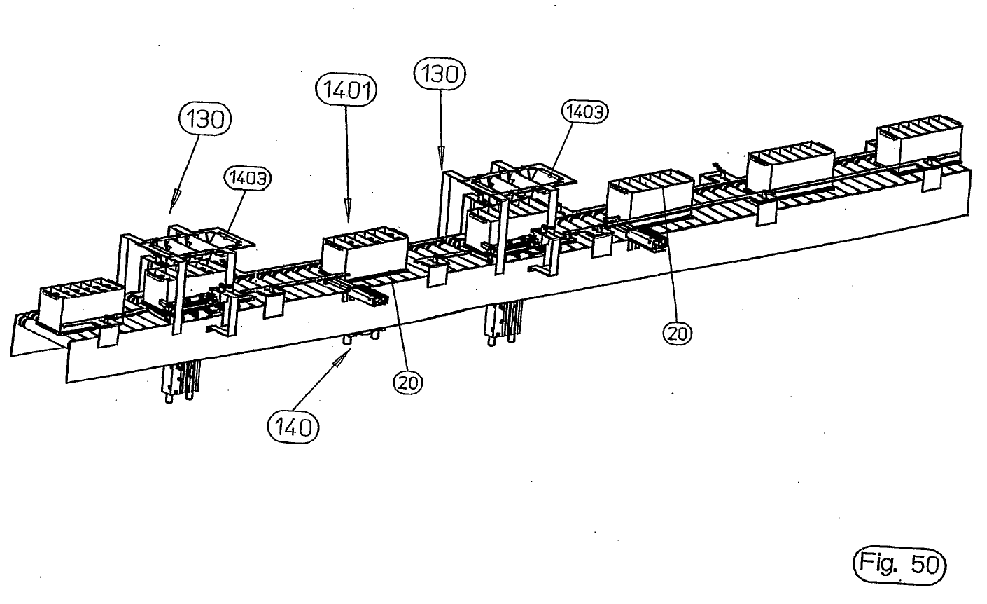

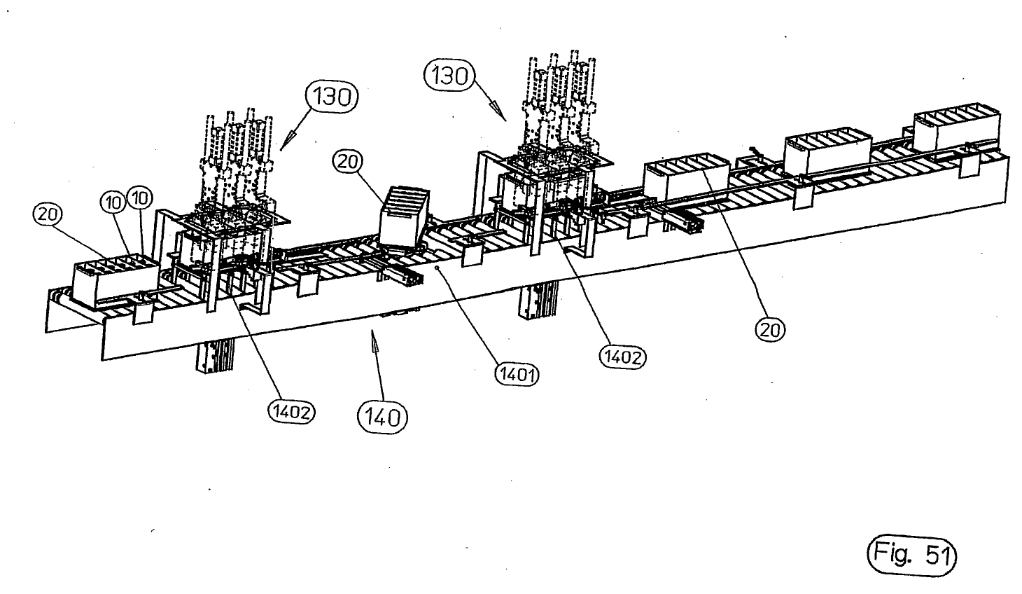

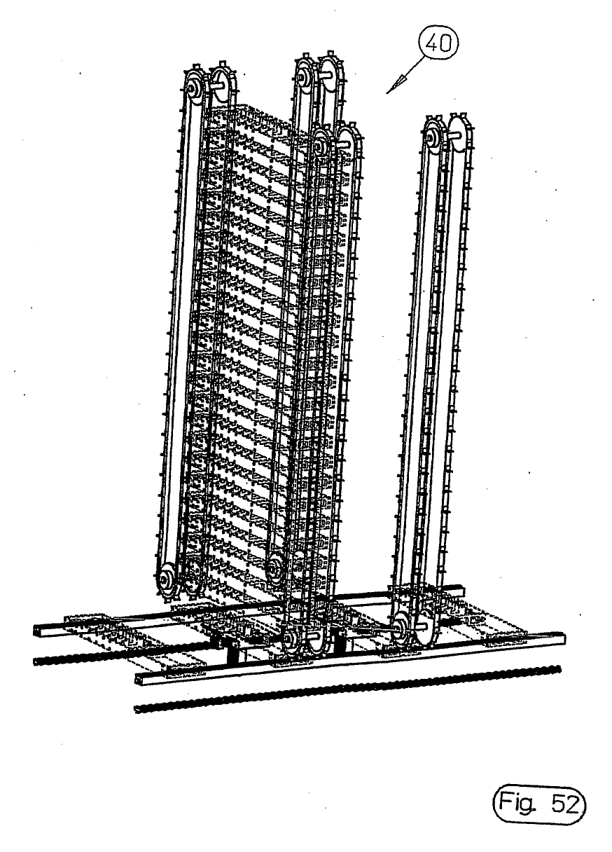

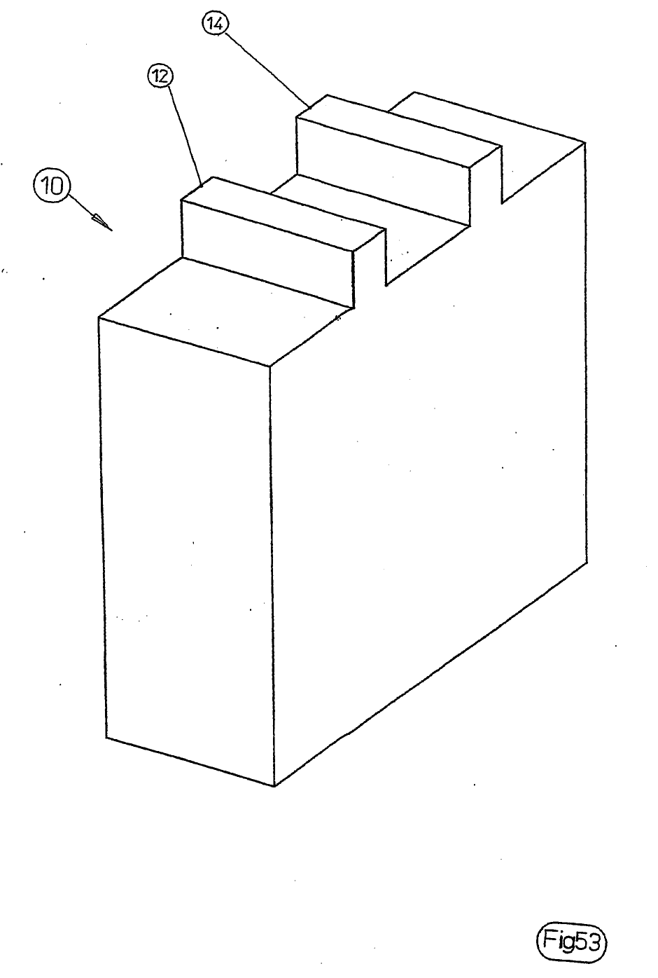

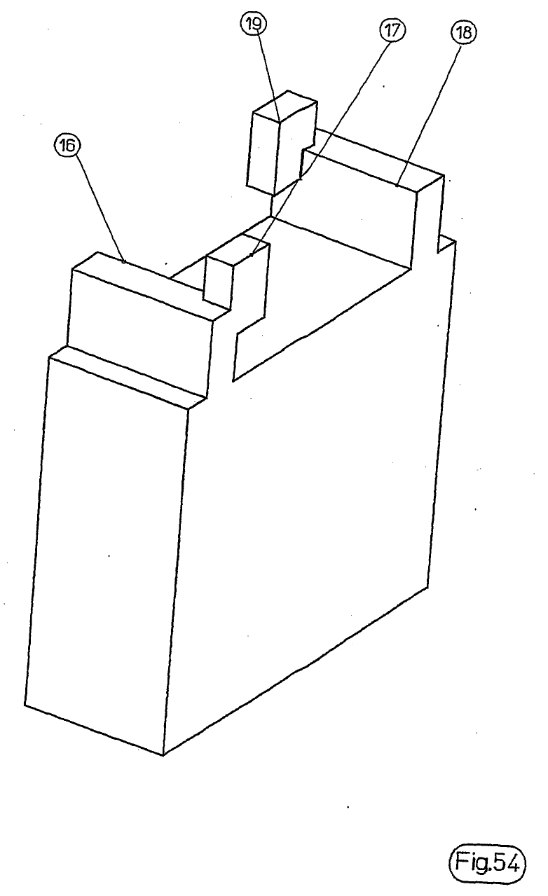

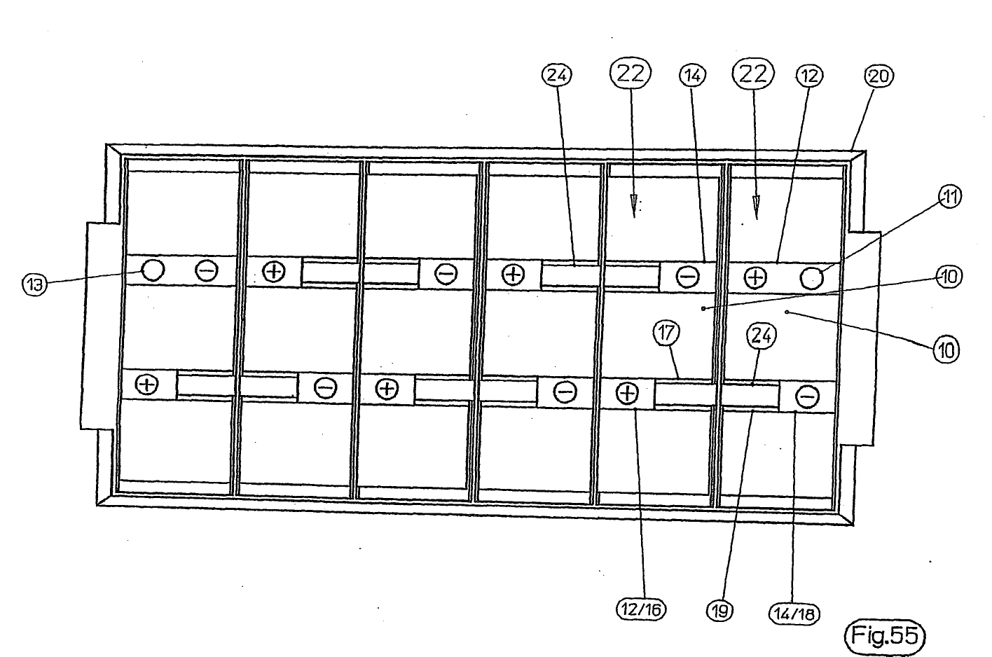

The first station then follows again (embodiment of FIGS. 4-52).

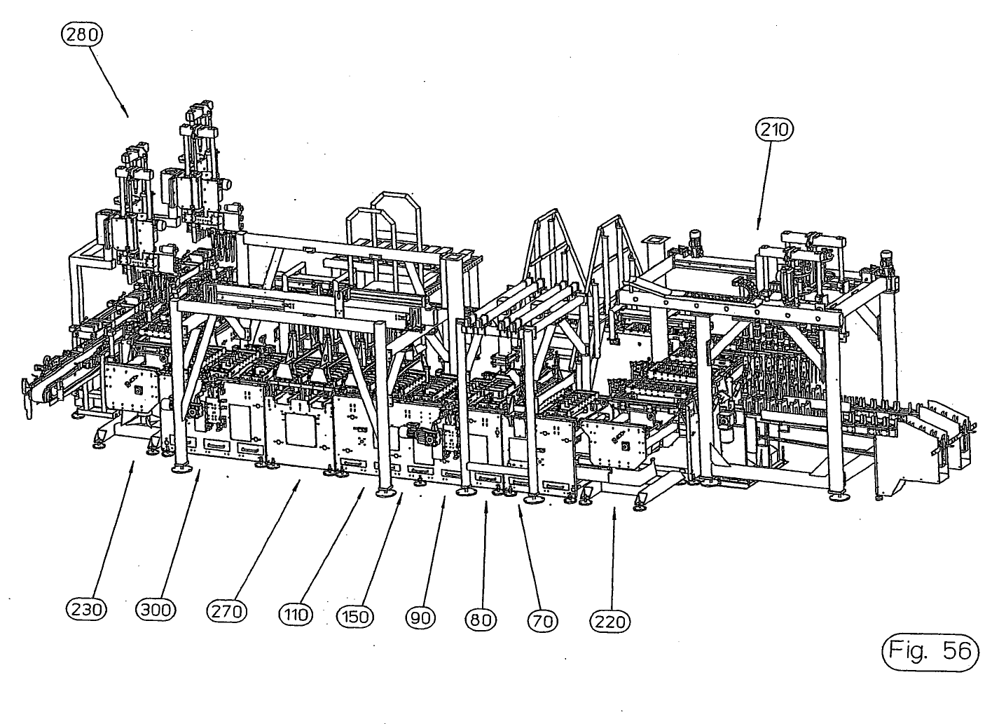

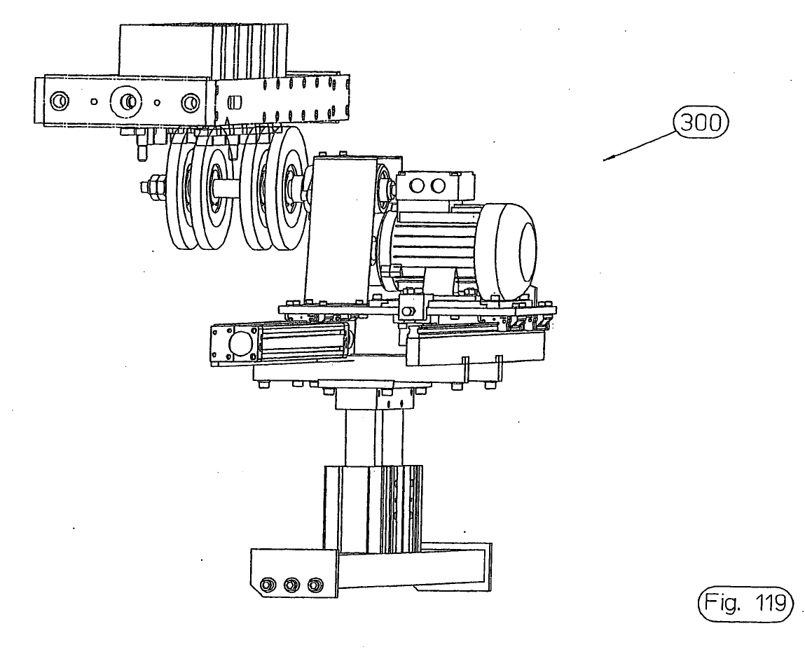

In one alternative embodiment of a system with which the process as claimed in the invention can be implemented, the system (embodiment of FIG. 56-119) has the following stations:

First Station:

Loading station in which cassettes are loaded with plate packs.

Second Station:

First rotary corner transfer device

Third Station:

Buffer site

Fourth Station:

After the buffer site a station in which plates and lugs are aligned.

Fifth Station:

This is a station in which the outer lugs are bent inwardly.

Sixth Station:

In this station the cassettes with the clamped plate packs which have been inserted therein are turned such that the lugs now point down.

Seventh Station:

A station for brushing the lugs as preparation for the casting-on of bridges and pole pins.

Eighth Station:

A station in which the lugs are treated with fluxes to facilitate casting-on of bridges and pole pins.

Ninth Station:

Buffer station

Tenth Station:

Two casting stations for casting-on of bridges and pole pins.

Eleventh Station:

Buffer station

TWELFTH STATION:

A station in which the pole pins and bridges are machined for cleaning and for deburring with brushes.

Thirteen Station:

A station in which the cassettes with the plate packs inserted therein are turned again such that the lugs and now cast-on bridges point up.

Fourteenth Station:

A buffer station with another rotary corner transfer device.

Fifteenth Station:

An unloading station in which the plates which have been delivered in the cassettes are inserted into compartments of prepared battery cases.

Sixteenth Station:

Following the unloading station a corner transfer device for empty cassettes in order to transfer them to a return station and

Seventeenth Station:

Another corner transfer device with which the cassettes are moved again into the FIRST STATION (loading station).

Other details, features and advantages of the invention will become apparent from the description of embodiments of the system as claimed in the invention with reference to the drawings.

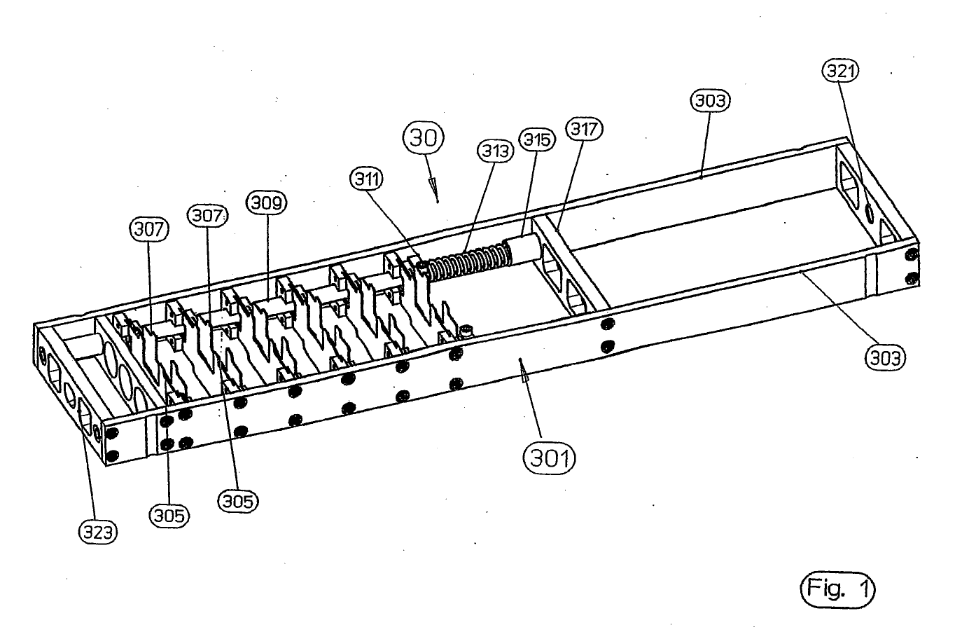

FIGS. 1 to 3 show cassettes as are used for transport of battery plates in the system,

FIGS. 4 to 7 show the system viewed from different directions,

FIGS. 8 to 12 show a station for insertion of plate packs in cassettes,

FIGS. 13 to 16 show a station for alignment of plates and lugs,

FIGS. 17 to 19 show a corner transfer device,

FIGS. 20 to 22 show a station for bending of lugs,

FIGS. 23 to 24 show a station for turning of cassettes,

FIGS. 25 to 26 show a station for brushing the lugs of the battery plates,

FIGS. 27 to 28 show a station for fluxing,

FIGS. 29 to 31 show a station for casting-on of bridges, intercell connectors and pole pins,

FIGS. 32 to 34 show a corner transfer device,

FIGS. 35 to 43 show parallel transfer devices in the unloading and loading station,

FIGS. 44 to 49 show a gripper for the parallel transfer device,

FIGS. 50 and 51 shows a conveyor path for battery cases,

FIG. 52 shows a bucket belt storage,

FIG. 53 schematically shows a plate pack,

FIG. 54 schematically shows a plate pack with bridges cast onto the lugs with flanges for intercell connectors,

FIG. 55 schematically shows a battery case with the plate packs located therein,

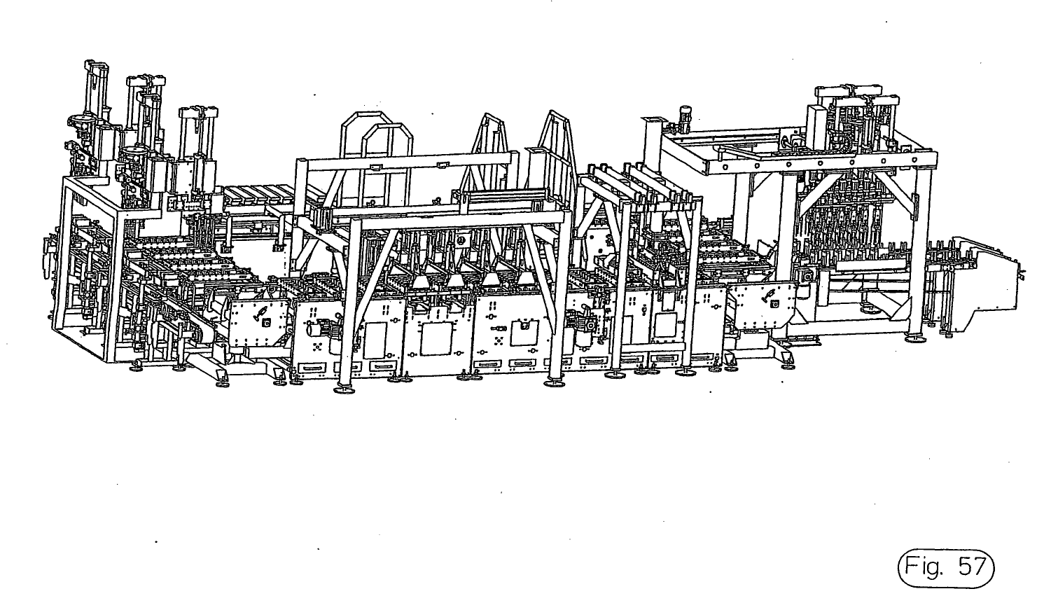

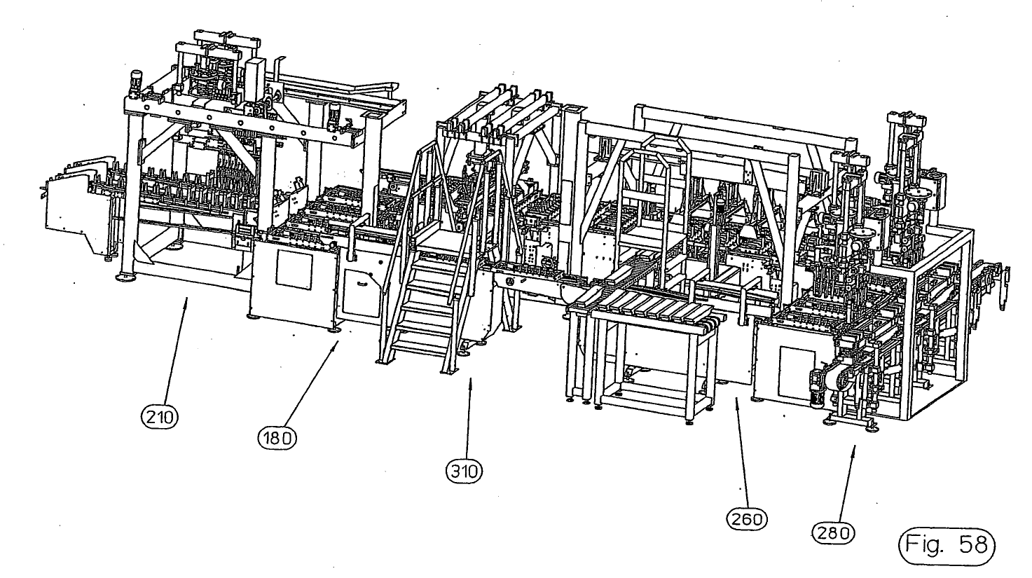

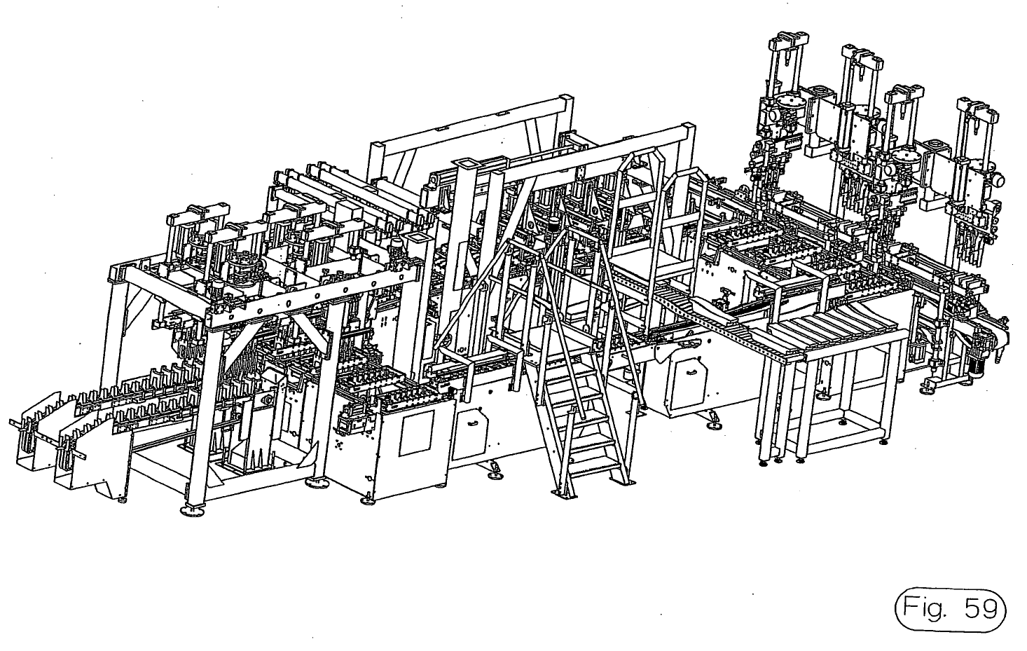

FIGS. 56 to 59 show another embodiment of the overall system in different perspective views,

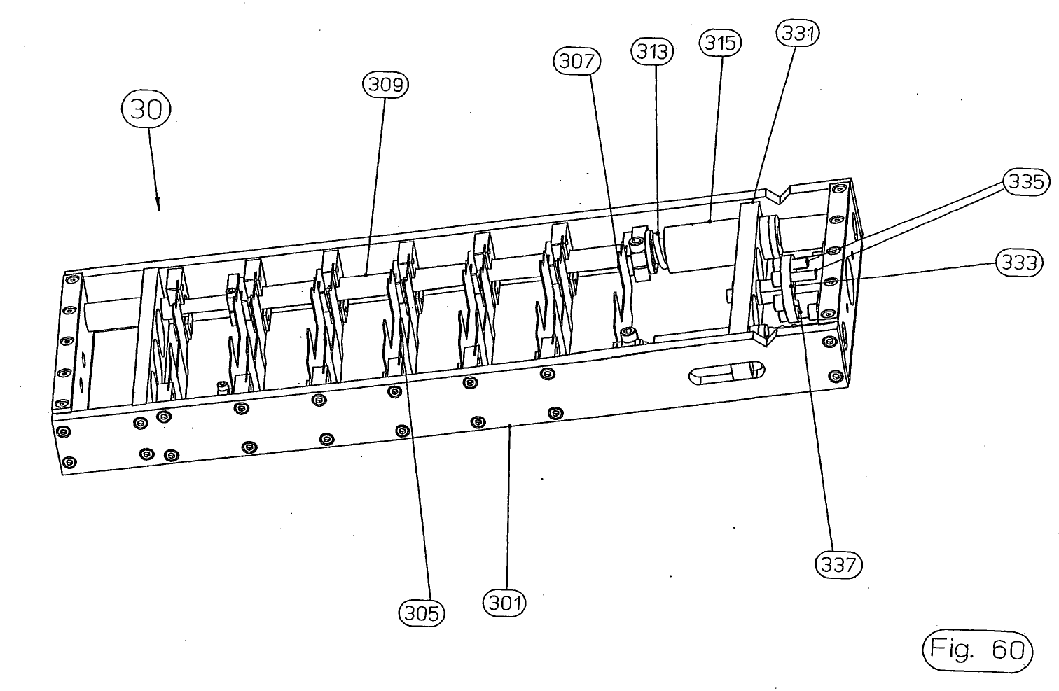

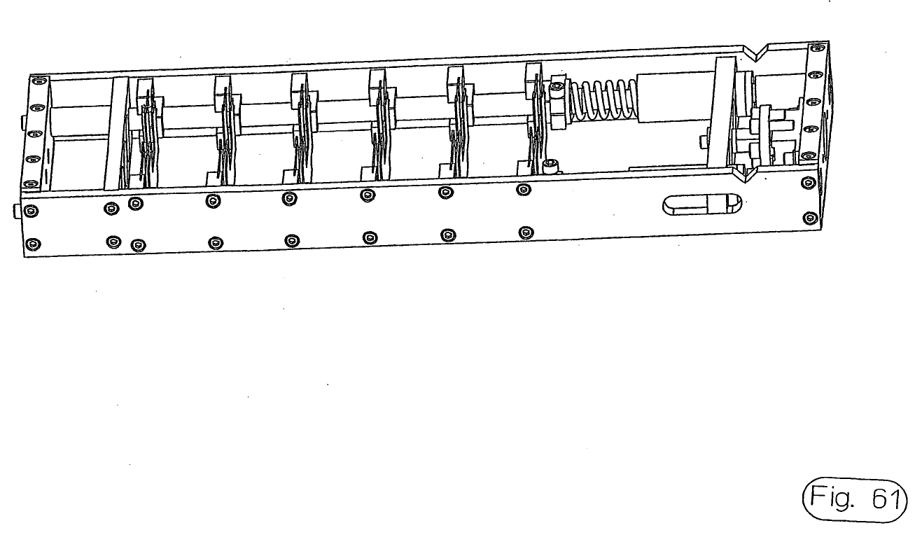

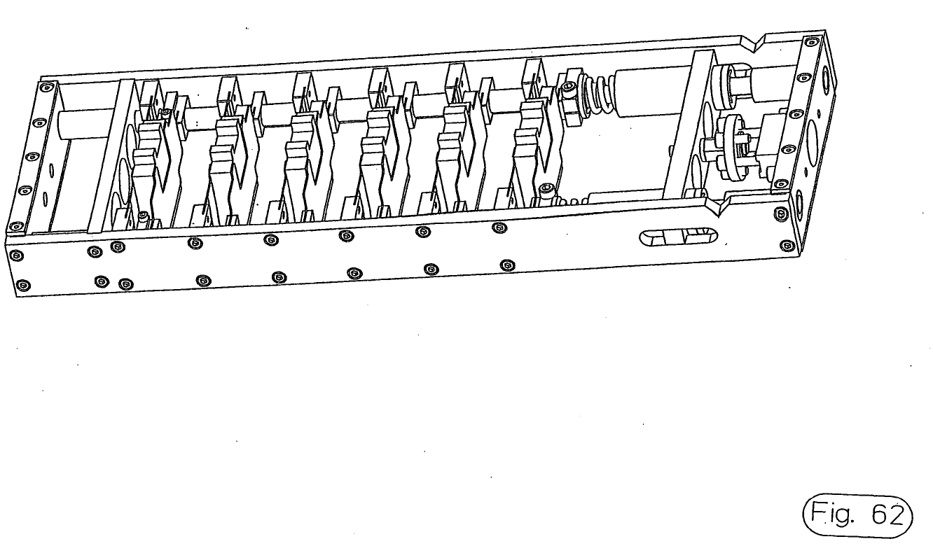

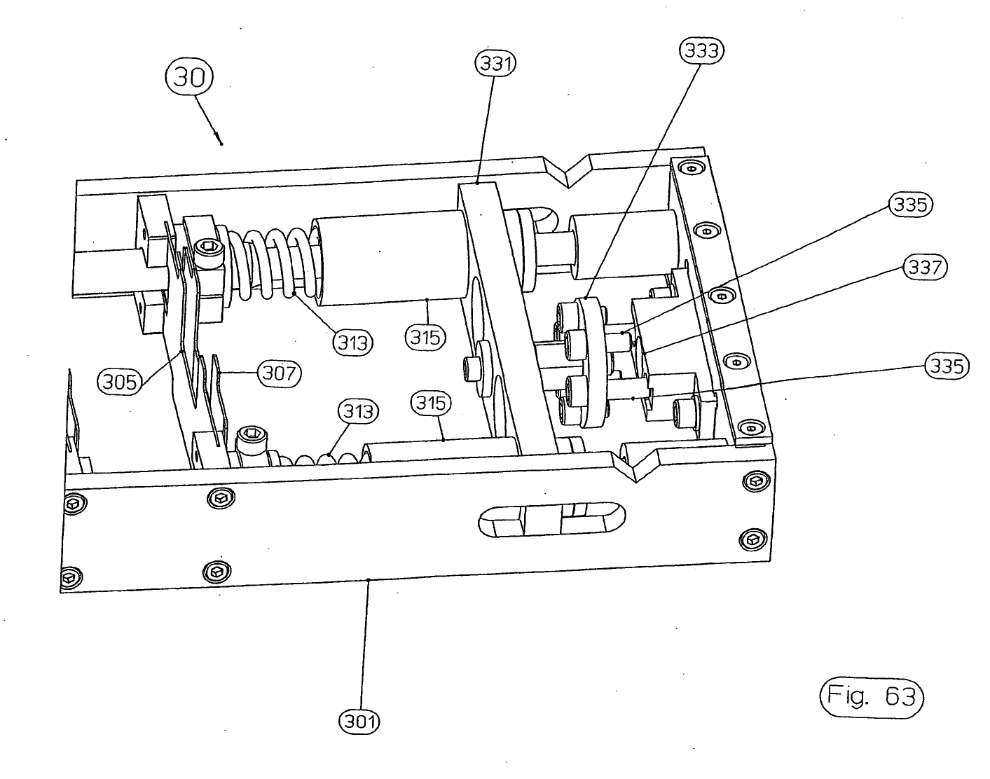

FIGS. 60 to 64 show another embodiment of a cassette with adjustable spring force,

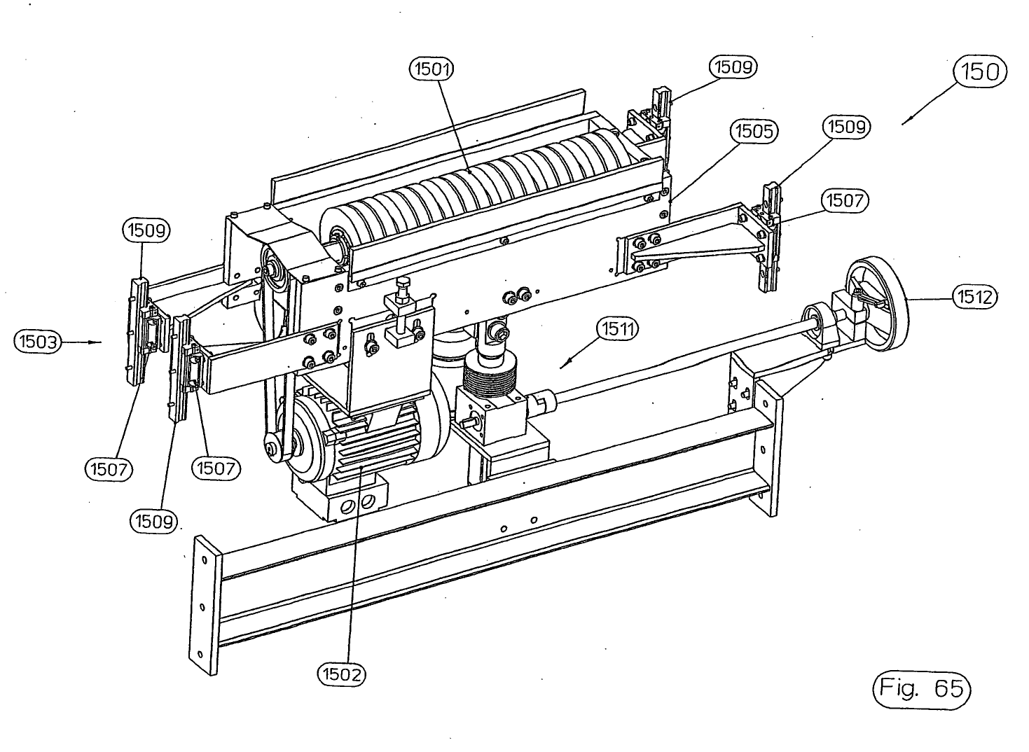

FIG. 65 shows another embodiment of a lug brush with an adjustable brush height,

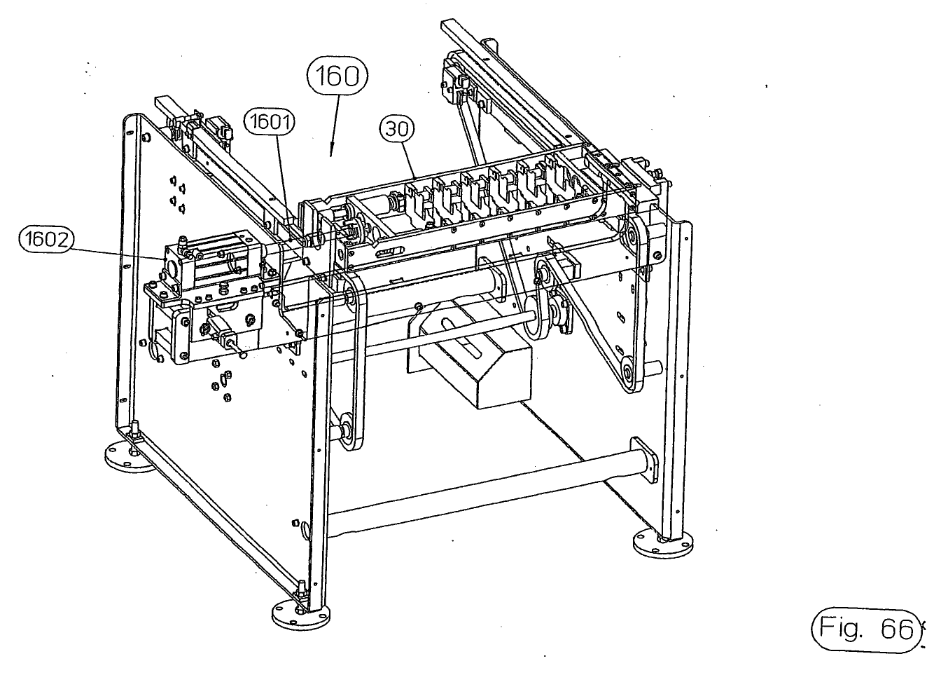

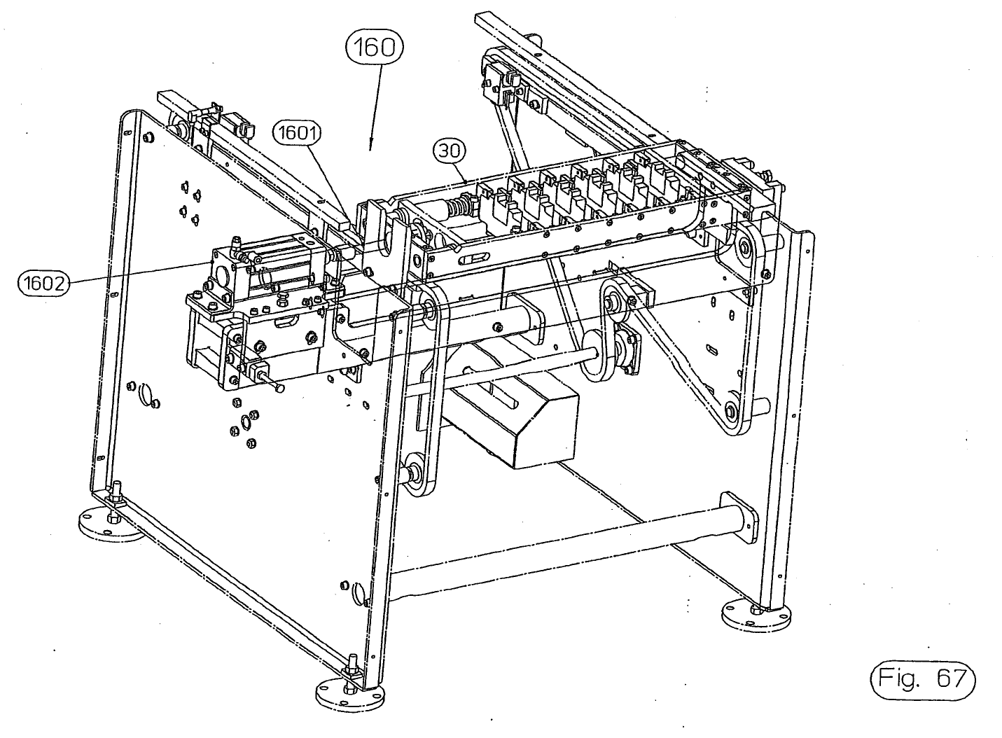

FIGS. 66 and 67 show in an oblique view an arrangement for adjusting the spring force of the cassette shown in FIGS. 60 to 64,

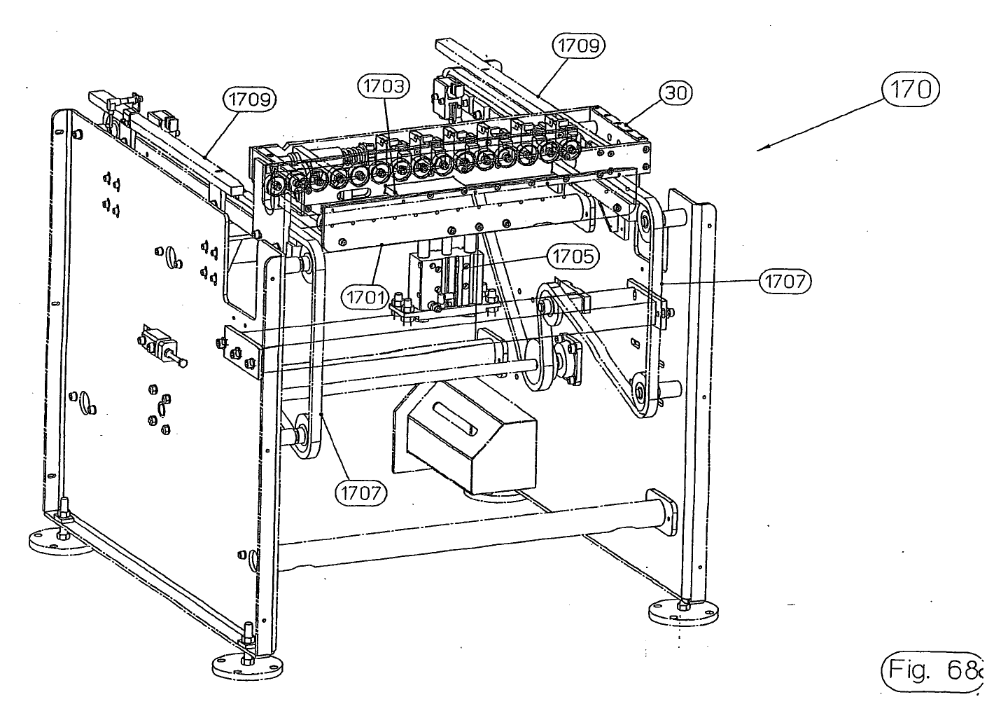

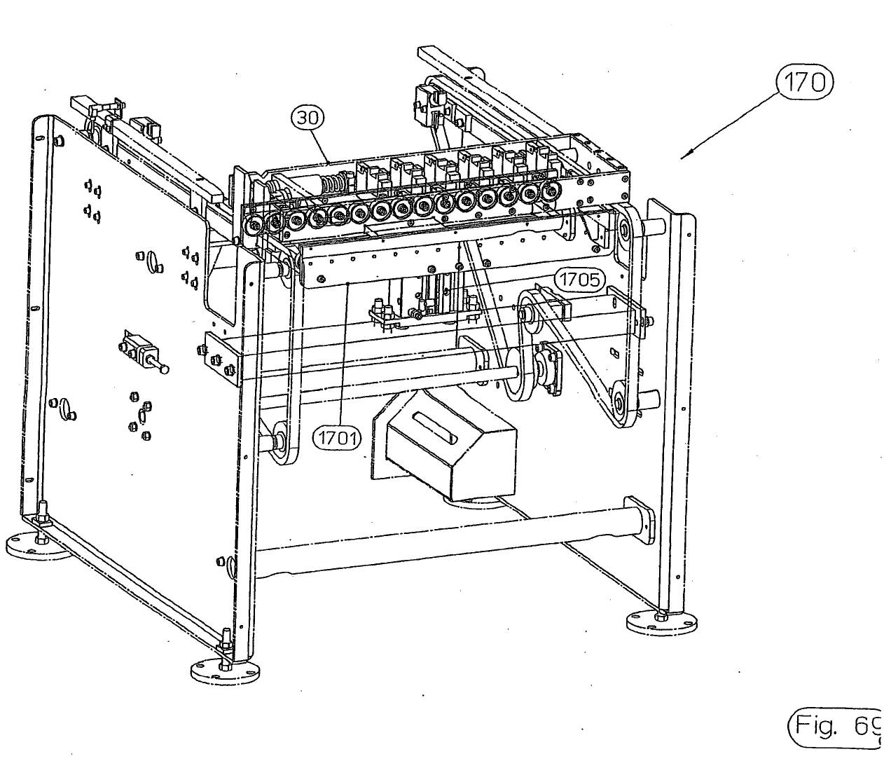

FIGS. 68 and 69 show a lift table on the end of the return segment,

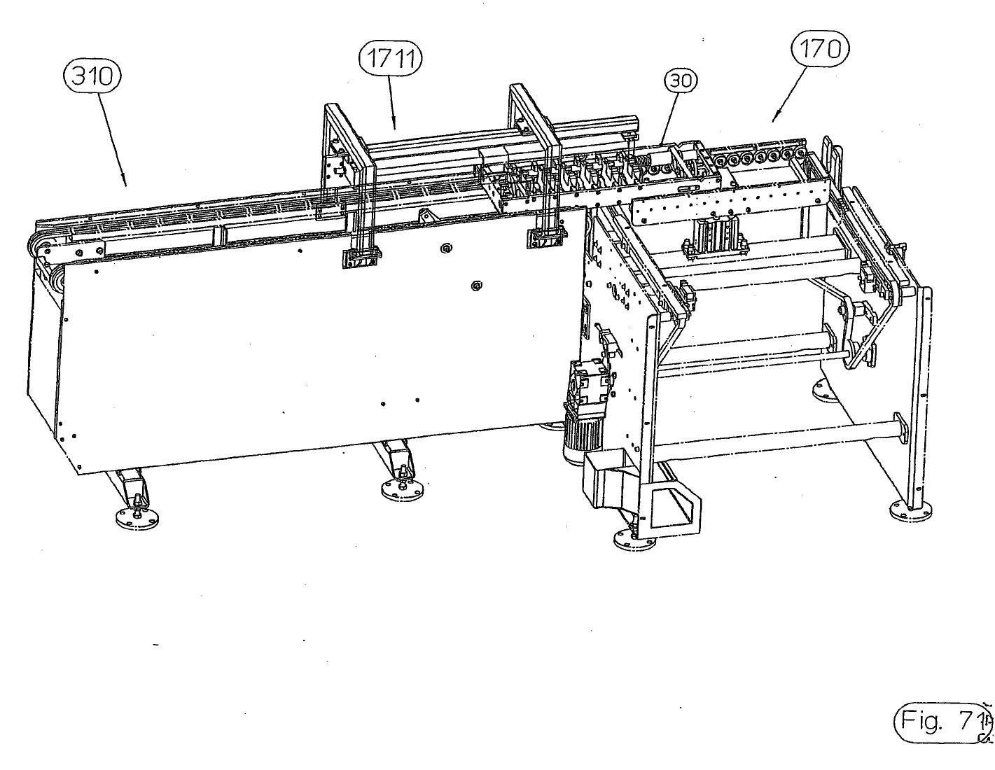

FIGS. 71 to 73 show a corner transfer device on the end of the return segment,

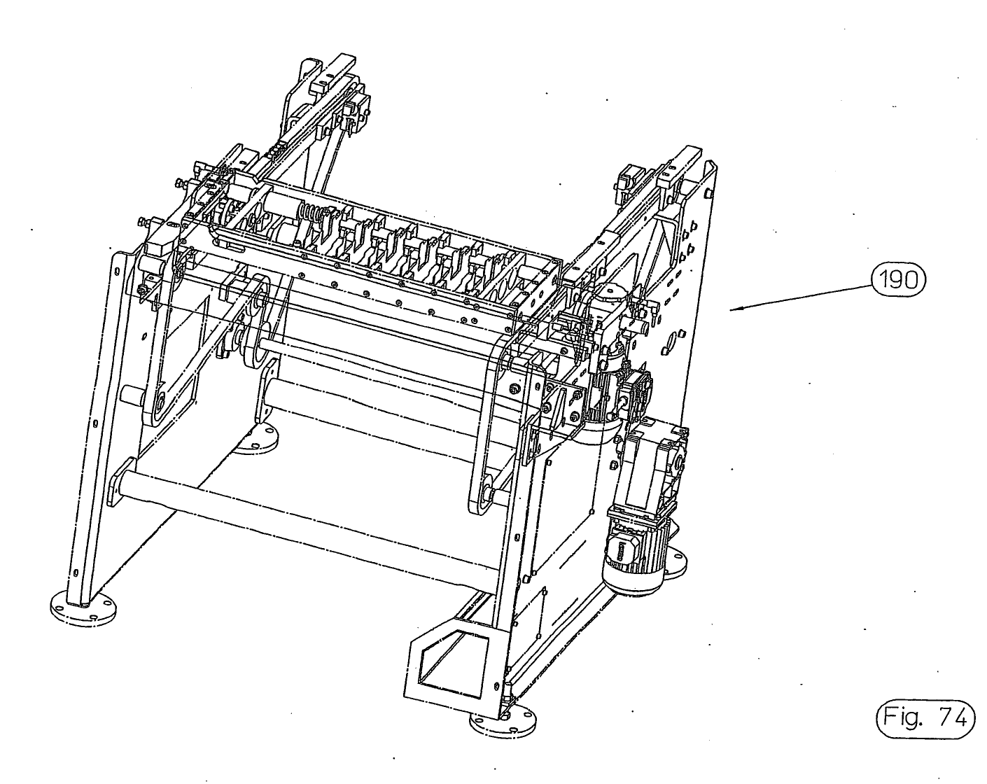

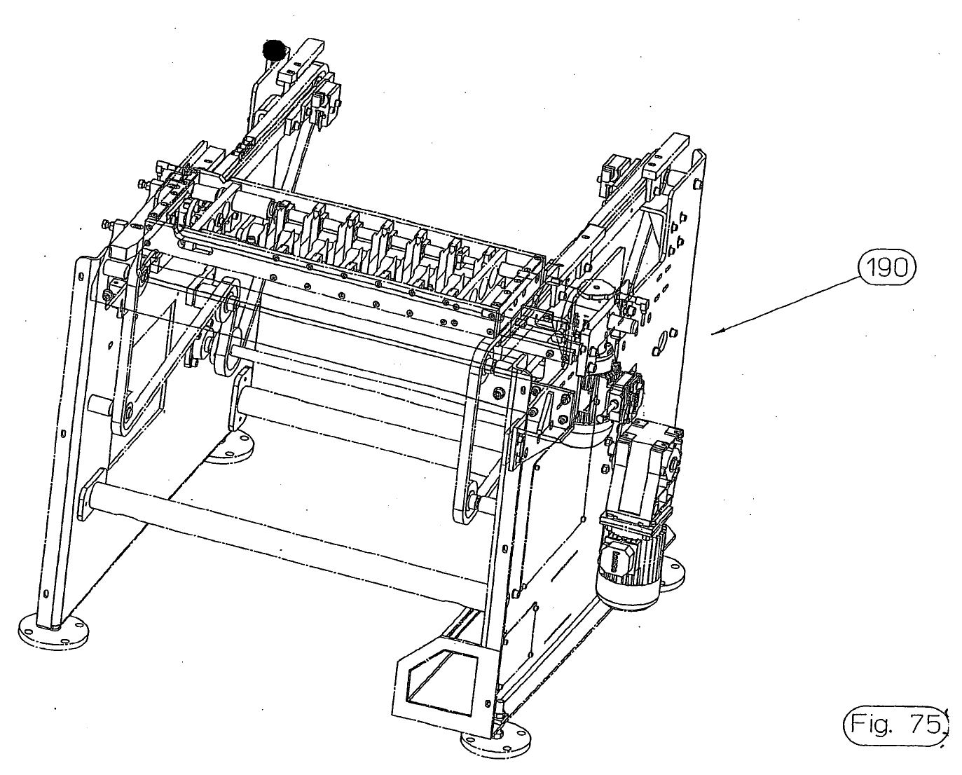

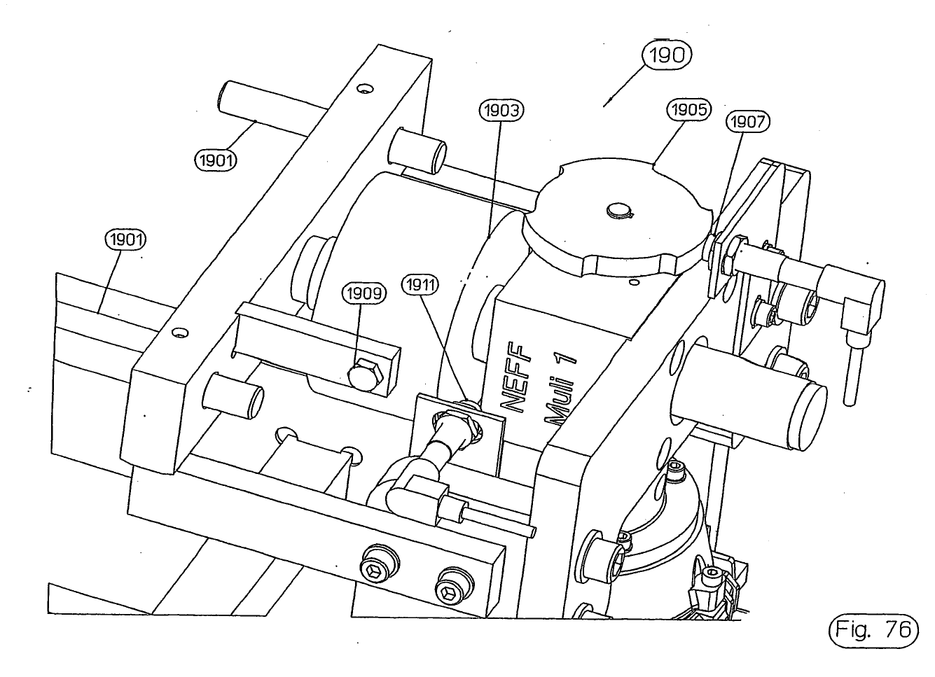

FIGS. 74 to 76 show a device for opening the cassettes using a spindle lift gear,

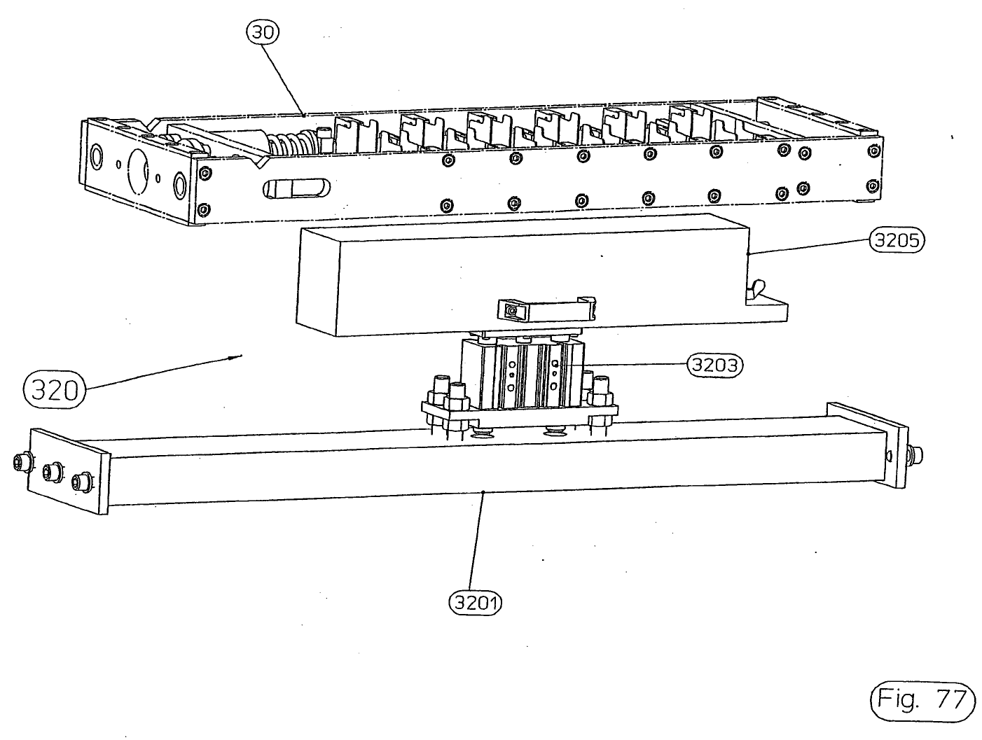

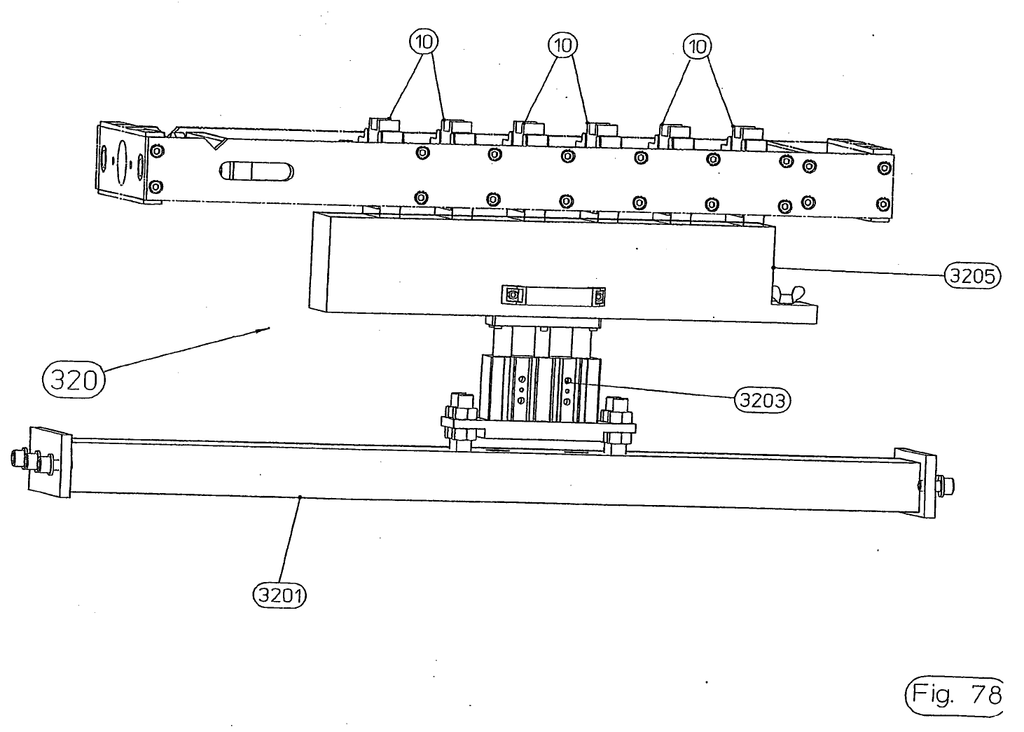

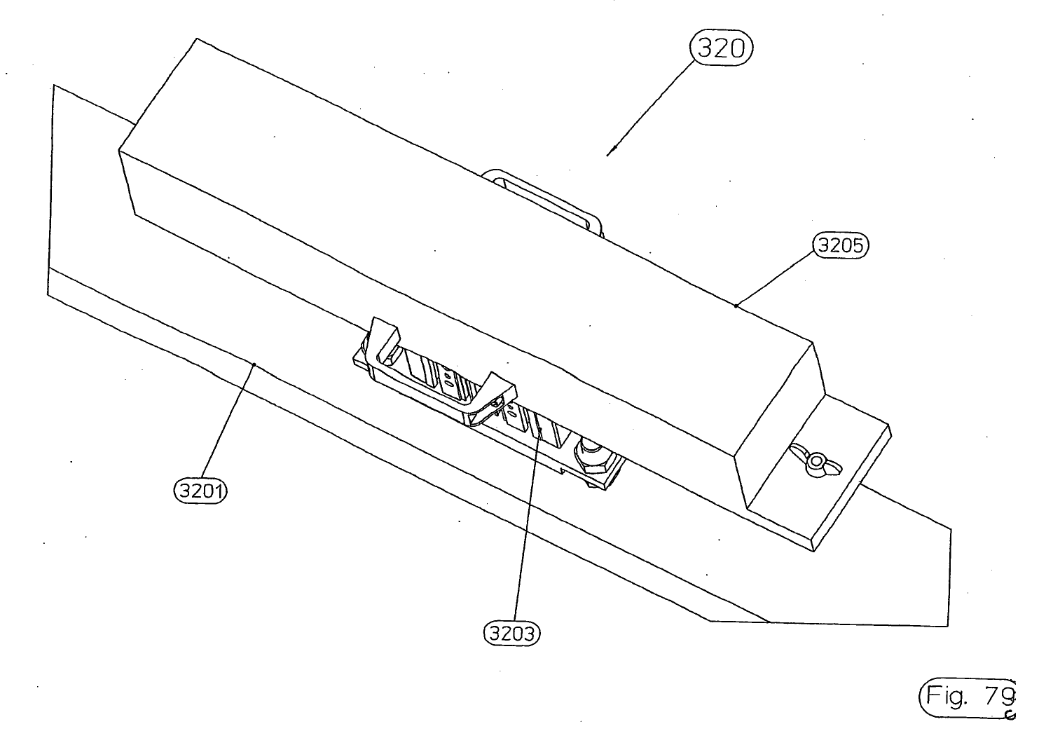

FIGS. 77 to 79 show a plate holding table for loading and unloading of cassettes with interchangeable adapter plates of various heights,

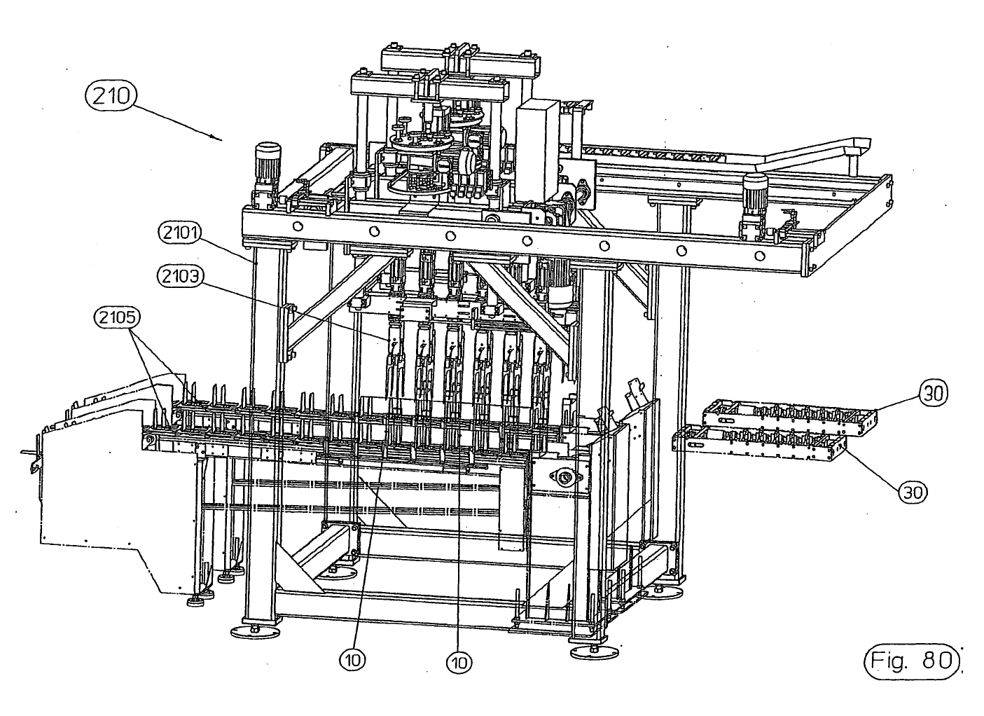

FIGS. 80 to 84 show a station for feed of cassettes with plates,

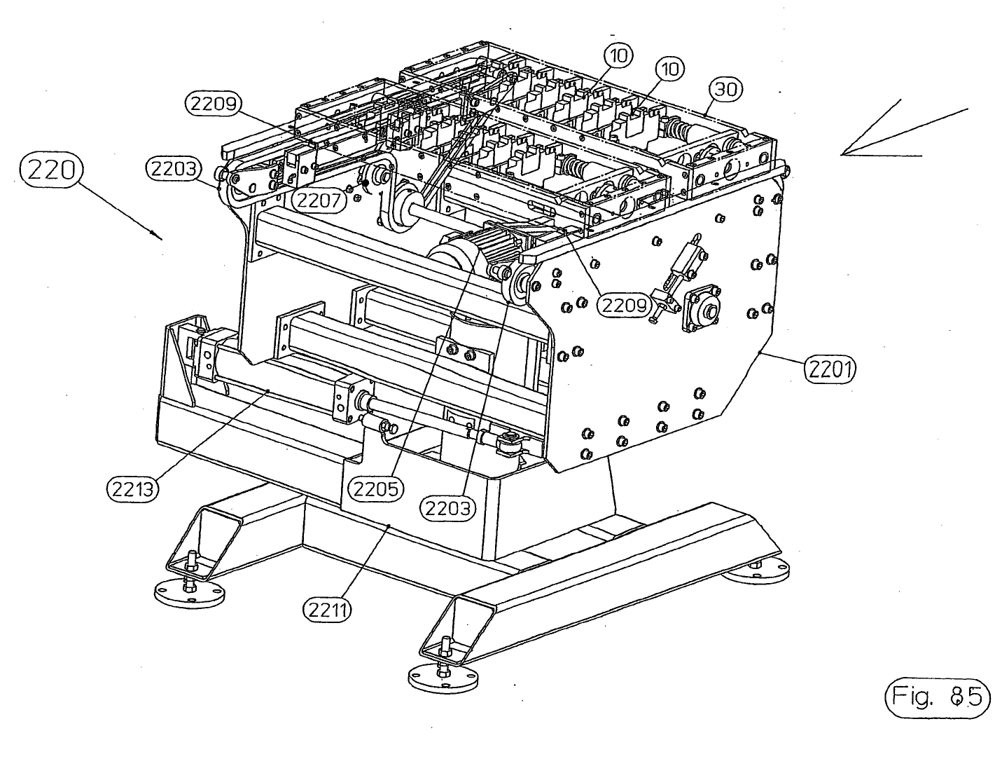

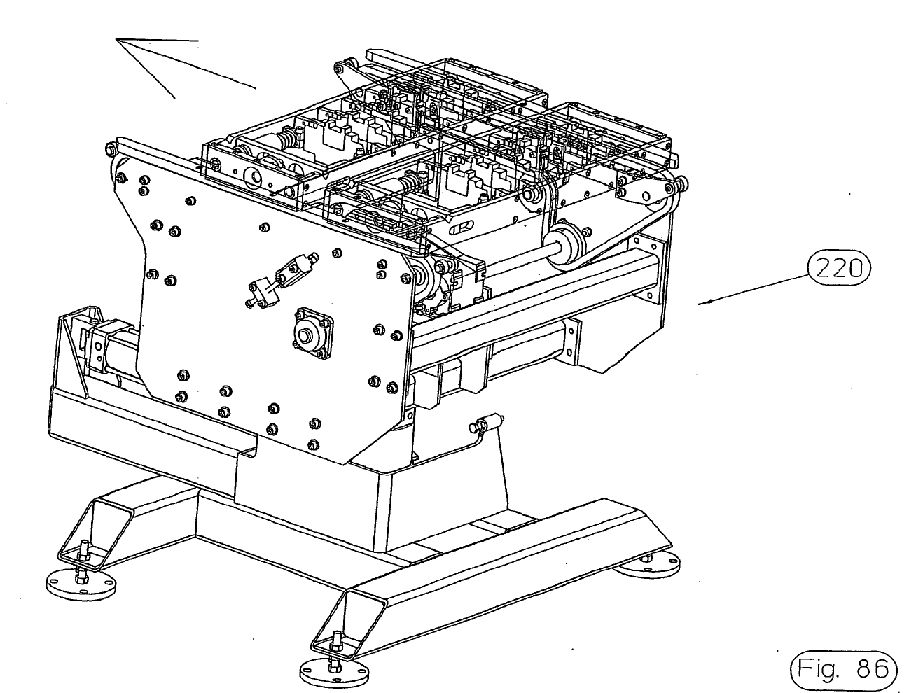

FIGS. 85 and 86 show a rotary corner transfer device with continuous conveyor direction,

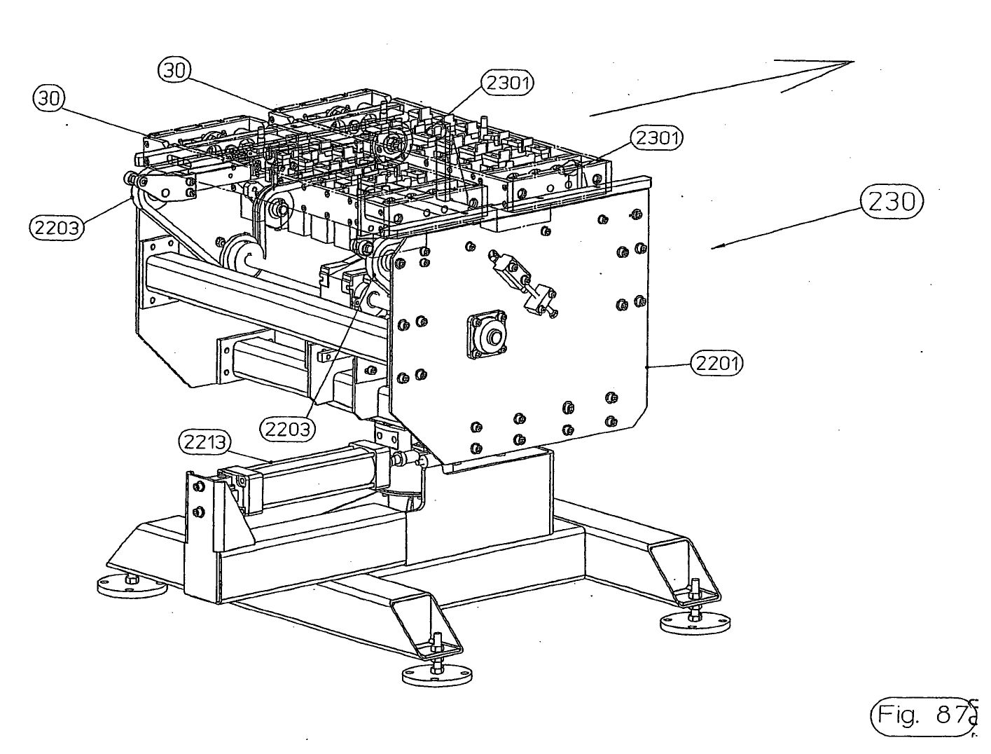

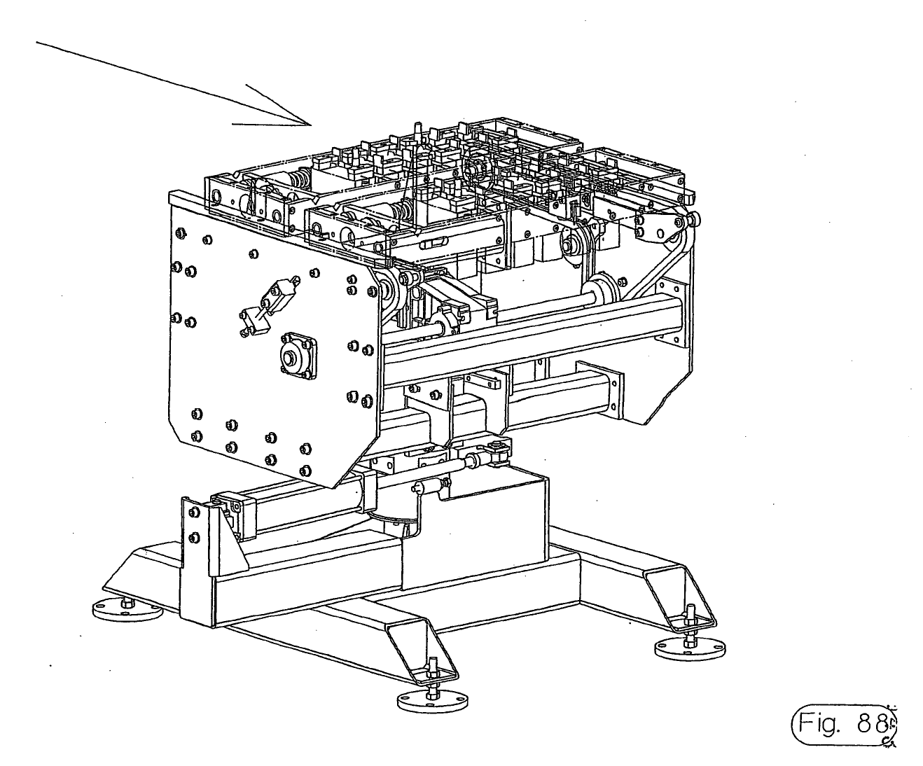

FIGS. 87 and 88 show a rotary corner transfer device with reversible conveyor direction,

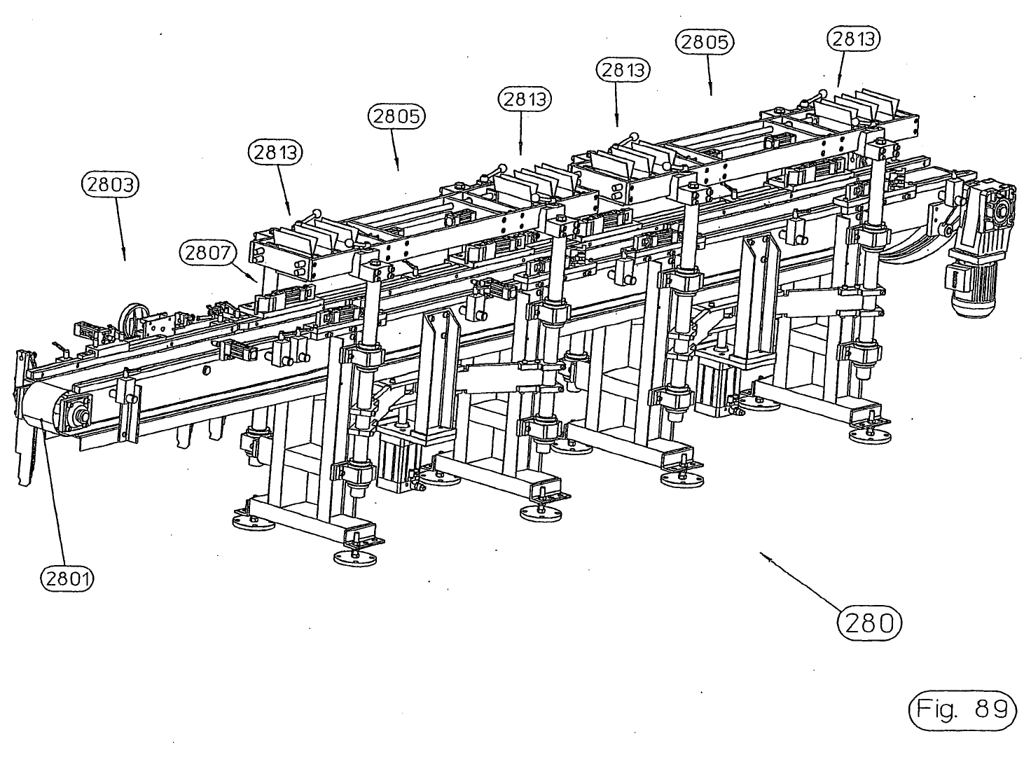

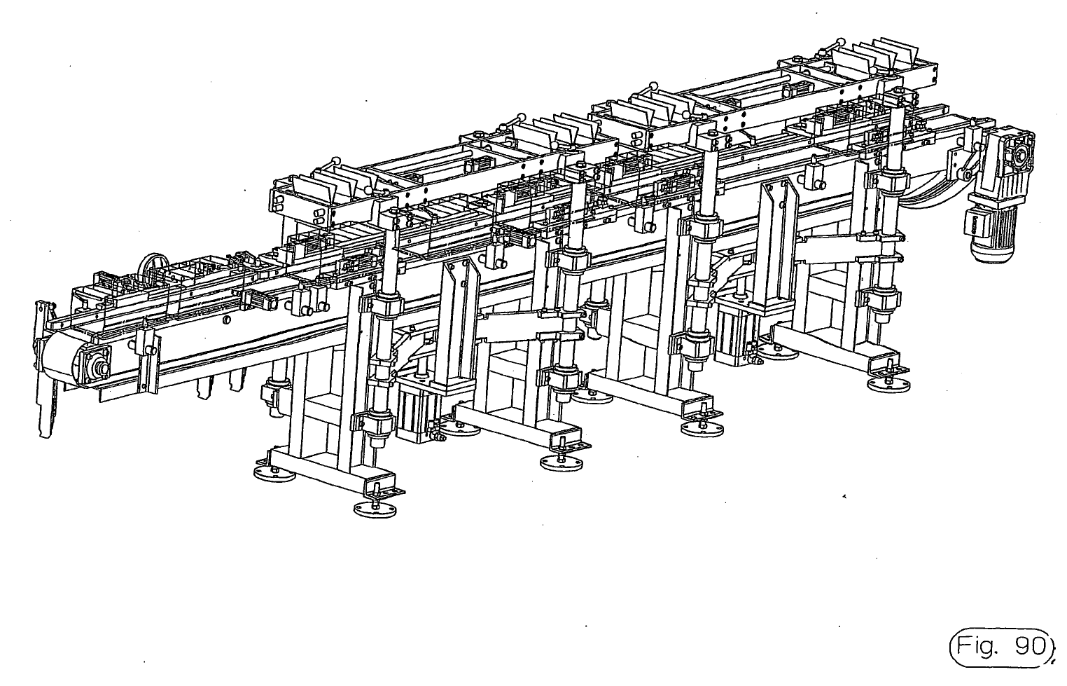

FIGS. 89 to 92 show a means for transport of battery cases including means for stopping the battery cases and aids for insertion of battery cases (insertion aids),

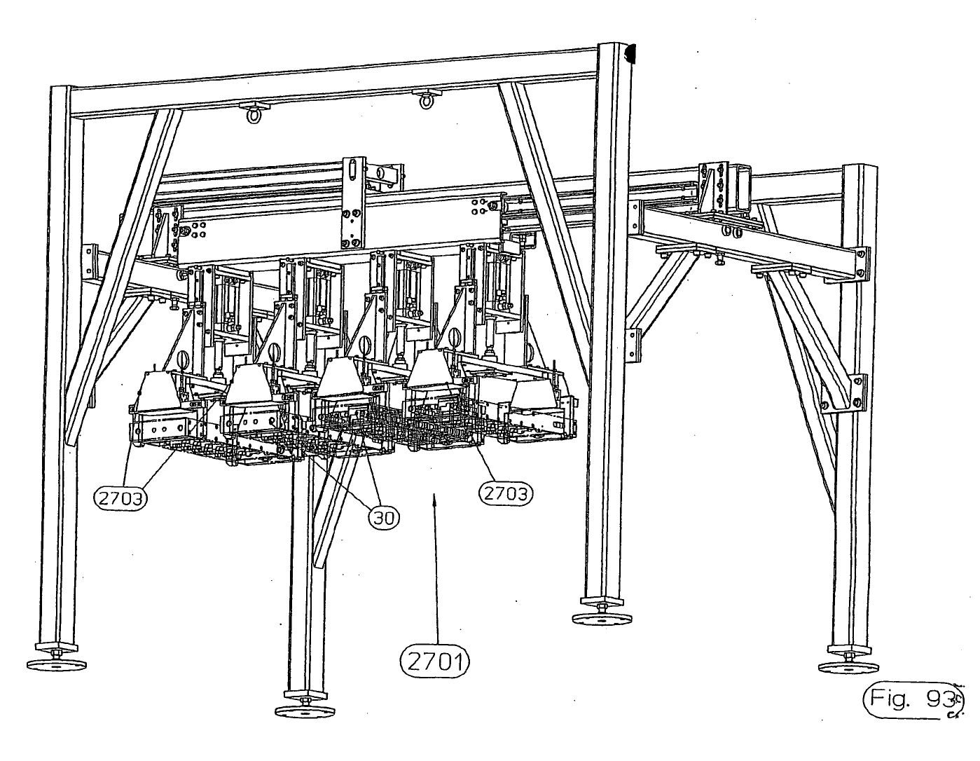

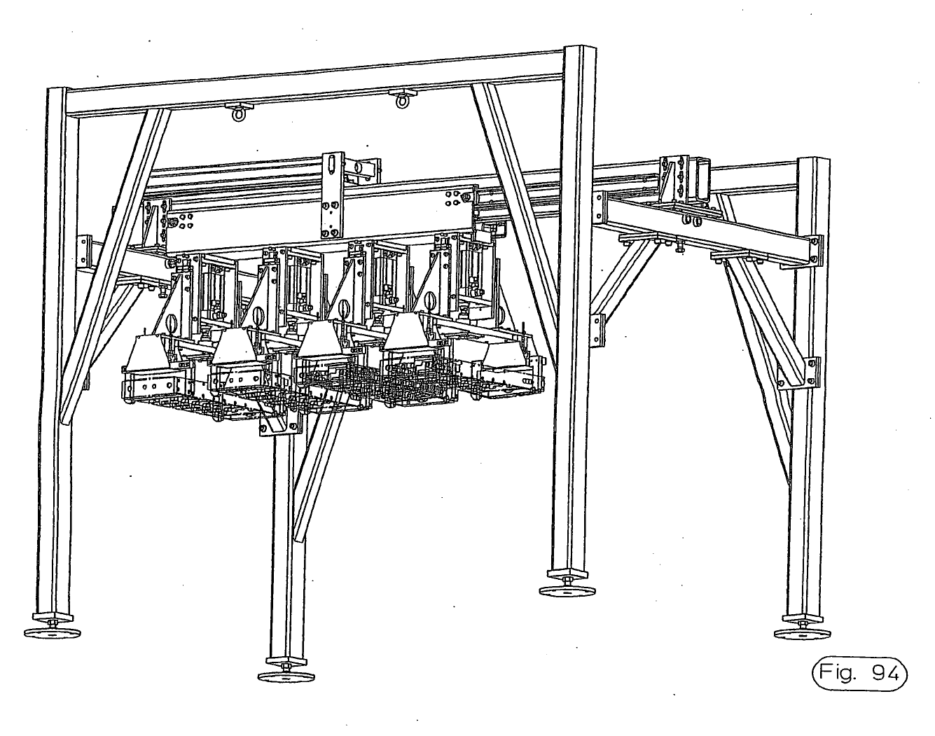

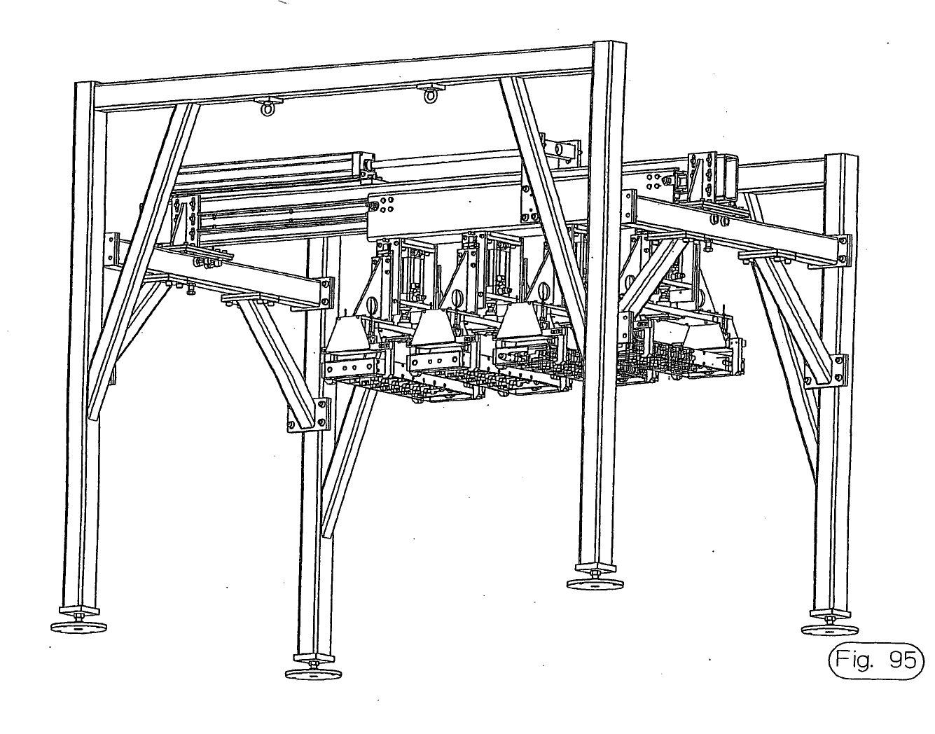

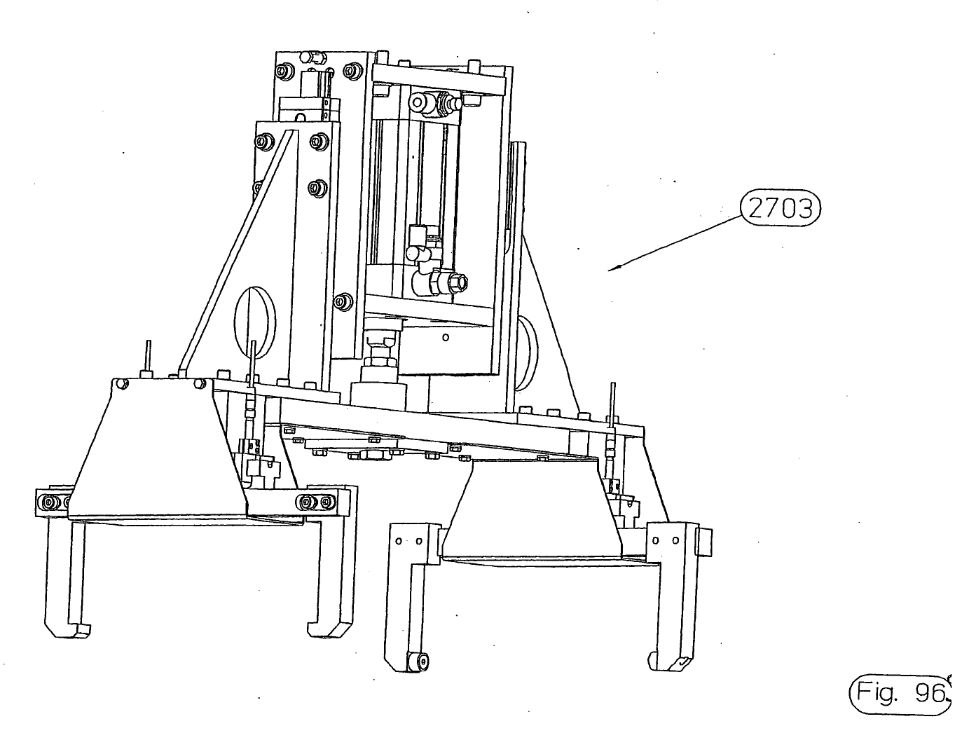

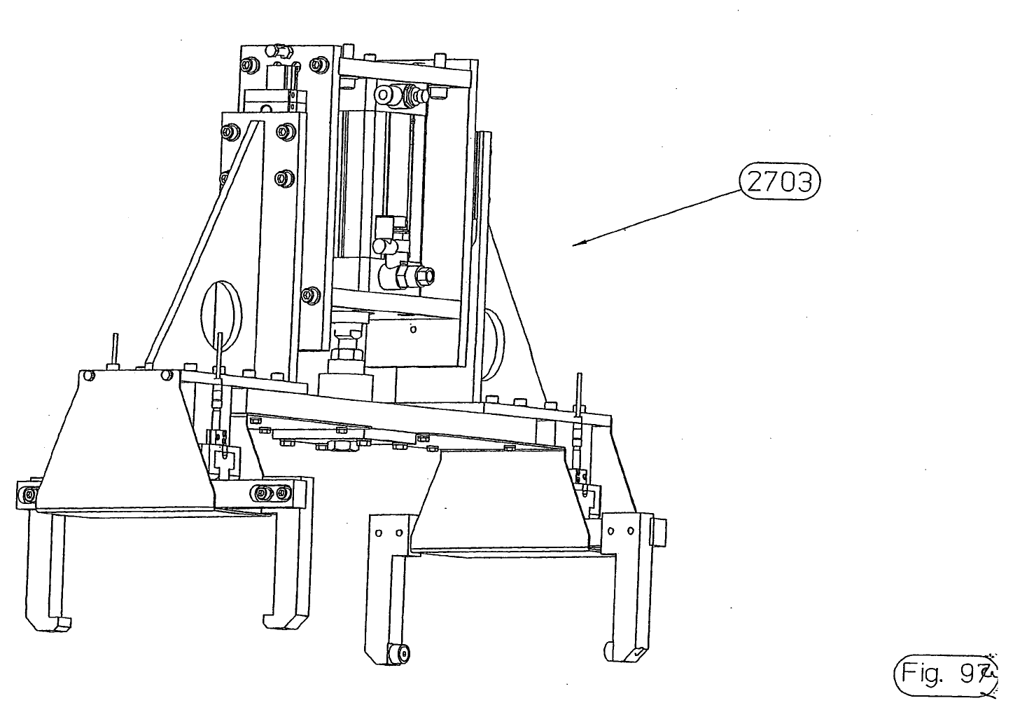

FIGS. 93 to 97 show a portal transfer device provided in the region of the casting station including grippers for grasping cassettes with battery plates,

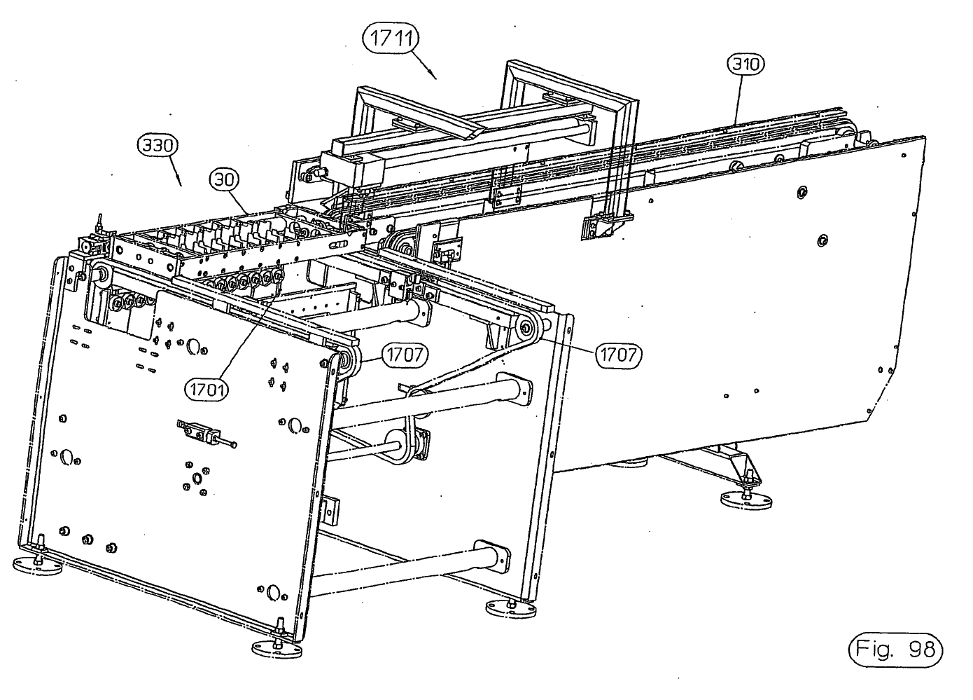

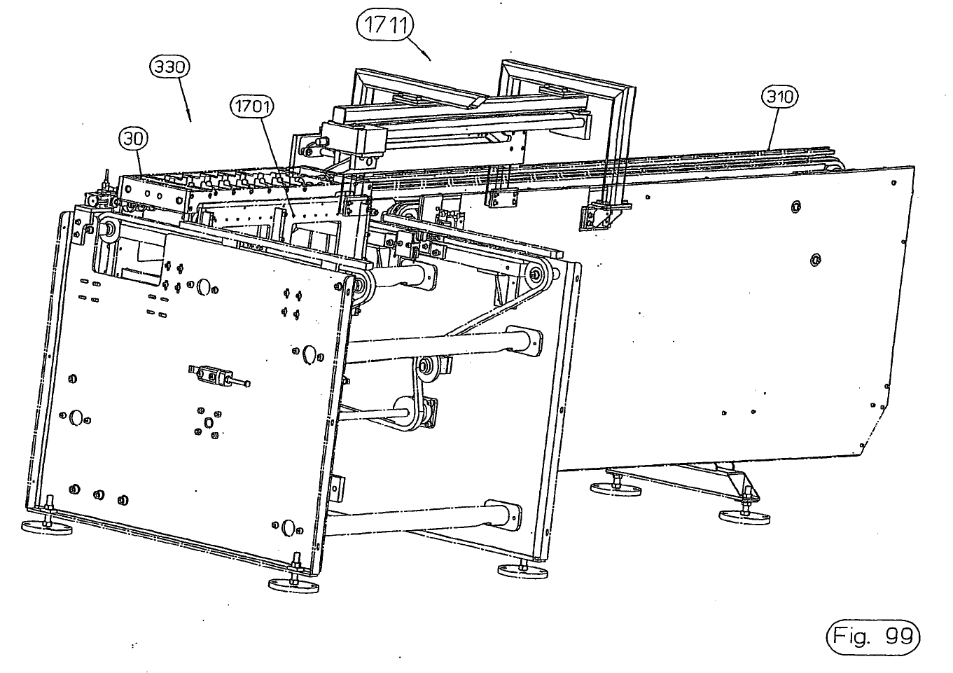

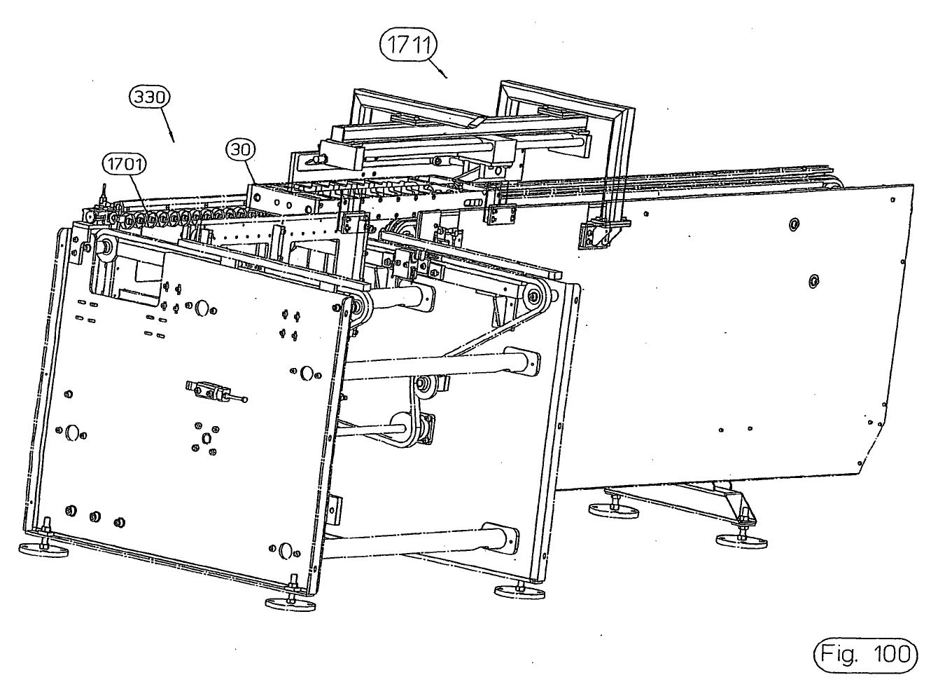

FIGS. 98 to 102 show a corner transfer device at the start of the return segment in different views,

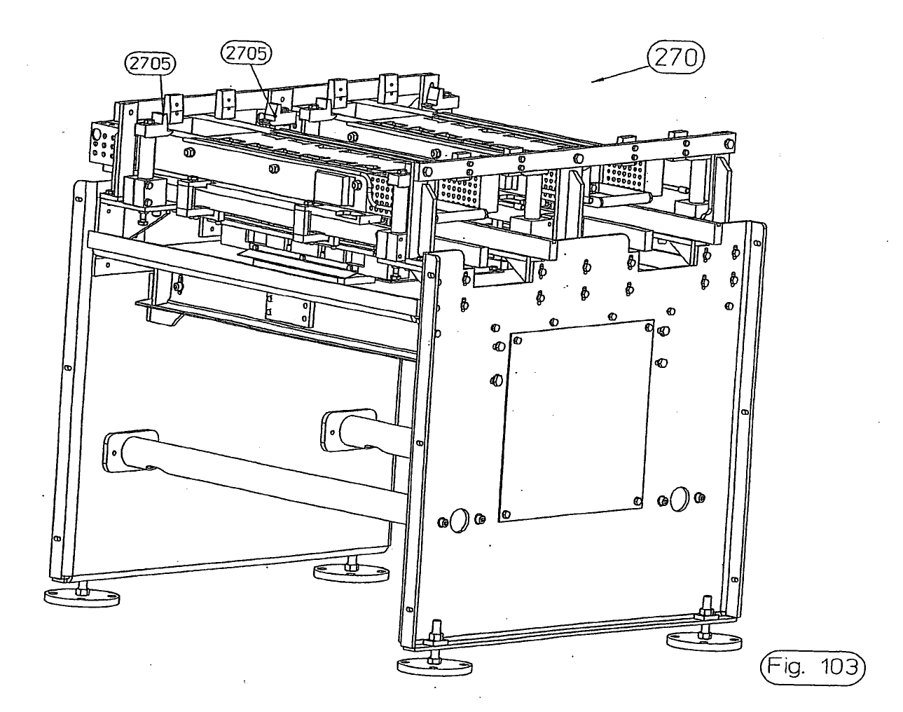

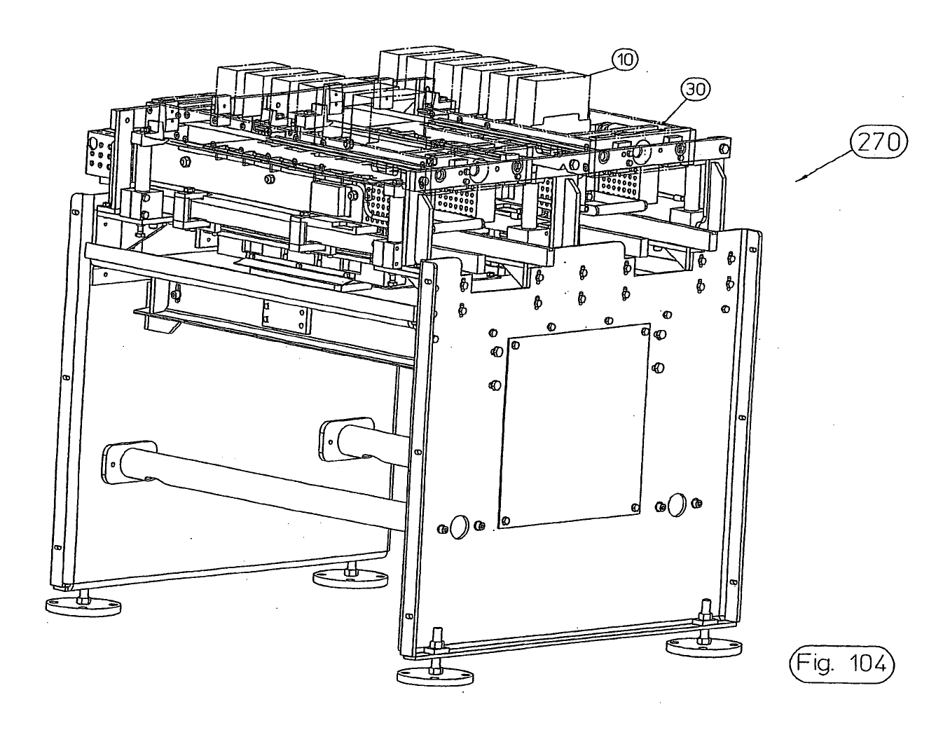

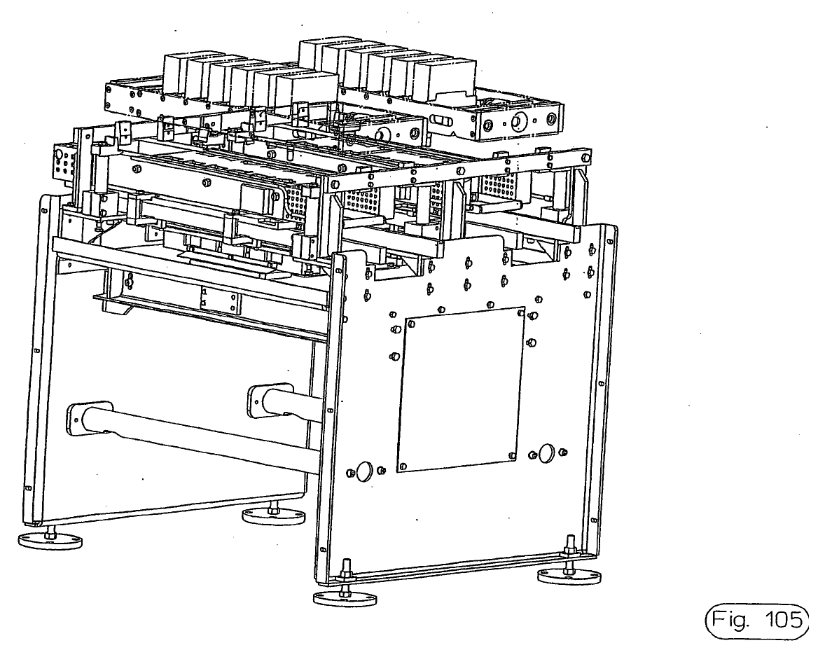

FIGS. 103 to 105 show a casting station in different views,

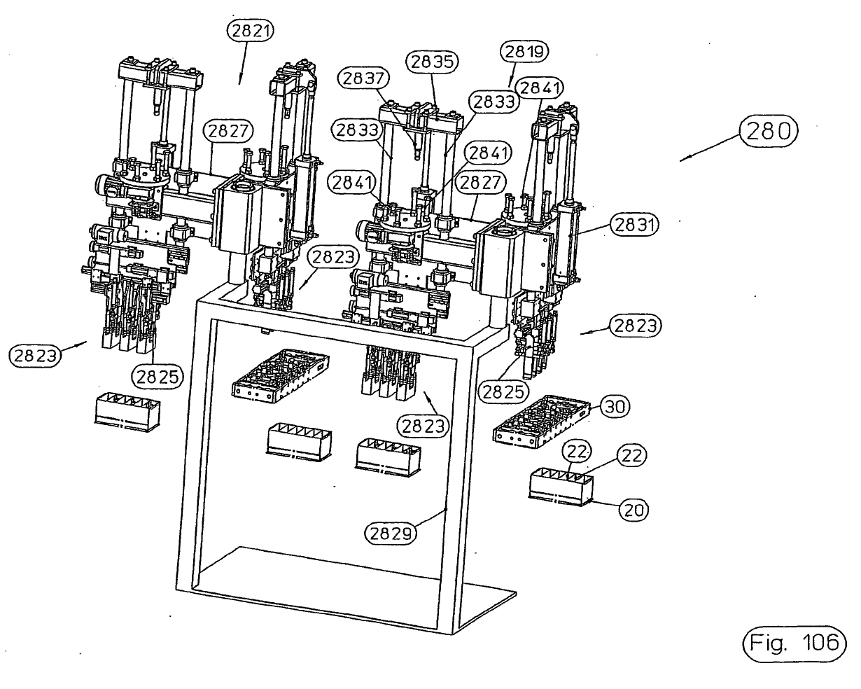

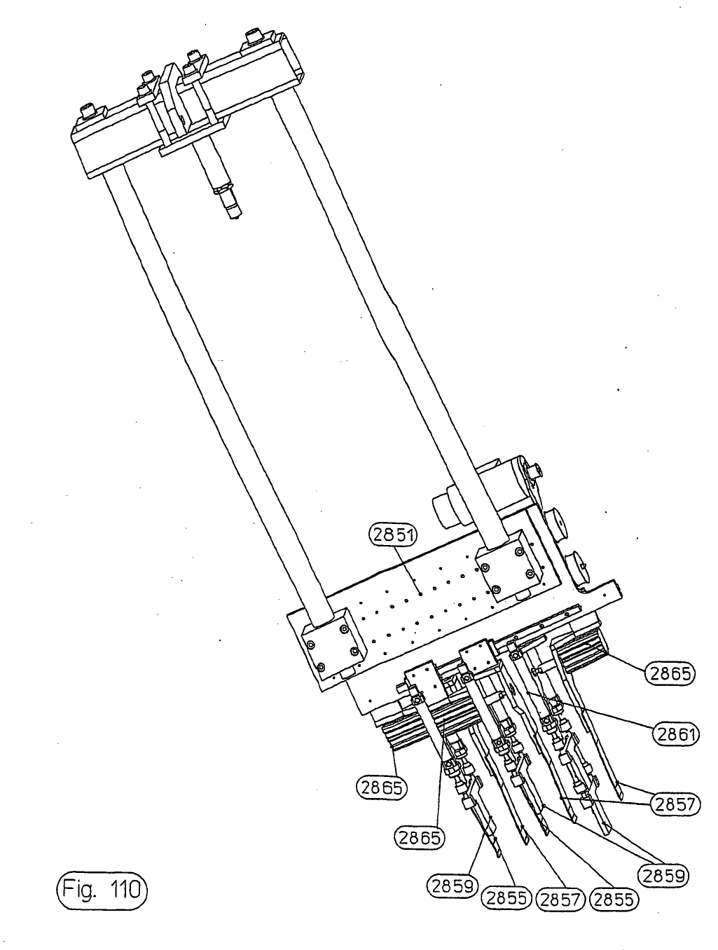

FIGS. 106 to 112 show a station for removing battery plates from cassettes and for insertion of battery plates into battery cases,

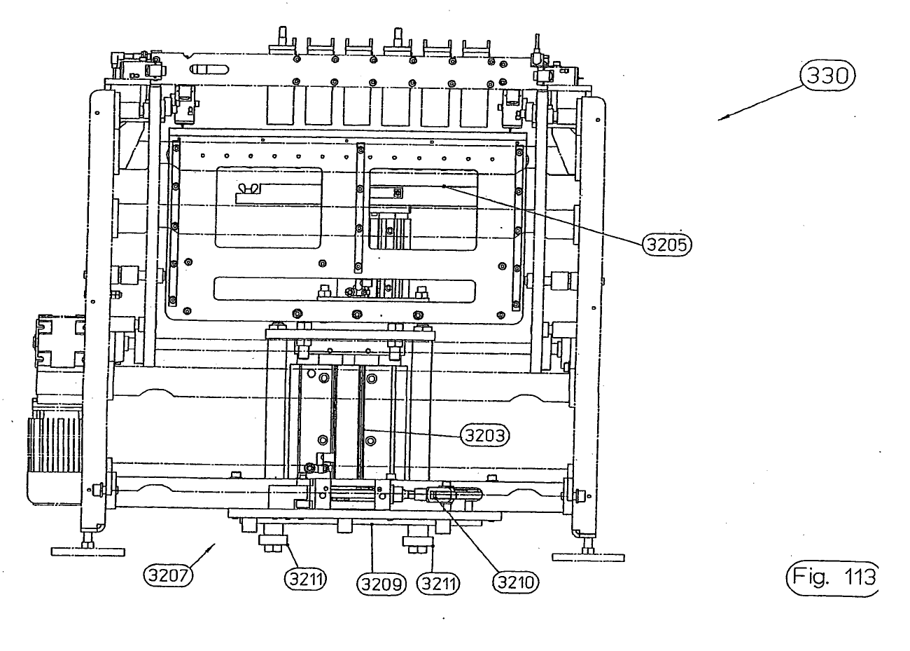

FIGS. 113 to 116 show a plate holding table in an unloading station,

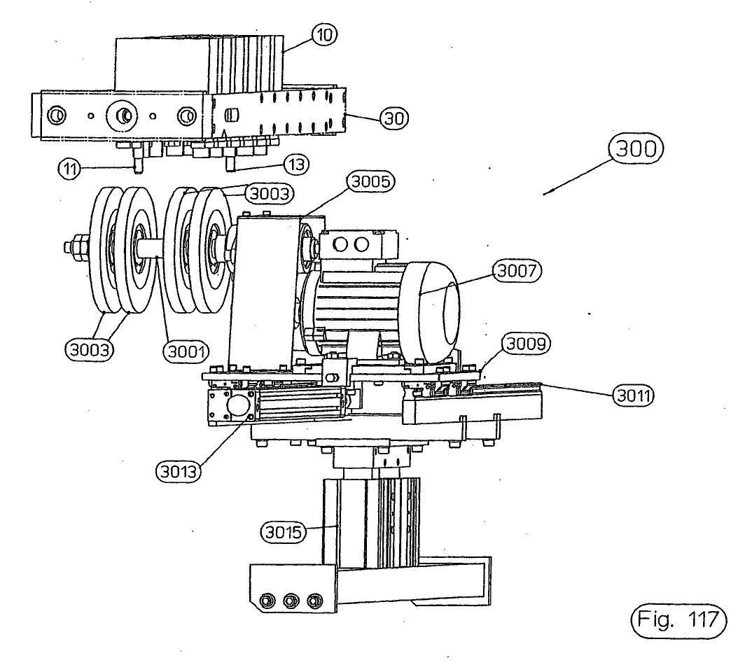

FIGS. 117 to 119 show a casting cleaning brush.

FIG. 53 schematically shows a pack 10 of battery plates—positive and negative plates in alternation—in the region of the (front) narrow side there being the lugs 12 of the positive plates and in the region which is behind in the region of the drawings in FIG. 53 the lugs of the negative plates are located. As mentioned above, either the negative or the positive plates are inserted into pockets of separator material.

The lugs 12 of the positive plates are interconnected by a bridge 16. Likewise the lugs 14 of the negative plates are interconnected by a cast-on bridge 18. FIG. 54 shows that on the bridges 16 and 18 which interconnect the lugs 12, 14 of the negative and the positive plates there is one flange 17, 19 at a time which project up and which are used to connect the battery plates which in adjacent cells 22 of a battery case 20 by intercell connectors 24 [sic].

In the cassettes 30 which are used to transport plate packs 10 through the various stations of the system as claimed in the invention, the plate packs 10 are arranged such that on one lengthwise side of the cassettes 30 there are solely lugs 12 of the positive plates and on the other lengthwise side, lugs 14 of the negative plates.

In a battery the plate packs 10 however are arranged with an alternating alignment, as is shown schematically in FIG. 55. FIG. 55 also shows how the flanges 17, 19 for the intercell connectors 24 on the one hand and the pins 11, 13 on the other for producing the pole pins of the finished battery can be arranged.

FIGS. 1 to 3 show a cassette 30 of a first embodiment as can be used in the system as claimed in the invention for transport of positive and negative battery plates combined into packs 10 from station to station.

The cassette 30 has a frame 301 which is essentially rectangular. In the frame 301 there are several intermediate walls 305 which are located stationary in the frame 301 and which are connected to the lengthwise walls of the frame 301. Furthermore, in the frame 301 there are movable walls 307 which are attached to at least one connecting rod 309, but preferably two connecting rods (in FIGS. 1-3 only one connecting rod 309 is shown) which is movably guided in the lengthwise direction of the frame 301. Preferably in the frame 301 there are two connecting rods 309 which are aligned parallel to the lengthwise walls 303 of the frame 301. The movable walls 307 are held on the connecting rods 309 via attachment blocks 311 which are attached to the connecting rods 309 and are connected to the movable walls 307.

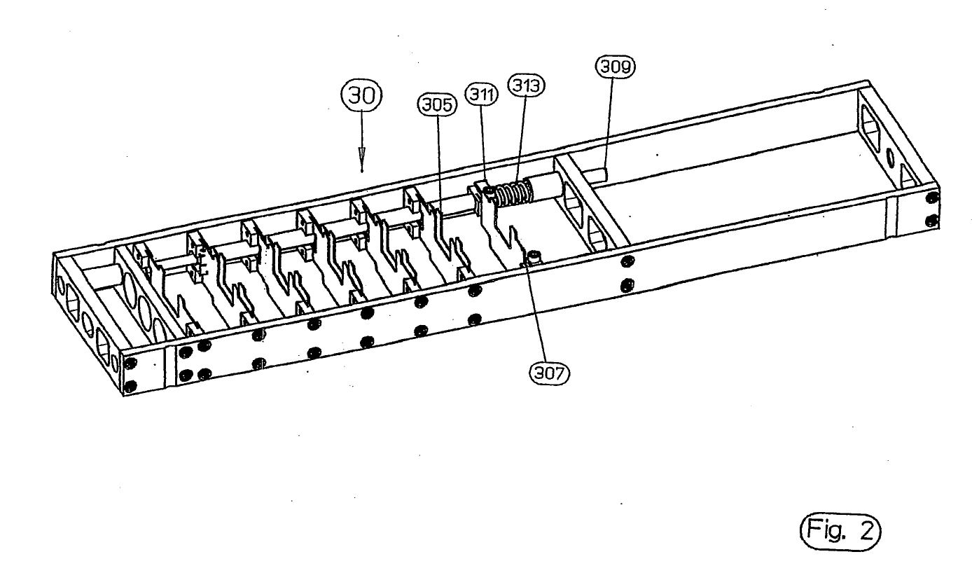

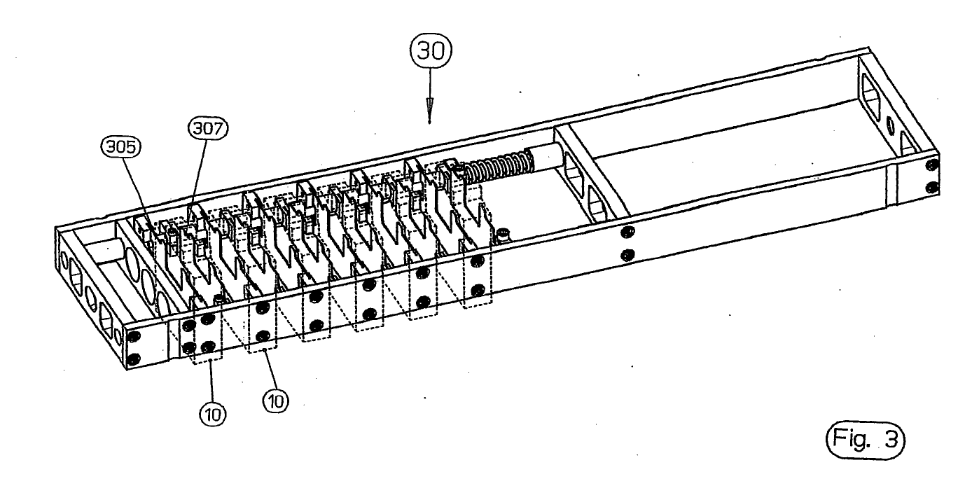

Helical compression springs 313 which are supported via a sleeve 315 on a transverse wall 317 fixed in the frame 301 are placed over the connecting rods 309. By pressure on the ends of the two connecting rods 309 opposite the springs 313 the movable walls 307 can be moved out of the position shown in FIG. 1 (“closed cassette”) into the position shown in FIG. 2 (“open cassette”) as the springs 313 are compressed. In the “open cassette” position between each stationary intermediate wall 305 and the movable wall 307 assigned to it there is a free space which is wider than the thickness of a plate pack 10 which is to be inserted into the cassette and which is to be clamped in the cassette 30. It is shown in FIG. 3 how plate packs 10 (shown by the broken line in FIG. 3) in the cassette are fixed by clamping between the frame-mounted intermediate walls 305 and movable walls 307.

The entire system which is shown in FIGS. 4 to 7 as viewed from different directions in a first embodiment and in which the process as claimed in the invention can be carried out consists of the following components (stations):
a magazine 40 made as a bucket belt (“fifteenth station”) for cassettes, preferably there are two bucket belts for different cassettes 30,
a first corner transfer station 50 (“corner transfer device”) “sixteenth station” in which the cassettes delivered from the bucket belt (they move transversely to their lengthwise extension) are transferred out of the first direction of movement into a second direction of movement which includes an angle of 90°with the first (the cassettes now move in the direction of their lengthwise extension),
a station 60 (“first station”) for loading cassettes with battery plate packs,
a station 70 (“second station”) for alignment of plates and lugs in the cassettes,
a second corner transfer station 50 on the of the first segment of the path of movement (“third station”, “corner transfer device”)
a station 80 (“fourth station”) for bending of outer lugs of battery plates in the second segment of the path of movement,
a station 90 (“fifth station”) for turning the cassettes around their lengthwise axis by 180°,
a station 100 (“sixth station”) for brushing the lugs,
a station 110 (“seventh station”) for treating the lugs with flux (fluxing),
a station 120 for casting-on (“ninth station”) of bridges with intercell connectors and pole pins,
another station 90 (“eleventh station”) for turning the cassettes around their lengthwise axis,
another corner transfer device 50 (“twelfth station”) on the end of the second segment of the path of movement,
in the third segment of the path of movement a station 130 (“thirteenth station”) for removing plate packs 10 (positive plates on the one hand and negative plates on the other) from the cassettes 30 and for insertion of plate packs into battery cases 20,
on the end of this segment of the path of movement another corner transfer device 50 (“fourteenth station”) in which empty cassettes are moved farther to the storage towers (“fifteenth station” bucket belt).

The path for movement of the cassettes 30 extends through the entire system. The path of movement is composed of four segments which are at an angle of 900 to one another, in each corner of the path of movement there being corner transfer devices 50 which relay (“transfer”) the cassettes 30 to the next segment of the path of movement.

The individual stations of the system (FIGS. 4 to 52) and the working processes which are executed in them are described below.

The station 60 (“first station”) provided in the first segment of the path of movement for insertion of plate packs 10 into cassettes 30 is shown in FIGS. 8-12 in different working positions and views and has a manipulator 601.

The manipulator 601 has grippers 602 which can be moved around several axes for holding plate packs 10 which have been delivered on conveyor paths 603. The grippers 602 insert the plate packs 10 which have been picked up by them into the cassettes 30 delivered on the first segment of the path of movement.

Each gripper 602 is equipped with two fork-shaped gripping elements which are placed from the outside against one pack 10 of battery plates at a time and which hold it fast by clamping.

For example, the grippers 602 used in the station 60 for loading of cassettes 30 with battery plates can have a design as will be described below using FIGS. 44-47 for the grippers 1301 of the “thirteenth station” 130 for removing packs 10 of battery plates from cassettes 30 and for inserting then into battery cases 20. Alternatively there can also be other grippers, for example pivoting grippers.

The plate packs 10, each consisting of the corresponding number of positive and negative battery plates, of which either the negative or the positive battery plates can be “pocketed” in jackets of separator material, are inserted into the cassettes 30 such that next to the long wall 303 of the frame 301 of the cassettes 30 only lugs 12 of positive plates and next to the opposing long wall only lugs of negative plates 14 are located. This is advantageous for casting-on of bridges 16 and 18 which interconnect the positive and negative lugs.

The cassettes 30 loaded with packs 10 of battery plates are routed along the first segment of the path of movement to a station 70 (“twelfth station”) in which the plates and the lugs of the plates are aligned (FIGS. 13-16).

In this station 70 the movable walls 307 of the cassettes 30 are moved by actuating the connecting rods 309 such that the battery plates of the packs 10 can be moved relative to one anther. First, the plates are aligned in this station 70, for which there are two straightening strips 701, 703 in this station 70; as shown in FIGS. 13 and 15, they act on the regions of the plates projecting underneath over the cassette frame 310, from opposite sides. For this purpose the straightening strips 701, 703 are mounted on the frames 705, 707 which can be moved close to one another or farther apart by a spur wheel-rack drive 709 (FIG. 14) in symmetrical movements.

To straighten the lugs, above the cassettes 30 there is a lug straightening device 713 made with sloped strips 711. This lug straightening device 713 has two pairs of strips 711 which are pivotally supported in holders 715. The shaft 717 which bears the outer strips 711 of each pair is coupled via a lever 719 to a hydraulic motor 721 so that it can be pivoted. To achieve synchronous movement of the second strip 711 of each pair, the shafts 717 of the outer pair of strips is provided with a gear wheel which meshes with a gear wheel which is attached to the shaft of the strip 711 which is the inner one at the time (FIG. 16).

After the plates in the cassette 30 have been aligned in the station 70 by the straightening strips 710, 703 taking effect for the plates of all packs 10 and the straightening strip 711 for the lugs 12, 14, the movable walls 307 of the cassette 30 are activated again by no longer pressing on the connecting rods 309 which bear the movable walls 307. The compression springs 313 press the movable walls 307 with clamping of the plate packs 10 now toward the intermediate walls 305 again.

The corner transfer device 50 which is shown in FIGS. 17 to 19 is used to transfer the cassettes 30 loaded with packs 10 of battery plates from the first segment of the path of movement into the second segment of the path of movement which is perpendicular to it. Here the cassettes 30 in the first segment of the path of movement are moved parallel to their lengthwise direction, conversely they are moved in the second segment of the path of movement transversely to their lengthwise direction from station to station of the second segment.

The corner transfer device 50, located on the end of the first segment of the path of movement above the latter and its conveyor means (belts), has two endless belts 501 (or conveyor chains) which are motorized (motor 503) to push cassettes 30 from the first segment of the path of movement on slide rails 505 which are located at the start of the second segment of the path of movement. In addition, the endless belts 501 which are provided with at least one driver strip 502 are supported to be able to pivot using a hydraulic motor 509. The slide rails 505 can be raised and lowered using at least one hydraulic motor 507.

In the first stage, when a cassette 30 is being transferred from the first segment of the path of movement into the second segment of the path of movement, the forward region of the cassette 30 has already been pushed onto the slide rails 505, conversely the rear part is still clamped between the conveyor means 511 of the first segment and the conveyor means 501 located above it and is pushed farther, supported by the driver strip 502.

In FIG. 18 the cassette 30 is located entirely on the slide rails 505. They are now lowered (FIG. 19) so that the cassette 30 with its ends is located on the conveyor belts 513 of the second segment of the path of movement. In addition to the two conveyor belts 513 there are guide sheets 515 assigned to the ends (narrow sides) of the cassettes 30.

The first station (“fourth station”) on the second segment of the path of movement is a station 80 for bending of the lugs of each plate pack 10 which are outermost at the time (FIGS. 20-22). This station 80 has a bridge 801 above the second segment of the path of movement in which there is a device 803 for bending of lugs which can be raised and lowered. The device 803 for bending of lugs has the rectangular frame 805 shown in particular in FIG. 22 with bending plates 811 which can be actuated by hydraulic cylinders 807 via connecting rods 809. The bending plates 811 are arranged in pairs and when the lug bending device 803 is being used they press to the inside the lugs of each plate pack 10 which are outermost at the time so that they are sloped at an angle. In this connection the lugs are sloped to the inside toward the center of the plate pack 10.

FIG. 20 shows the bending device 803 in the readiness position and FIG. 21 shows the bending device 803 in its active position, therefore when lugs are being bent. Here the process is such that the bending device 803 is lowered with its frame 805 onto the plates in the cassette 30 and then the bending plates 811 are actuated by actuating the hydraulic cylinders 807 for bending the lugs of each plate pack 10 which are outermost at the time.

The cassettes 30 with the lugs of each plate pack 10 which are outermost at the time and which have now been bent inward are moved into a station 90 (“fifth station”) in which the cassettes 30 are turned around their lengthwise axes by 180° so that the lugs 14, 16 now point down. This station 90 is shown in FIGS. 23 and 24. The turning device of the station 90 has a loop-shaped base body 901 which can be raised and lowered using a hydraulic cylinder 903. On one end of the base body 901 there is a cone 907 which can move on a carriage 905; the cone fits into a corresponding recess 321 on one transverse wall of the cassette 30. On the other end of the base body there is a cone 911 which can be actuated by a hydraulic cylinder 909 and which fits into a recess 323 on the other end of the cassette 30. This cone 911 can turned by a motor 913 so that the cassette 30 can be turned out of the position shown in FIG. 23 around its lengthwise direction into the position shown in FIG. 24. Now the lugs 12, 14 of the battery plates which are clamped in the cassette 30 point down. In an alternative embodiment of the station 90 not only the cone 911, but the entire assembly of the cone 911, motor 913 and gearing 915 can be moved by the hydraulic motor 909 in order to move the cone 911 into or out of the opening 323 of the cassette 30.

The cassettes 30 with the lugs 12, 14 now pointing down are transported to a station 100 (“sixth station”) in which the lugs are brushed, if necessary. This station 100 for lug brushing (FIGS. 25-26) has round (metal) brushes 1001 which are pivotally mounted in a frame 1003 and which are driven by a drive motor 1006 in opposite directions. The cassettes 30 with the battery plates held in them are transported simply through the second segment of the path of movement via this brush station 100, the lugs 12, 14 being brushed bare.

The station 100 with the two wire brushes 1001 for brushing the lugs 12, 14 is shown n FIGS. 25 and 26, in FIG. 26 for the sake of clarity one brush roller 1001 having been removed. It is apparent that on the bottom end of the trough 1005 via which the brush rollers 1001 are held with a capacity to rotate, there are slots 1007 to which a suction means 1009 is assigned for exhausting abraded fragments which are formed when the lugs 12, 14 are brushed.

Following the station for brushing the lugs 12, 14, there is a station 110 (“seventh station”) in which the now brushed lugs 12, 14 of the battery plates are treated with flux. One embodiment for the station 110 is shown in FIGS. 27 and 28. This station 110 has a trough 1101 in which there is a foam body (1102) (“sponge”) impregnated with flux. The trough 1101 can be moved by a lifting drive 1103 out of the readiness position with a distance underneath a cassette 30 with battery plates which is located in this station 110 (FIG. 27) into a working position in which the lugs 12, 14 of the battery plates are pressed into the flux-impregnated foam body 1102 for fluxing of the lugs 12, 14 (FIG. 28), and can then be lowered again. In the trough 1101 there is a device for monitoring the level of the flux. On the two lengthwise sides of the trough 1101 with the foam body 1103 with flux there are pipes 1105 with nozzles 1107 for blowing out hot air to dry the lugs 12, 14 after fluxing. Hot air is supplied to the pipes 1105 with the nozzles 1107 from a fan 1109 with a heating means 1111. Drying of the lugs 12, 14 is done after the trough 1101 has been moved from the cassette 30 with the packs 10 of battery plates by lowering again into the position shown in FIG. 27.

Following the station 110 for fluxing of the lugs 12, 14 of the battery plates there is a station 120 (“ninth station”) in which the bridges 16, 18 with the flanges 17, 19 for the intercell connectors and the pole pins 11, 13 (where necessary) are cast onto the lugs 12, 14 of the battery plates. This device 120 is shown in FIGS. 29 to 31.

In the illustrated embodiment, the station 120 for casting-on of bridges 16, 18 is set up such that the plate packs 10 which are held in two or three cassettes 30 can be supplied at the same time to two or three casting molds 1201. Here it is provided that the casting molds 1201 are supported stationary in the station 120 and the undersection 1203 of the second segment of the path of movement located in the region of the station 120 (casting station) is made to be able to be raised and lowered, so that the bridges 16, 18 which connect the lugs 12, 14 of the battery plates can be cast on. The feeding of molds 1201 for casting-on of the bridges 16, 18 with the metal melt (molten lead alloy) as well as the execution of the molds 1201 themselves are familiar to one skilled in the art and need not be detailed in particular.

Following the station 120 for casting-on of the bridges 16, 18 of the flanges 17, 19 for intercell connectors and pole pins 11, 13 there is another rotation station 90 in which the cassettes 30 are turned again such that the lugs 12, 14 of the battery plates, now with the bridges 16, 18 and the flanges 17, 19 cast on, and pole pins 11, 13 where necessary, again point up.

Following the station 100 for treating the lugs with flux (“fluxing”) and following the station 120 for casting on the bridges there is one or two buffer sections at a time depending on the system size. These buffer sections make it possible to equalize the different working times in the individual stations.

At the end of the second segment of the path of movement there is again a corner transfer device 50 which is shown in FIGS. 32 to 34. A cassette 30 delivered transversely to its lengthwise extension on the segment of the path of movement (conveyor belts 513) is raised by lifting strips 505 from the conveyor means 513 of the second segment, and using conveyor belts 501 which are located above the lifting strips 505 (or (endless) chains with drivers 502 as linear axes) which are pivoted down into their active position (cylinders 509) is transported onto the third segment of the path of movement in which the cassettes 30 are again moved parallel to their lengthwise direction. Here FIG. 32 shows how a cassette 30 has arrived at the end of the second segment of the path of movement, FIG. 33 shows the cassette 30 lifted off the lifting strips 505, and FIG. 34 shows how the cassette 30 has been transferred onto the next segment (third segment) of the path of movement and the next cassette 30 has already arrived at the end of the second segment of the path of movement.

In this third segment of the path of movement the cassettes 30 are moved to a station 130 (“thirteenth station”) for unloading of the cassettes 30 and insertion of the plate packs 10 which have been removed from the cassettes 30 into the battery cases 20.

The station 130, therefore the thirteenth station of this embodiment of the system as claimed in the invention, is divided into two substations (in the example formed by parallel transfer devices) which have essentially an identical structure; their purpose, structure and operation will be described below with reference to FIGS. 35 to 51.

Parallel to this segment of the path of movement there is a conveyor 140 (FIGS. 4, 50, 51) for delivering battery cases 20 into which the plate packs 10 are to be inserted by grippers 1301 of the thirteenth station 130 in a manner yet to be described. In the conveyor 140 for the battery cases 20 there is a station 1401 in which the battery cases 20 can be turned around a vertical axis.

The reason why there are two parallel transfer devices with three grippers 1301 each and in between one station 1401 for turning the battery cases 20 by 180° around a vertical axis is that in the cassettes 30 the packs 10 of battery plates are inserted such that on one lengthwise side only the lugs 12 of positive plates are located and on the other lengthwise side only the lugs 14 of the negative plates are located. The reason for this arrangement was described above in conjunction with station 120 for casting-on of bridges 16, 18, etc.

The two parallel transfer devices with three grippers 1301 each of the thirteenth station 130 have an identical structure and are described below using FIGS. 35 to 49.

Each parallel transfer device, movable on guide rods 1303, has an arrangement of (three) grippers 1301 (for example with the embodiment to be described using FIGS. 44-49). The grippers 1301 are held adjustably in a carriage 1305 which can be moved on the guide rods 1303 in a frame 1307 so that the relative distance of the grippers 1301 from one another can be changed. To move the carriage 1305 transversely to the conveyor direction of this segment of the path of movement there is a hydraulic motor 1309. To raise and lower the grippers 1301 there are (three) other hydraulic motors 1311.

FIG. 35 shows how the cassette 30 is in the position in which the first group of three packs 10 of battery plates contained in them can be removed. For example, it is the first, second and third plate pack 10. For this purpose the grippers 1301 are lowered from the position shown in FIG. 35 into the position shown in FIG. 36 and the gripper sheets 1321/1322 are closed so that one plate pack 10 at a time is clamped in each gripper 1301. The grippers 1301 with the plate packs 10 clamped on them are now raised (FIG. 37) and are moved by actuating the carriage 1305 transversely to the alignment of the fourth segment of the path of movement until they are located above a battery case 20 which has already been placed on the conveyor 140. Then the grippers 1301 with the plate packs 10 are lowered again (FIG. 39).

Before the plate packs 10 are inserted into the battery case 20 into the corresponding compartments 22 for the cells (cell compartments “1”, “3”, and “5”), by lowering the grippers 1310 and raising the battery cases 20 the grippers 1301 are moved away from one another to the corresponding distance.

Altogether the following movements take place:

The grippers 1301 are located first in the base position: gripper/gripper distance—spacing of the cassette 30; all grippers 1301 in the raised position as shown in FIG. 35.

The grippers 1301 are lowered into the cassettes 30 (FIG. 36). Then the three grippers 1301 are pushed laterally (5 mm—movement of the displacement cylinder 1323 in FIG. 42) so that the fixed gripper sheets 1321 laterally adjoin the packs 10 of battery plates. Then the packs 10 are clamped by the respective gripper 1301 by the movable tongues 1322 being adjusted (FIG. 36). Then the grippers travel up (FIG. 37), and parallel offset of the grippers 1301 relative to one another takes place for matching of the spacing to the battery case spacing (distance of compartments 22 for the cells (FIG. 38). Afterwards the grippers 1301 are lowered and deposit the packs 10 of battery plates in the battery case 20 (FIG. 39) which is raised for this purpose.

As the process continues, the grippers 1301 again travel up and the battery case 20 down, and parallel offset of the grippers 1301 to the cassette 30 takes place. During this parallel offset the spacing between the grippers 1301 is again brought to the spacing of the cassette 30 and the grippers 1301 are moved laterally (5 mm). At this point the grippers 1301 are again in the initial position.

The grippers 1301 of the second parallel transfer device of the station 130 work analogously to insert the three remaining packs 10 from the cassette 10 into the (still empty) compartments 22 of the battery case 20.

FIGS. 40 and 41 show the grippers 1310 (viewed from the back of FIGS. 35-39) in two different spacings to one another (distance of the grippers 1301 from one another). The grippers 1301 can be moved together or apart with equal spacing. This takes place via two threaded spindles 1342, 1343 (FIGS. 42, 43) with different thread pitch (one spindle has twice the pitch of the other spindle) which are driven by a motor 1340 via gearing 1341.

The design of the grippers 1310 of the two parallel transfer devices of the thirteenth station 130 is described below using FIGS. 44-49. Each gripper 1301 has a stationary gripper tongue 1321 (gripper sheet) and one movable gripper tongue 1322 which can be moved parallel to the fixed gripper 1321. The gripper tongue 1322 which is movable is located on the carrier 1323 which is connected to the two guide rods 1325 which can be moved in the base plate 1327 of the gripper 1301. The guide rods 1325 are connected to connecting pieces 1329 which are L-shaped in this embodiment and which can be moved on four guide pins 1331 on the base plate 1327. The connecting pieces 1329 are loaded by springs 1333 which are placed over the guide pins 1331 so that the movable gripper tongue 1322 in the direction away from the stationary gripper tongue 1322, therefore into the position at a distance from the latter, is loaded. To close the gripper 1301, therefore to move the movable gripper tongue 1322 toward the stationary gripper tongue 1321, there is a wedge 1351 which can be actuated by a hydraulic motor 1350 and which can be moved out of the position shown in FIG. 45 (open gripper) into the position shown in FIG. 47 (closed gripper). In the active position the wedge 1351 presses the plate 1353 which connects the connecting pieces 1329 to one another away from the base plate 1327 of the gripper 1301 so that the movable gripper tongue 1322 is moved toward the stationary gripper tongue 1321 which is rigidly connected to the base plate 1327.

In FIGS. 48 and 49 there is adjustable stroke limitation 1360 for movements of the wedge 1351.

The described construction allows a slender execution of the grippers 1301 so that they can be easily inserted into the cassettes 30 for holding the battery plate packs 10 and for insertion of the plate packs 10 into compartments 22 for the cells of the battery cases 20.

FIGS. 50 and 51 show the conveyor means 140 (roller conveyor) for battery cases 20 which is provided in the thirteenth station 130 for insertion of plate packs 10 into battery cases 20. On these roller conveyors 140 battery cases 20 are moved to the first parallel transfer device for insertion of plate packs 10 into the cell compartments 22 (“1”, “3”, “5”) for battery plate packs 10, then moved from this position to a device 1401 for turning the battery cases 20 and farther to the second parallel transfer device in which the receiving spaces (compartments 22) for the cells “2”, “4” and “6” are supplied with plate packs 10. FIG. 50 shows that the battery cases 20 in the actual insertion process of the plate packs 10 into the compartments 22 for cells in the battery cases 20 are lifted off the roller conveyor 1401 by lifting devices 1402.

It is furthermore shown (FIG. 50) that for reliable insertion of plate packs 10, above the lifting means 1402 for the battery cases 20 there are funnel-shaped guide sheets 1403 which ensure reliable insertion of plate packs 10 into the cell compartments 22.

The cassettes 30 which are empty again after removal of the plate packs 10 are guided by another corner transfer device 50 to the fourth segment of the path of movement and on this farther to the first corner transfer device 50 at the start of the first segment of the path of movement. In (two) magazines 40 which are made as bucket belt magazines, cassettes 30 are kept in readiness for use, their being moved out of the bucket belt magazines 40 transversely to their lengthwise extension to the first segment of the path of movement and to the corner transfer device 50 provided at the start of this segment when cassette changing is necessary (passenger car batteries—truck batteries). The bucket belt magazines 40 store cassettes 30 and are supplied with cassettes 30/emptied when cassettes with another cassette size are required.

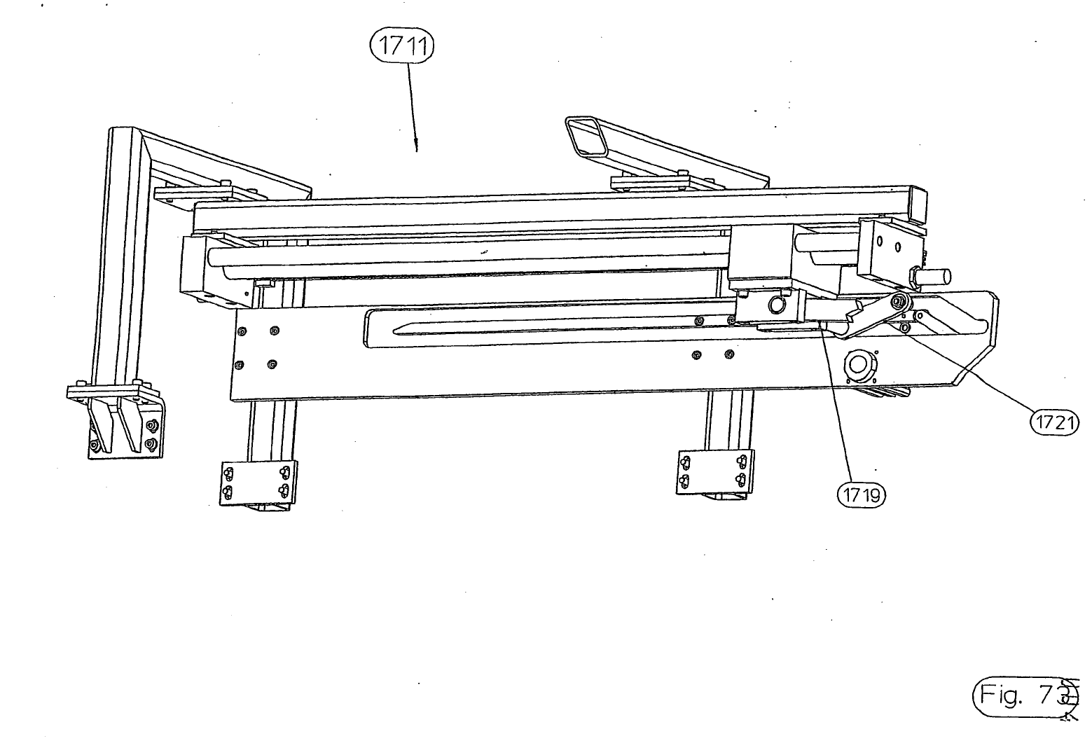

The other embodiment of a system for supply of battery cases with plate packs 10 shown in FIGS. 56 to 59 comprises the following stations:
a loading station 210 (FIGS. 80 to 84) in which cassettes 30 are loaded with plate packs 10,
a first corner transfer device 220 (FIGS. 85 to 86),
following the first rotary corner transfer device 220, a buffer site,
after the buffer site a station 70 in which plates and lugs 12, 14 are straightened (FIGS. 13 to 16),
after this station 70 a station 80 in which the outer lugs 12, 14 are bent (FIGS. 20 to 22),
after this station 80 for bending the outer lugs of the plates a station 90 in which the cassettes are turned so that the lugs 12, 14 now point down (FIGS. 23 to 24),
following the aforementioned, a station 150 (FIG. 65) in which the lugs 12, 14 are brushed,
afterwards a station 110 (FIGS. 27 to 28) in which the lugs are fluxed, i.e. treated with flux to facilitate casting-on of bridges 16, 18 and of pole pins 11, 23,
following the aforementioned, a buffer station,
after this buffer station two casting stations 270 for casting-on of the bridges 16, 18 of the flanges 17, 19 for intercell connectors and the pole pins 11, 13 (FIGS. 93 to 97 and FIGS. 103 to 105),
following the station 270 in which the pole pins 11, 13, the flanges 17, 19 and the bridges 16, 18 are cast, a buffer station and
afterwards a station 300 for brushing the pole pins 11, 13 and bridges 16, 18 for cleaning and deburring (FIGS. 117 to 119),
then a station 90 in which the cassettes 30 are again turned such that the lugs 12, 14 and the now cast-on bridges 16, 18 point up (FIGS. 23 to 24),
following the aforementioned, another buffer station which follows a second corner transfer device 230 (FIGS. 87, 88),
after the corner transfer device 230, in the system there is an unloading station 280 in which the plates delivered in the cassettes 30 are inserted into the compartments 22 of battery cases 20 (FIGS. 89-92),
after this unloading station 280 a corner transfer device (FIGS. 98 to 102) for empty cassettes 30 in order to transfer then to a return station and
following the return station another corner transfer device with which the cassettes 30 are supplied again to the loading station 210 in which they are supplied with the delivered battery plates which are combined into packs 10 (FIGS. 68 and 73).

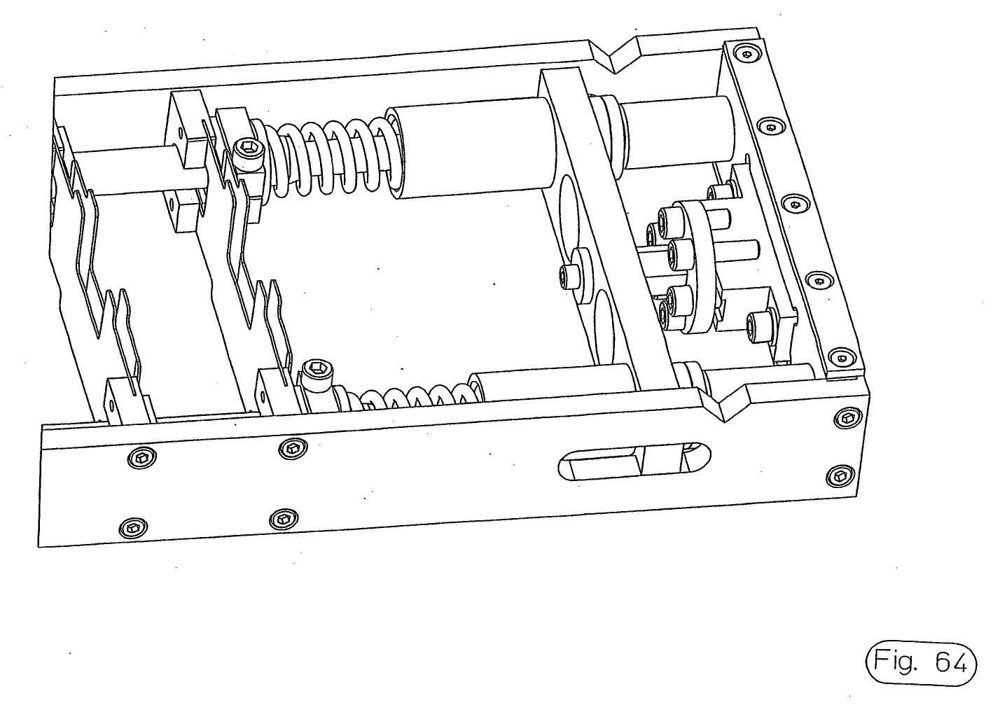

The alternative embodiment of a cassette 30 shown in FIGS. 60 to 64 in different views for transport of packs 10 of battery plates through the system takes into account the circumstance that the plate packs 10, depending on the battery type, are of varied thickness, but it is necessary to always use roughly the same clamping force to hold the plates without damage and securely in the cassettes 30. For this purpose it is provided that the sleeves 315 in which the helical compression springs 313 are supported which load the connecting rods 309 on which the adjustable intermediate walls 307 are mounted in the sense of movement onto the stationary intermediate walls 305 are attached to a wall 331 which can be moved in the cassette 30 in its lengthwise direction. On this wall 331 a disk 333 is supported to be able to turn and bears pins or studs 335 of different length. A block 337 which is attached to the narrow transverse wall of the cassette 30 is assigned to the free ends of the pins 335 (the ends of the pins 335 which face away from the movable wall 331). By turning the disk 333, the location of the wall 331 can be adjusted and thus the pretensioning of the springs 313 which load the movable intermediate walls 307 can be selected according to the thickness of the plate packs. Here it is provided that for the thickest plate packs 10 the shortest pin 335 of the rotary disk 333 is chosen (compare FIG. 64) so that the movable wall 331 which bears the sleeves 315 for the springs 313 is advanced into the space of the cassette 30 at least to the distance at which the plate packs 10 are clamped between the intermediate walls 305 and 307.

In the embodiment of the station 150 shown in FIG. 65 with a brush 1501 for working the lugs 12, 14 of the battery plates (lug brushes), there is a single, rotationally driven lug brush 1501 which is driven by an electric motor 1502. The unit 1503 consisting of the lug brush 1501, its support 1505 and the electric motor 1502 is arranged to move vertically, for which it is guided in the machine frame by four guide shoes 1507 on vertical guide rails 1509.

To vertically adjust the unit 1503 with the lug brush 1501 there is a spindle drive 1511 which can be actuated for example by a hand crank 1512.

FIGS. 66 and 67 show a means 160 with which the disk 333 provided in the cassettes 30 can be turned with stops of varied length which are made as pins 335 in order to adjust the desired force of the springs 313 by which the movable intermediate walls 307 of the cassette 30 are loaded. Here there is a pressure rod 1601 which is actuated by a hydraulic cylinder 1602 (compressed air cylinder) which acts centrally on the disk 333 which is pivotally supported on the intermediate wall 331 in order to lift the stops 335 (pins) off the block 337 on one narrow end wall of the cassette 30. By turning the disk 333 the stop 335 can be chosen which is necessary for the desired spring force relative to the thickness of the plate packs 10. The disk 333 with the stops 335 is turned for example by hand, but can also be turned using a drive which is not shown. The device of FIGS. 66 and 67 can be combined with a linear conveyor with which the cassettes are moved transversely to their lengthwise extension on endless conveyor belts or chains which are guided via several deflection rollers. This linear conveyor is preferably a corner transfer device as is shown for example in FIGS. 68 to 73 and is described below.

FIGS. 68 and 69 show a corner transfer device (lifting table) 170 as is located on the end of the return conveyor segment 310 for empty cassettes 30 via which empty cassettes 30 are conveyed out of the unloading station 280 to the loading station 210 at the start of the system, therefore the station 210 in which the cassettes 30 with the plate packs 10 are supplied. Here it is such that cassettes 30 coming from the right of FIG. 69 are moved on the raised roller conveyor 1701 of the corner transfer device 170. The roller conveyor 1701 is lowered with its lifting table 1703 by a hydraulic motor 1705 so that cassettes 30 with their ends (narrow walls) rest on the conveyor chains 1707 and are transported from them onward to the loading station 210. To reliably guide the cassettes 30 on the chain conveyors 1707, there are guide rails 1709 which run lengthwise.

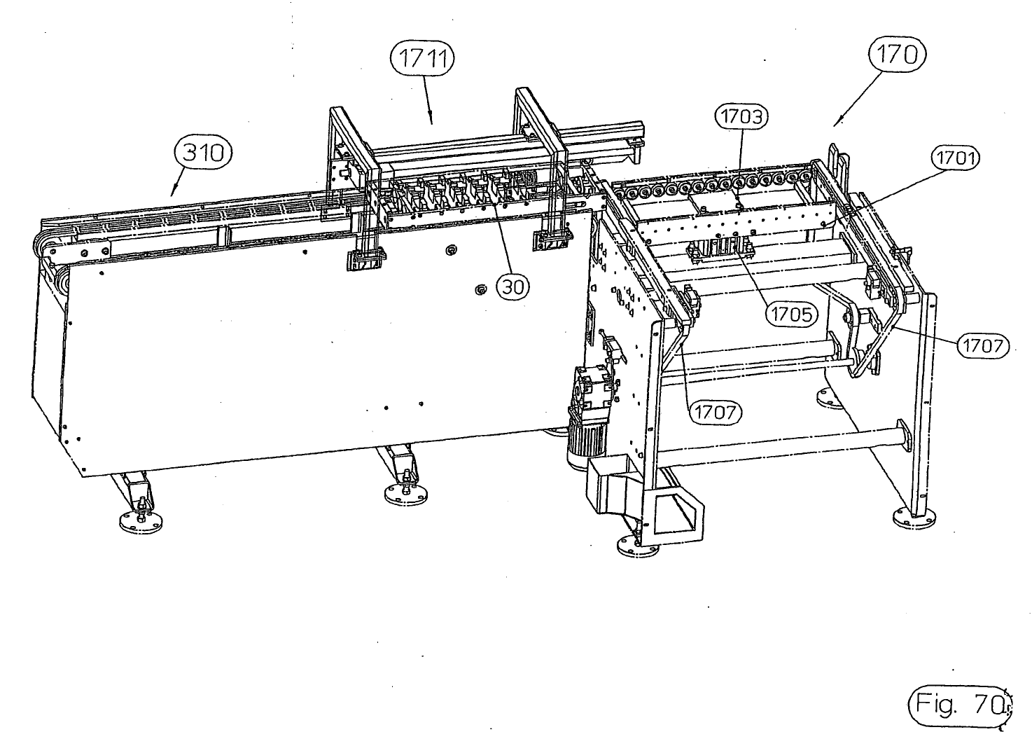

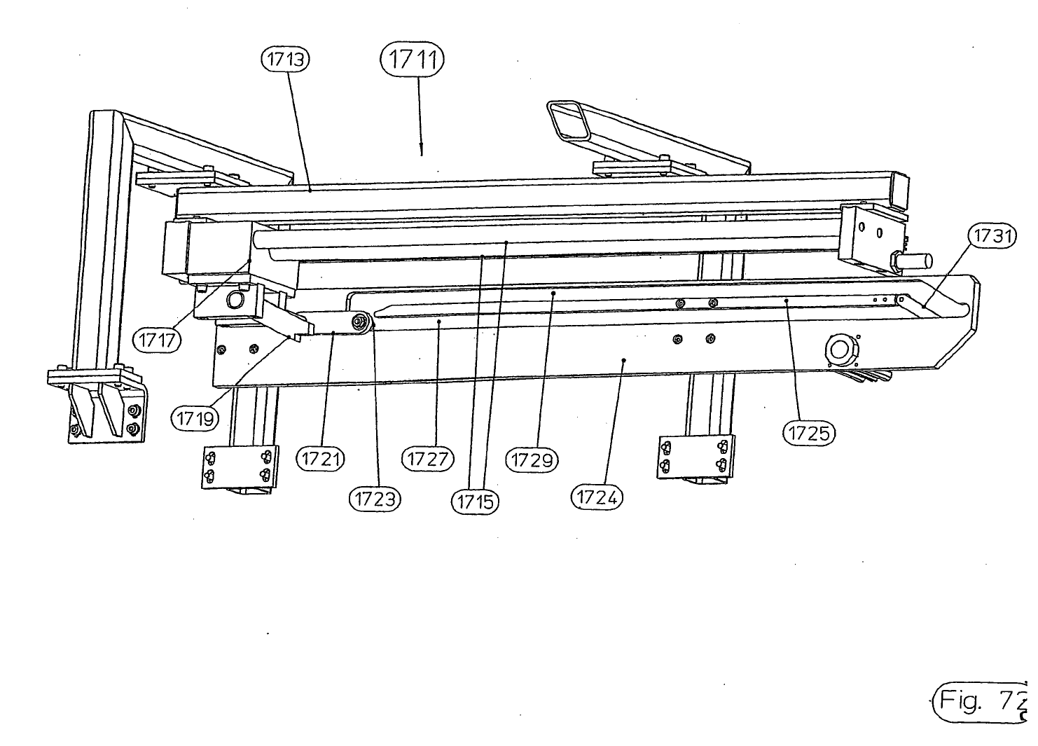

FIGS. 70 to 73 again show, viewed from the other side, the corner transfer devices 170 of FIGS. 68 and 69 with the end of the return conveyor segment 310 assigned to it for empty cassettes 30. Here it is also shown that over the end of the return conveyor segment 310 on which the empty cassettes 30 are delivered in the direction of their lengthwise extension, there is an advance device 1711 (FIGS. 72 and 73) which acts from overhead on the cassettes 30 and which transfers the cassettes 30 onto the raised lift table 1703 of the corner transfer device 1707 of FIGS. 68 and 69 by displacement. After lowering the lift table 1703, the cassettes 30 are transported onward from the chain conveyors 1707 (FIGS. 68 and 69) to the loading station 210 after the spring force of the compression springs 313 in the cassettes 30 has been set using the means 160 of FIGS. 66 and 67, if necessary.

The advance device 1711 as is shown in FIGS. 72 and 73 on a larger scale has a catch 1719 which is pivotally supported on a carriage 1717 which can be moved along guide bars 1715 by a linear drive 1713 (pneumatic cylinder), and which in moving forward acts on the back end of a cassette 30 which has reached the end of the return conveyor segment 310. The catch 1719 is assigned an actuation lever 1721 which engages a guide 1724 with a roll 1723 which is pivotally supported on it. The guide 1724 is divided by a strip 1725 which runs lengthwise into a lower guide slot 1727 and an upper guide slot 1729. On the discharge-side end of the advance device 1711 (to the right in FIG. 72) there is a pivoting flap 1731 on the lengthwise-running strip 1725. This flap 1731 causes the roll 1723 which runs first in the lower guide slot 1727 of the guide 1725 to move into the upper guide slot 1729 in the reverse stroke of the flap 1731 (FIG. 73), by which the advance catch 1719 likewise pivots up so that it moves in the return stroke above the cassette 30 which has been delivered in the meantime. On the back end (left in FIG. 72) of the guide slots 1727/1729 the roller 1723 drops again into the lower guide slot 1727 so that the catch 1719 is likewise pivoted down and is prepared for another advance process (position from FIG. 72).

FIGS. 74 to 76 show a device 190 with which the movable intermediate walls 307 of the cassettes 30 can be moved relative to the stationary intermediate walls 305 of the cassettes 30 (“opening” of the cassettes) in order to increase the space between them. Thus plate packs 10 can be used without their rubbing on the intermediate walls 305, 307. This device 190 encompasses two pins 1901 which are inserted through openings in the end wall opposite the compression springs 313 in the cassette 30. The pins 1901 move the rods 309 which bear the movable intermediate walls 307 as the springs 313 are compressed. Thus the distance between each stationary intermediate wall 305 and the movable intermediate wall 307 assigned to it is increased. The pins 1901 are actuated by a spindle lift drive 1903 which is driven by an electric motor.

A certain “opening width” of the cassette 30 is stipulated via the machine control program. By counting the revolutions of the cam disk 1905 which is coupled to the drive 1903 of the pins 1901 by means of a counting sensor 1907, this path can be defined.

When the cassette 30 is closed (pins 1901 move back into their initial position) the zero point is again re-referenced by means of the reference point 1909 on the reference sensor 1911.

These devices 190 for “opening” the cassettes 30, therefore for moving the movable intermediate wall 307 away from the stationary intermediate wall 305 assigned to it, are provided both in the station 210 for loading of the cassettes with packs 10 of battery plates and also in the station 70 for lug and plate straightening. Likewise there are two such devices 190 in the unloading station 280 in which the plate packs 10 are removed from the cassettes 30 and inserted into the battery cases 20.

FIGS. 77 to 79 show a plate holding table 320 which is used in the supply of cassettes 30 with plate packs 10. An analogously made plate holding table 320 can also be provided in the station 280 for removing plate packs 10 (unloading station). The plate holding table 320 is mounted on a base carrier 3201 in the machine frame and is vertically adjustable against a stop by a lift drive 3203.

Since the plate packs 10 must be inserted into the cassettes 30 with a certain projection of the lugs 12, 14 into the cassettes 30, the plate packs 10, depending on the height of the plates to be inserted into the cassettes 30, project down more or less over the cassettes 30. To take into account these differences in the plate holding table 320, there are adapter plates 3205 of varied thickness. Thus it is possible to insert into the plate holding table 320 the adapter plate 3205 which corresponds with its thickness to the height of the plates to be inserted into the cassettes 30 so that it is ensured that the lugs 12, 14 on the top of the cassette 30 have the correct projection which is necessary for further treatment. Other details in this respect are described farther below with reference to FIGS. 113 to 116.

FIGS. 80 to 84 show a station 210 for loading of cassettes 30 with plate packs 10 in different working positions.

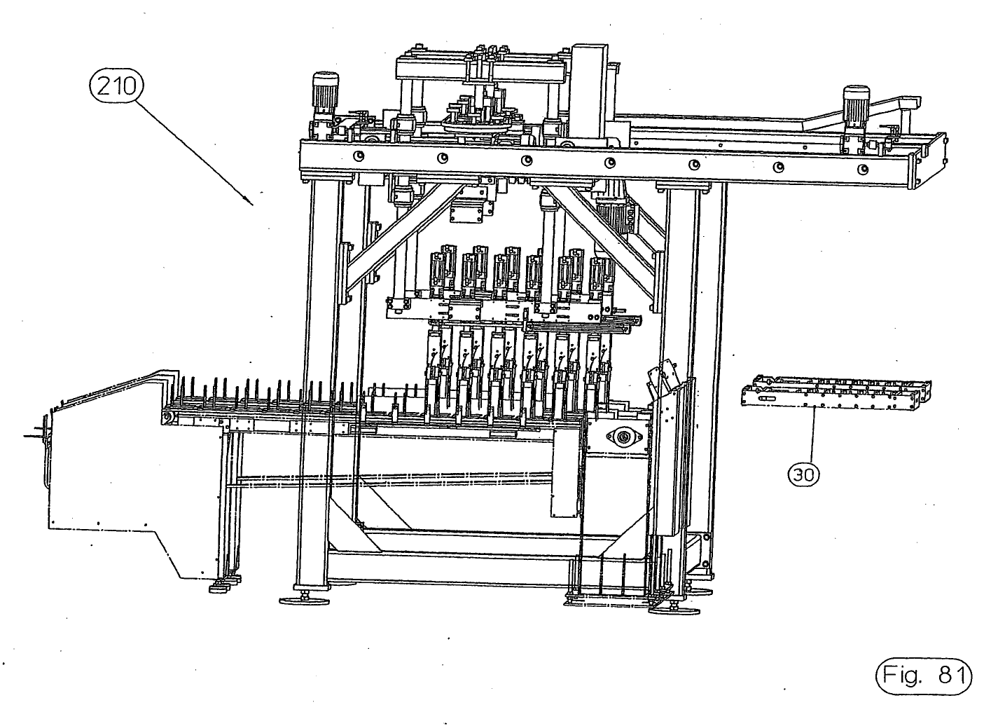

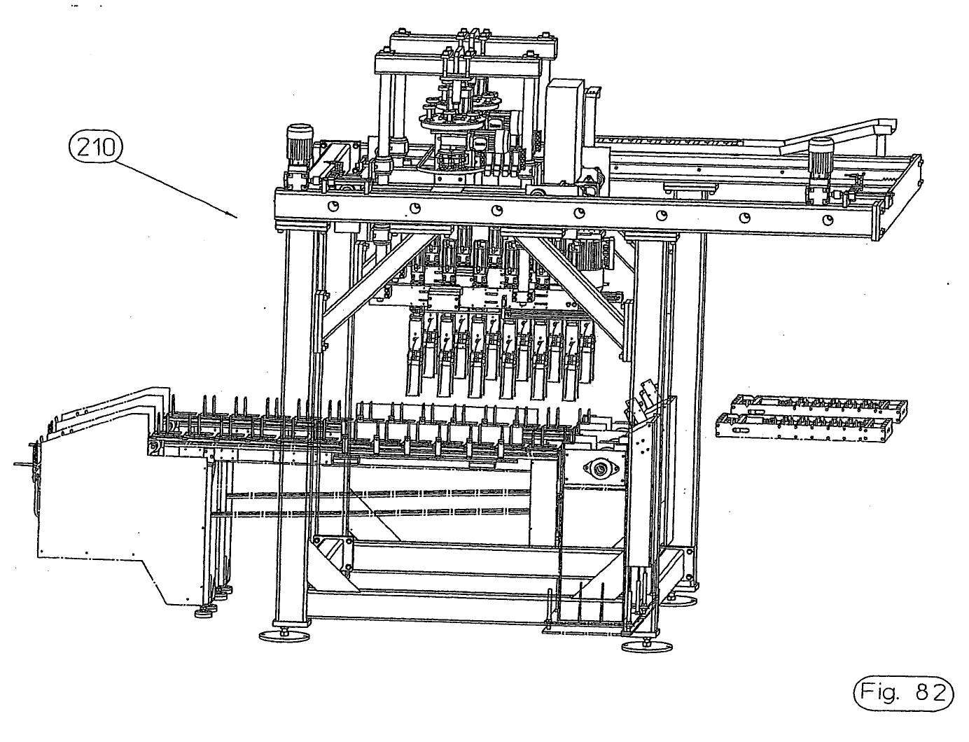

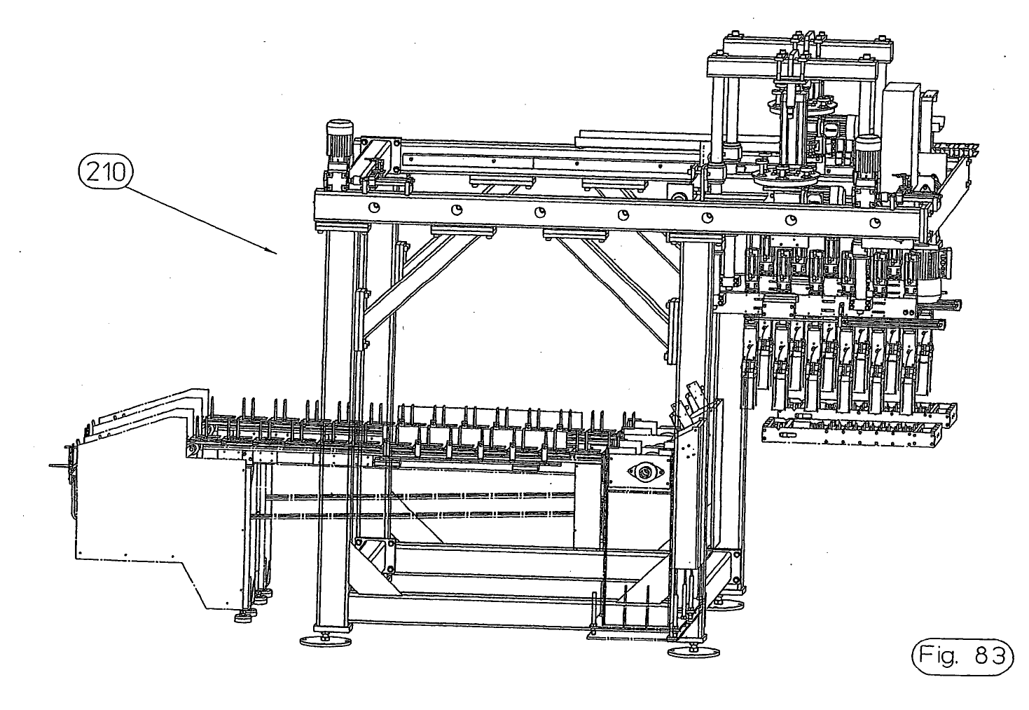

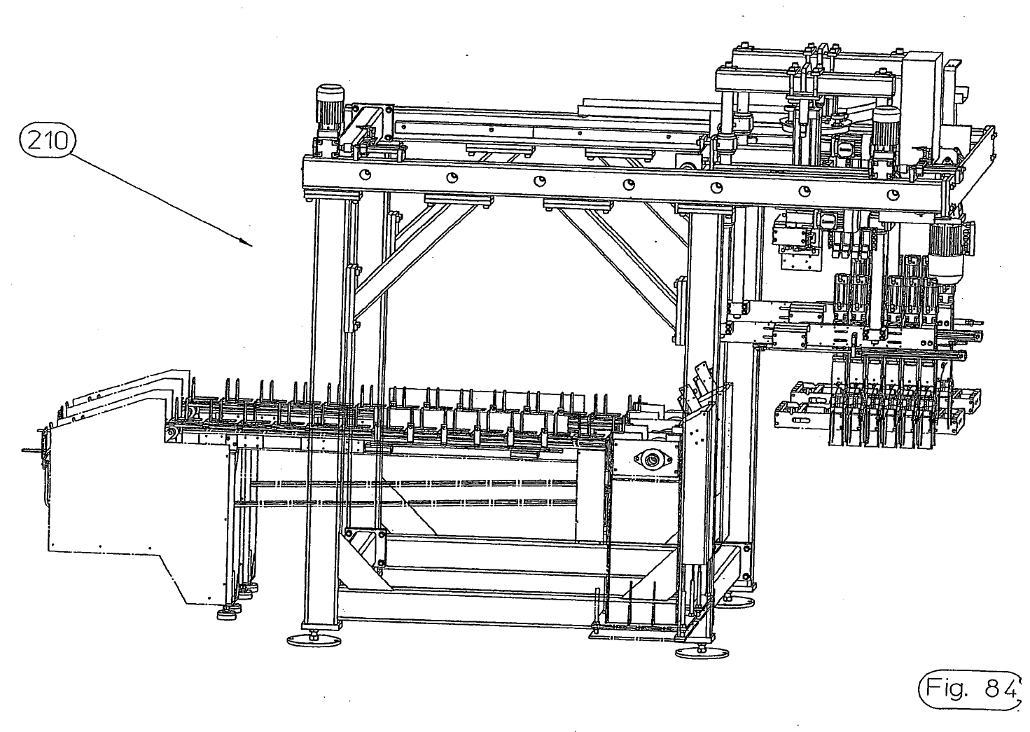

The loading station 210 in a frame 2101 has two groups of six grippers 2103 each, which groups are located next to one another, which grippers grasp packs 10 of positive and negative battery plates which have been delivered on two conveyor paths 2105 which are aligned parallel to one another, and can be inserted into prepared cassettes 30 (with “opened” intermediate walls—FIGS. 74-76). In this connection FIG. 80 shows the situation in which the grippers 2103 are located above the plate packs 10, FIG. 81 shows how the grippers 2103 are lowered in order to pick up the plate packs 10 from the two conveyor paths 2105 for plate packs 10. FIG. 82 shows the situation in which the two groups of grippers (six grippers 2103 each) have lifted the plate packs 10 from the conveyor paths 2105. FIG. 83 shows a situation in which the two groups of grippers 2103 are located in their discharge position above the cassettes 30. Finally, FIG. 84 shows the situation in which the grippers 2103 have been lowered to deposit the plate packs 10 in the cassettes 30 such that one plate pack 10 at a time is deposited in the spaces between the stationary intermediate walls 305 and the movable intermediate walls 307 which are assigned to them.

Since the spacing of the receiving spaces for plate packs 10 in the cassettes 30 which are formed in the cassettes 30 between the stationary intermediate walls 305 and the movable intermediate walls 307 is different from the distance of the plate packs 10 on the two conveyors 2105 from which the plate packs 10 are picked up by the grippers 2103, the distance of the grippers 2103 from one another is reduced before lowering into the cassettes 30, as a comparison of FIGS. 83 and 84 shows.

The cassettes 30 which have been supplied with plate packs 10 in this way are transported transversely to their lengthwise extension out of the loading station 210 to the first rotary corner transfer device 220 (FIGS. 85, 86).

When the plate packs 10 are inserted into the cassettes 30 they are located above the lift tables 320 of the design shown in FIGS. 77 to 79, the plates being moved down until their lower horizontal edges stand upright on the adapter plate 3205 which has been inserted in the lift table 320 from overhead. Afterwards the grippers 2103 are released from the plate packs 10 and the cassettes 30 are closed by the movable intermediate walls 307 being moved under the action of the helical compression springs 313 which load the movable intermediate walls 307 onto the stationary intermediate walls 305 assigned to them as the plate packs 10 are clamped.

The aforementioned first rotary corner transfer device 220 is shown in FIGS. 85 and 86. The rotary corner transfer device with “continuous conveyor motion” has a frame-like structure 2201 in which two endless conveyor chains 2203 which are driven by a motor 2205 turn, guided by rolls 2207. On these chains 2203, in particular on the upper horizontal strands thereof, cassettes 30 (from the right in FIG. 85) are delivered until the forward cassette of for example two cassettes 30 adjoins the stops 2209 projecting into the path of movement of the cassettes 30. These stops 2209 can be lowered as soon as the cassettes 30 have to be further transported. The entire frame-like structure 2201 of the rotary corner transfer device 220 of the embodiment shown in FIGS. 85 and 86 is pivotally supported in a base frame 2211, and for execution of the rotary motion (by 90° in the illustrated embodiment there can be a hydraulic cylinder 2213 (pneumatic cylinder).

As soon as the two cassettes 30 are located on the rotary corner transfer device 220 of FIGS. 85 and 86 (position according to FIG. 85) and the front cassette 30 adjoins the stops 2209, the hydraulic cylinder 2213 is actuated and the rotary corner transfer device 220 is pivoted into the position which is shown in FIG. 86. After lowering the stops 2209 the two cassettes 30 are conveyed without reversing the direction of motion of the conveyor chains 2203 (“=continuous conveyor motion”) onward into the buffer site located following the first rotary corner transfer device 220 or to the first machining station 70 (lug straightening/plate straightening).

FIGS. 93 to 97 show gripper systems 2701 as can be used in the casting station 270 (casting-on of bridges 16, 18 and pole pins 11, 13), four grippers 2703 at a time being intended for cassettes 30. Each gripper 2703 holds one cassette 30. The cassettes 30 held by the grippers 2703 of FIGS. 93 to 97 come from the fluxing and buffer station 110 and are prepared for insertion into the two casting stations 270 provided in the embodiment. For the embodiment of the casting station 270 shown in FIGS. 103 to 105 the cassettes 30 with plates with lugs 14, 16 pointing down (achieved by the turning station 90 arranged before) are placed by the gripper systems 2701 of FIGS. 93-97 on rests 2705 (stationary) and the pole pins 11, 13, flanges 17, 19 and bridges 16, 18 are cast on.

Here it is such that two grippers 2703 at a time hold cassettes 30 which are inserted into the casting station 270 and the two other grippers 2703 hold cassettes 30 which come from the casting station 270. These two other grippers 2703 deposit the cassettes 30 with battery plates to which the pole pins 11, 13, the flanges 17, 19 and the bridges 16, 18 are cast, on the buffer station and the turning station 90.

In front of the turning station 90 is the station for cleaning the castings which is shown in FIGS. 117-199. In this turning device 90 the cassettes 30 are then turned such that the lugs 12, 14 which are now interconnected by bridges 16, 18 point up.

FIGS. 117 to 119 show a device 300 for cleaning of the castings as have been produced in the casting station 270. This cleaning station 300 follows the casting station 270 (compare FIGS. 103-105) before or in the turning station 90 in which the cassettes 30 with the plates are turned again such that the bridges 16, 18, the flanges 17, 19 and pole pins 11, 13 which have been produced in the casting station 270 again point up. This casting cleaning station 300 is used to remove casting residues, scratches and the like. In this connection, brushing is done before the cassette 30 is swivelled back so that the particles which have been removed cannot fall into the cassettes 30 or between the battery plates.

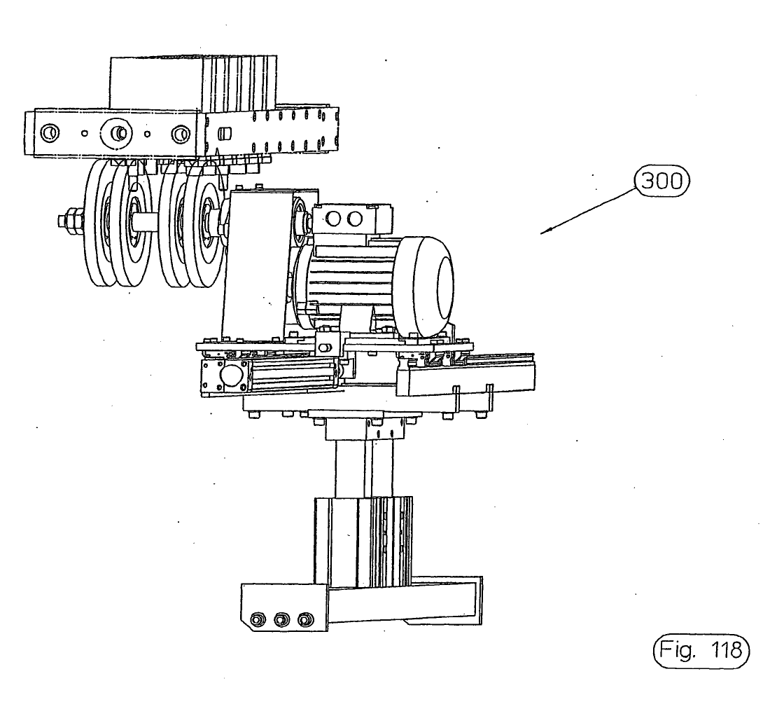

In particular, the device 300 has several, for example, four, cleaning brushes 3003 which are located on a common shaft 3001 and which are driven via a multiplication gear 3005 by an electric motor 3007. The electric motor 3007 is mounted on a carriage 3009 which can be pushed horizontally back and forth on linear guides 3011 by a hydraulic motor 3013 (pneumatic cylinder). In addition, the guide 3011 of the carriage 3009 is mounted on a lifting cylinder 3015 so that the brushes 3003 are moved out of their readiness position (FIG. 117) into their active position (FIG. 118) in which they are then moved along the guide rail 3011 (compare FIGS. 118 and 119).

FIGS. 87 and 88 shows a rotary corner transfer device 230 which is located directly in front of the unloading station in which the plate packs are inserted into battery cases. This rotary corner transfer device has a “reversing conveyor direction” and is similar in its structure to the one of FIGS. 85 and 86, however stationary stops 2301 being provided for the cassettes 30 which have been delivered on endless chain conveyors 2203 (from the left of FIG. 87). When two cassettes 30 are located on the rotary corner transfer device 230 of the embodiments of FIGS. 87 and 88 (compare FIG. 87), the superstructure 2201 of the rotary corner transfer device 230 is pivoted by the hydraulic cylinder 2213 by 90° and then the cassettes 30 are moved away from the rotary corner transfer device 230 by their being moved away from the fixed stop 2301. This means that the conveyor direction of the endless chain conveyor 2203 is now opposite the conveyor direction when the rotary corner transfer device 230 is supplied with cassettes 30, therefore has been reversed.

FIGS. 89 to 92 show the part of the station 280 (“unloading station”) for feed (loading) of battery cases 20 with plate packs 10, on which battery cases 20 are delivered and are moved into the positions in which they are supplied with battery plate packs 10, therefore packets 10 are inserted into the compartments 22 of the battery cases 20.

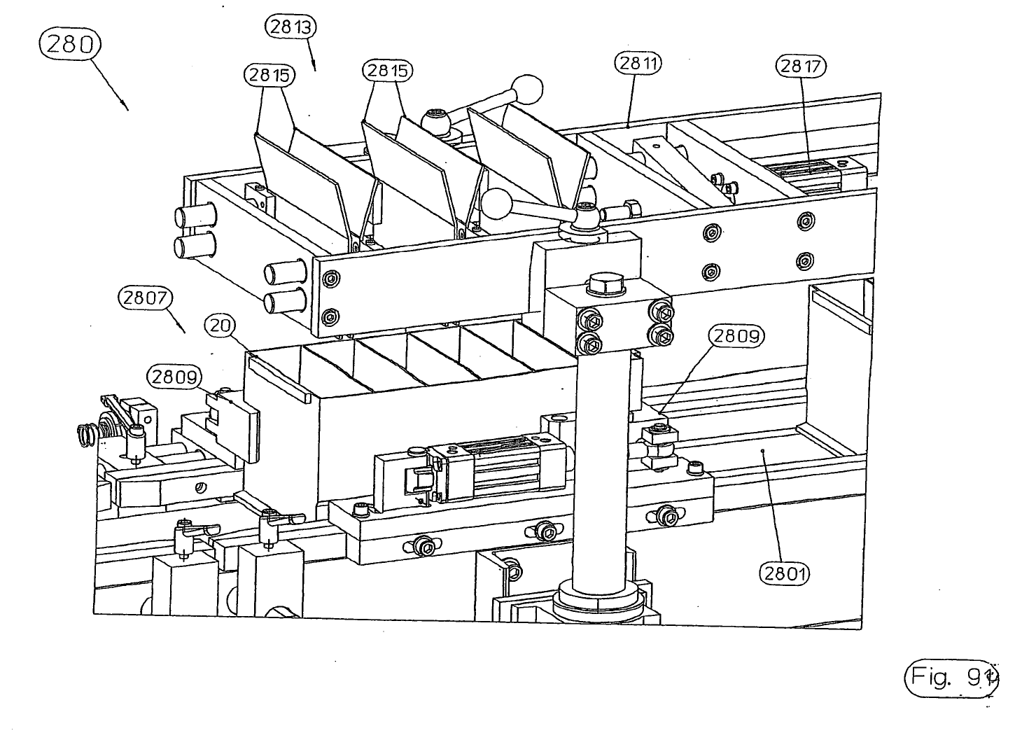

In particular, for this purpose there is a conveyor path 2801 on which in the section 2803 which lies to the left in FIG. 89 the delivered battery cases 20 are separated from one another so that they are moved onward with a given distance from one another. In the illustrated embodiment there are two other sections 2805 in which in the region of the conveyor path there is one device 2807 at a time for fixing the battery cases 20. These devices 2807 comprise two angles 2809 which can be pivoted into the path of movement of the battery cases 20 and which adjoin the corners of the battery cases 20 to hold them fast, as shown in FIG. 91.

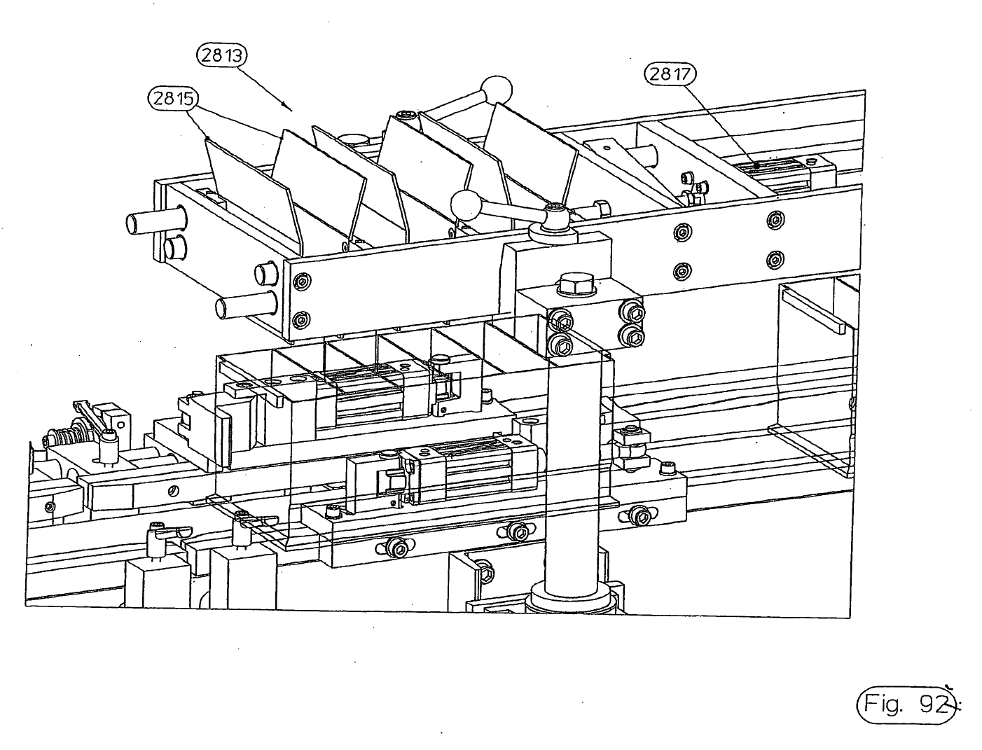

Above the battery case holder 2807 in a frame 2811 there are insertion aids 2813 which can be raised and lowered for plate packs 10 in the form of guide sheets 2815. Here the arrangement is chosen such that the guide sheets 2815 can be moved out of the base position shown in FIG. 91 using a hydraulic motor 2817 into the active position shown in FIG. 92 (i.e. the position which they assume when the plate packs 10 are inserted through the insertion aid 2813 into the compartments 22 of the battery cases 20). It is recognizable that the plate packs 10 are not inserted at the same time into all the compartments 22 of a battery case 20, as has been explained above using the embodiment of the system described in FIGS. 1 to 55 as claimed in the invention.

The devices 2807 for stopping and fixing the battery cases 20 on the conveyor path 2801 are adjustable so that they can be matched to the size of the battery cases 20.

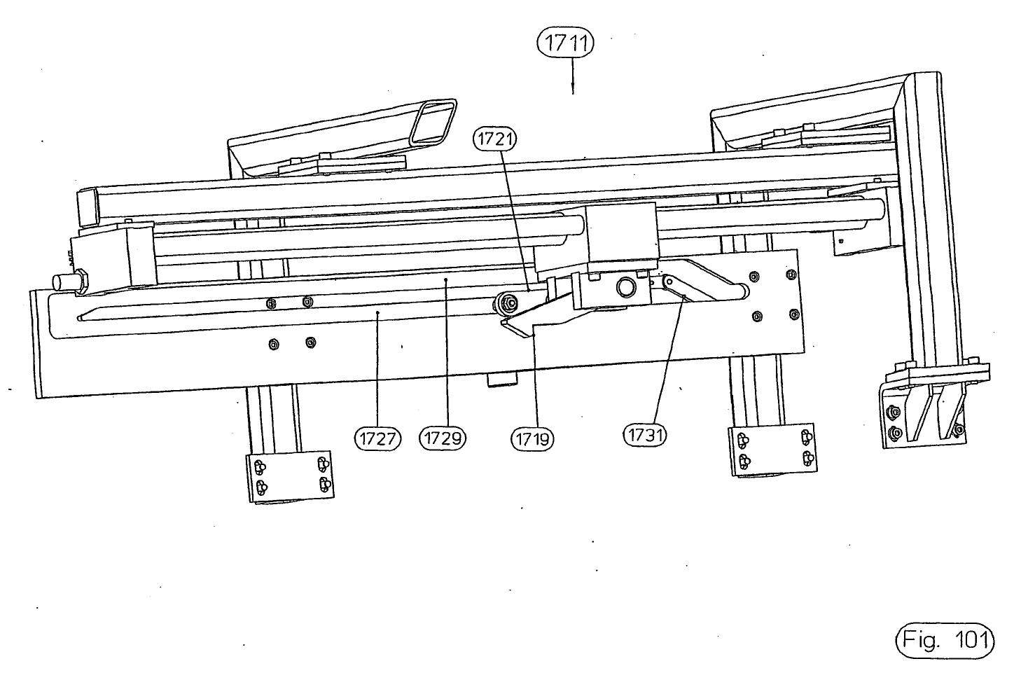

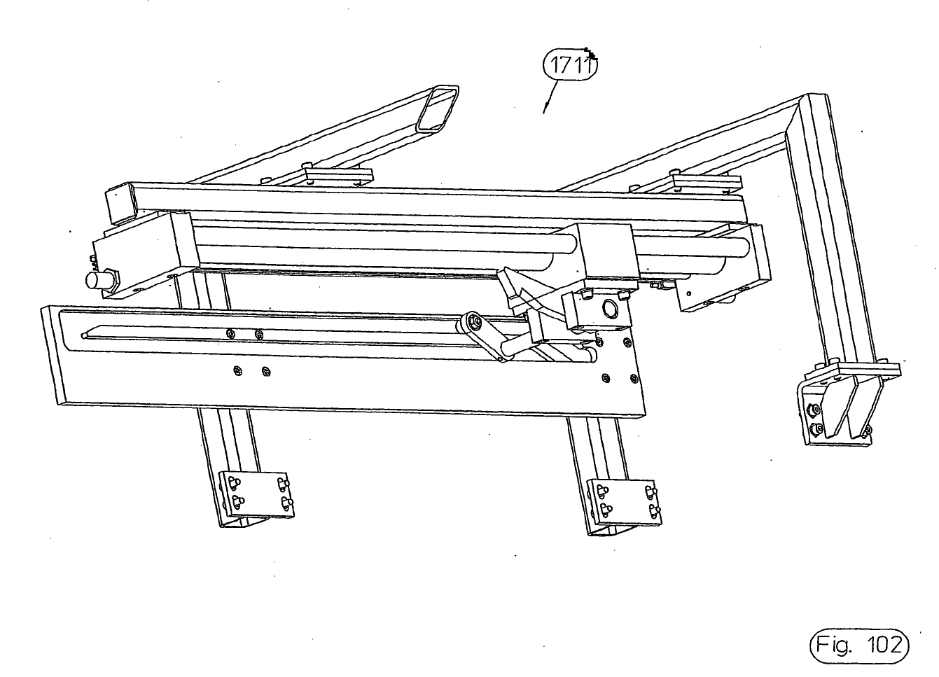

FIGS. 98 to 102 show a lifting table 330 with a plate holding table 320 at the second unloading station 280 at the start of the return conveyor segment 310 (see also FIGS. 113-116). Here cassettes 30 are delivered transversely to their lengthwise extension on the chain conveyors 1707 which are shown on the left in FIG. 98 until they are located above a roll conveyor 1701, FIG. 98 showing the position of a cassette 30 which is located in the (second) loading station 280. In the corner transfer device 330 there are two lift tables: The first lift table 320 corresponds to the one shown in FIGS. 77 to 79. After raising the lift table 320 the cassette 30 is opened, for which the device 190 shown in FIGS. 74 to 76 can be used. As soon as the cassette 30 is opened, three and three plate packs 10 at a time are removed and the cassette 30 is then closed again. The first lift table 320 is lowered and the second lift table is raised and the cassette 30 is pushed by an advance device 1711 similarly to the advance device 1711 from FIGS. 72 and 73 as shown in FIGS. 101-102 onto the return conveyor 30 for empty cassettes 30.

In this connection the different heights of plates are taken into account for example by the following measure. As mentioned above, the plates are arranged in the cassettes 30 such that they have a defined projection to the top (in order to enable casting of the bridges onto the lugs of the plates). Since the removal grippers 2825 which remove the plate packs 10 from the cassettes in order to then insert them into the battery cases 20 have only a given stroke, different plate sizes are taken into account by taller plates being raised farther than shorter plates so that “fanning our” of the plate packs by the grippers 2825 which act only in their upper region is avoided.

This further raising of taller plates can take place by the first lift table 320 which adjoins the bottom of the battery plates via its adapter plate 3205 being raised further on the second lift table by a defined distance.

For this purpose, the station which is shown in principle in FIG. 77 is equipped with another lifting cylinder which allows additional raising for larger plates.

The plate holding table 330 shown again in FIGS. 113-116 for the unloading station 280 or the lifting table (FIGS. 98-100) at the start of the return conveyor segment 310 has the following function.

In FIG. 113 the rest position is shown with the plate holding table 320 lowered.

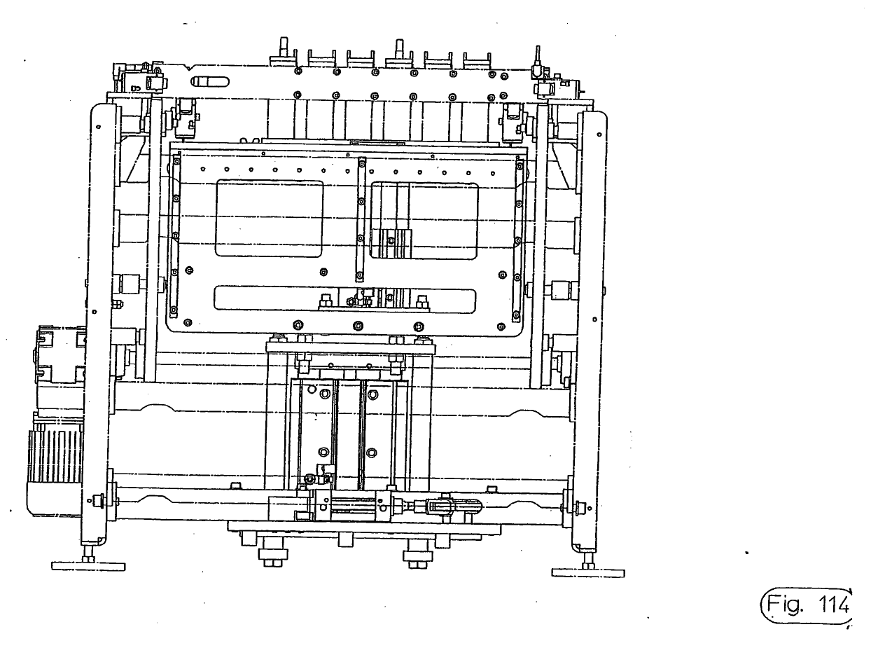

In FIG. 114 the plate holding table 320 is raised so that the cassette opener 190 (compare FIGS. 74-76) can open the cassette 30 and plate packs 10 can be taken from the unloading grippers.

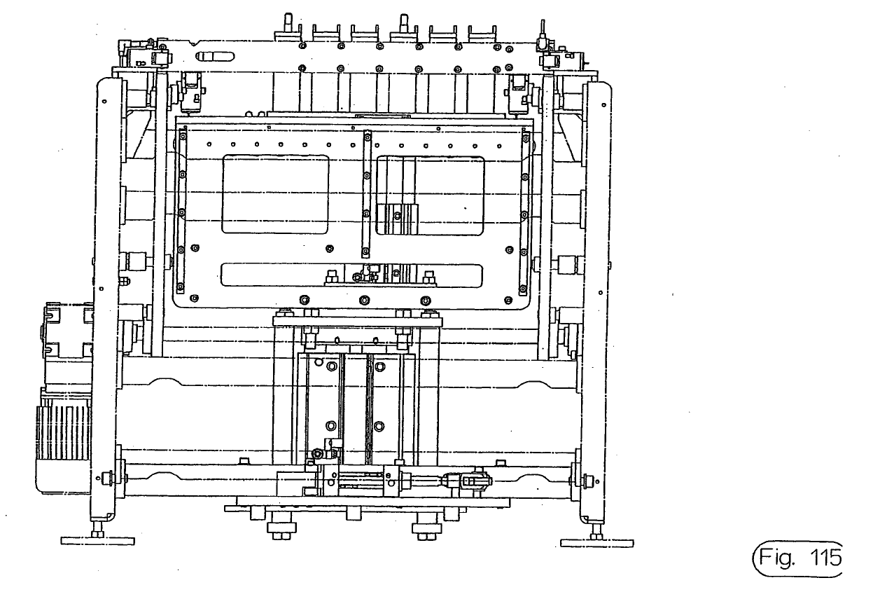

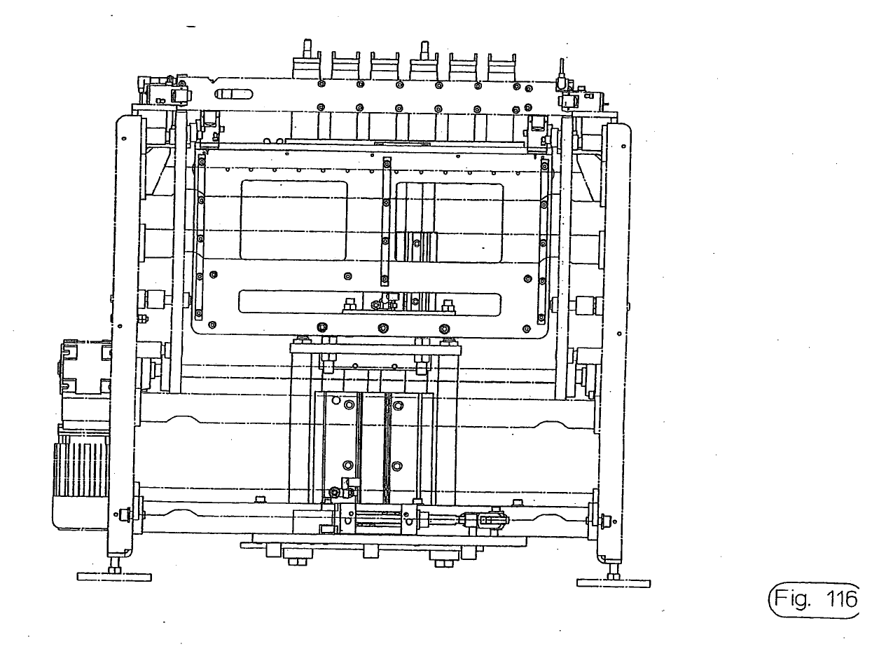

In FIG. 115 the plate holding table 320 is raised and a locking system 3207 is actuated, a locking cylinder 3210 moving the locking plates 3209 until the position as shown in FIG. 116 is reached. The locking system 3207 comprises a locking plate 3209 which can be moved by a hydraulic motor 3210. In the position of the plate 3209 as shown in FIGS. 115 and 116 the cylinder 3203 can lift the plate holding table 320 only until the stops (spacer rings) 3211 adjoin the plate 3209.

The plate 3209 is pushed by the cylinder 3210. In this way the cylinder 3203 can execute its lifting motion only until the rod attached to the movable part of the cylinder 3203 together with spacer rings 3211 stands on the plate 3209. Thus the extent of the stroke of the plate holding table 320 can be fixed exactly at the desired amount.

Finally, FIG. 116 shows the situation with the plate holding table 320 raised and for the lift table raised so far that the stop formed by the spacer rings 3211 stands on the locking plate 3209. This means that the plates in the cassette 30 can be pushed farther up by the partial stroke of the lift table.

The function of “pushing up” of the plate packs 10 proceeds especially for total plate heights starting from 123 mm. For total plate heights below 123 mm this function is not necessary. The function of “pushing up” is used (see explanations above) to ensure that the unloading grippers 2825 grasp the plate packs over a larger area and “fanning out” of the plates is avoided.

In the first unloading station 280 the function of pushing up (with the objective of the grippers 2825 reliable grasping the plate packs 10 over a large area) is performed such that two pneumatic cylinder are switched together. Depending on whether only one of the two cylinders or the two cylinders are actuated, the “pushing up” arises or does not. Therefore, in this embodiment a cylinder is used for raising the plate holding table 320 and the second cylinder is used for “pushing up”.

The structure and the function of the station 280 (“unloading station”) in which the plate packs 10 are removed from cassettes 30 and are inserted into battery cases 20 are explained below with reference to FIGS. 106 to 112.

This station 280 has two substations, specifically an “unloading station 1” 2819 and an “unloading station 2” 2821 which work synchronously. These unloading stations 2819, 2821 are located in the region of the conveyor path 2801 described using FIGS. 89 to 92 for battery cases 20, above the guide sheets 2815 which are used as insertion aids 2813 when the plate packs 10 are inserted into the compartments 22 of battery cases 20.

Each of the two unloading stations 2819 and 2821 has two sets 2823 of three grippers 2825 each which are located at an angle of 90° to one another and attached to a L-shaped carrier 2827 can move up and down in the machine frame 2829 and are arranged to be able to pivot around vertical axes. In this way the grippers 2825 of the gripper sets 2823 can be assigned in alternation to a cassette 30 which has been supplied with plate packs 10 and a battery case 20. Here the arrangement is such that the cassettes 30 which have been supplied with plates are transported on a conveyor (not shown)—transversely to their lengthwise extension (compare FIG. 106)—which is located parallel to the conveyor 2801 for the battery cases 20 (FIGS. 89 to 92).

The unloading stations 2819 and 2821 work as follows:

Each set 2823 of grippers 2825 of the two unloading stations 2819 and 2821 takes a first group of three plate packs 10 from a cassette 30 and is then swivelled 90° clockwise (viewed from the top) so that the second gripper set 2823 can remove the second group of three plate packs 10 from the cassette 30. The process here is such that after pivoting the grippers 2825 of the first set 2823 the first group of three plate packs 10 is deposited into compartments 22 in a battery case 20 and at the same time a second group of three plate packs 10 in the cassettes 30 is grasped and picked up by the second gripper set 2823.

In particular the plate packs 10 of the first group of three packs 10 are inserted into compartments “1”, “3” and “5” of a battery case 20 which has six compartments 22. The plate packs 10 of the second group are then inserted into compartments “2”, “4” and “6” of a battery case 20 in a second step. In doing so it is such that the battery cases 20 are moved forward a distance before insertion of the plate packs 10 of the second group into the compartments “2”, “4” and “6” so that the grippers 2825 keep the plate packs 10 of the second group in position over the compartments “2”, “4” and “6”. These activities are performed by the sets 2823 of grippers 2825 in the unloading stations 1 and 2.

The grippers 2825 are raised and lowered by a hydraulic cylinder 2831 (pneumatic cylinder). Guide rods 2833 of the gripper sets 2823 are assigned a stop 2837 which is provided on a cross bracket 2835 and which is opposite a plate 2839 with stops 2841 of differing height. By selecting the rotary position of the plate 2839, i.e. by moving the correspondingly high stop 2841 into the position opposite the opposing stop 2843 on the cross bracket 2835, the stroke of the gripper set 2823 is determined so that it corresponds and is matched to the height of the battery plates to be inserted.

FIG. 106 shows the situation in which the second set 2823 of grippers 2835 of the two unloading stations 2819, 2821 is ready to deposit the plate packs 10 held by its grippers 2825 into the compartments “2”, “4”, and “6” of a battery case 20, in the battery case the plate packs 10 having already been inserted in the compartments “1”, “3” and “5”.

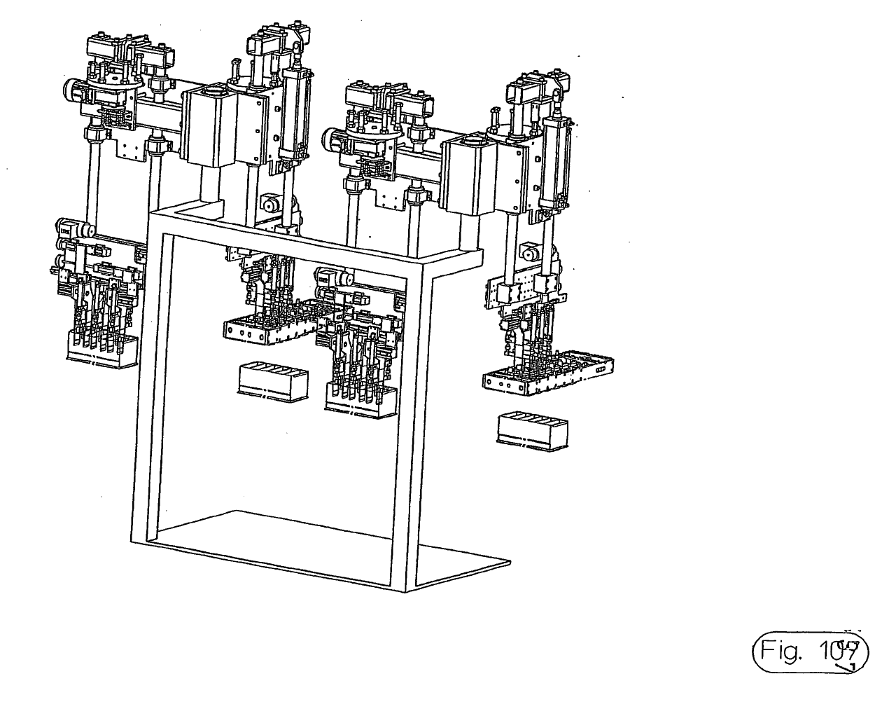

FIG. 107 shows the situation with the lowered gripper sets 2823, the first gripper sets 2823 of the unloading station 2819, 2821 being ready to pick up the first groups of three plate packs 10 each from prepared cassettes 30. At the same time, plate packs 10 are deposited into compartments “2”, “4” and “6” of the battery cases 20 by the two gripper sets 2823 of the unloading stations 2819, 2821.

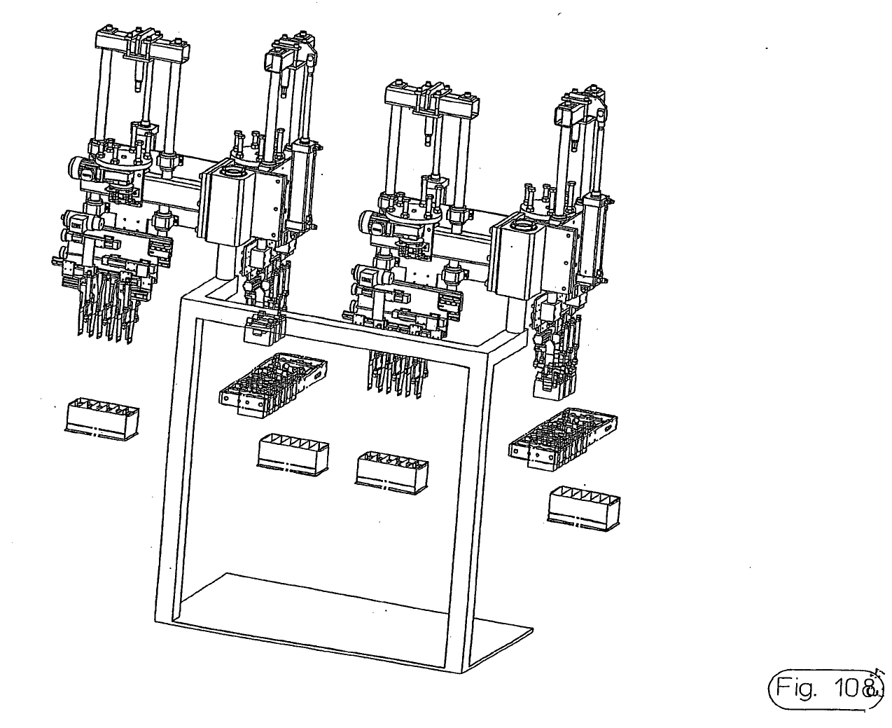

FIG. 108 shows the situation in which the two gripper sets 2823 of the two unloading stations 2819, 2821 are raised and the first gripper sets 2823 of the first groups of three plate packs 10 each have been removed from the cassettes 30. It is also apparent in FIG. 108 that the battery cases 20 located under the second gripper sets 2823 already contain plate packs 10 in all compartments 22.

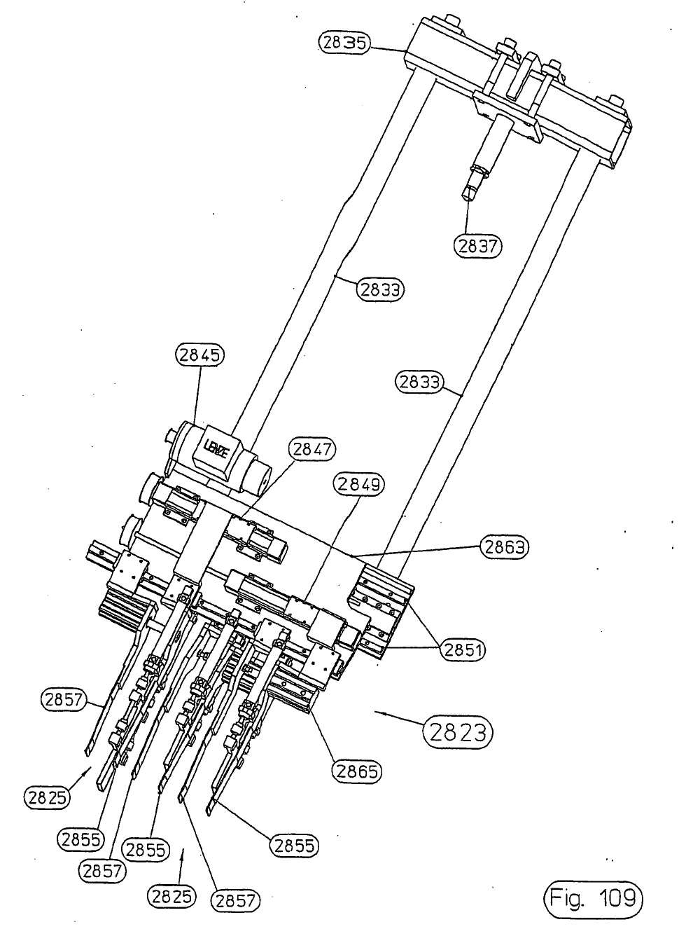

FIG. 109 using the example of a gripper set 2823 shows that the distance of its grippers 2825 can be matched to the different spacing of the distance of the plate packs 10 from one another in the cassette 30 on the one hand and the battery case 20 on the other.

In order to match the position of the grippers 2825 of each gripper set 2823 to one another when loading a battery case 20 with plate packs 10 to the spacing of the compartments 22 in the battery case 20, there is a drive motor 2845 which drives via a belt drive two linear drives 2847, 2849 which are coupled to the grippers 2825 of the set of 2823 of three grippers 2825 which are the outer ones at the time. In this connection it is such that the middle gripper 2825 of each gripper set 2923 is stationary. Depending on the direction of rotation of the output motor 2845 the outer grippers 2825 are moved toward one another or away from one another.

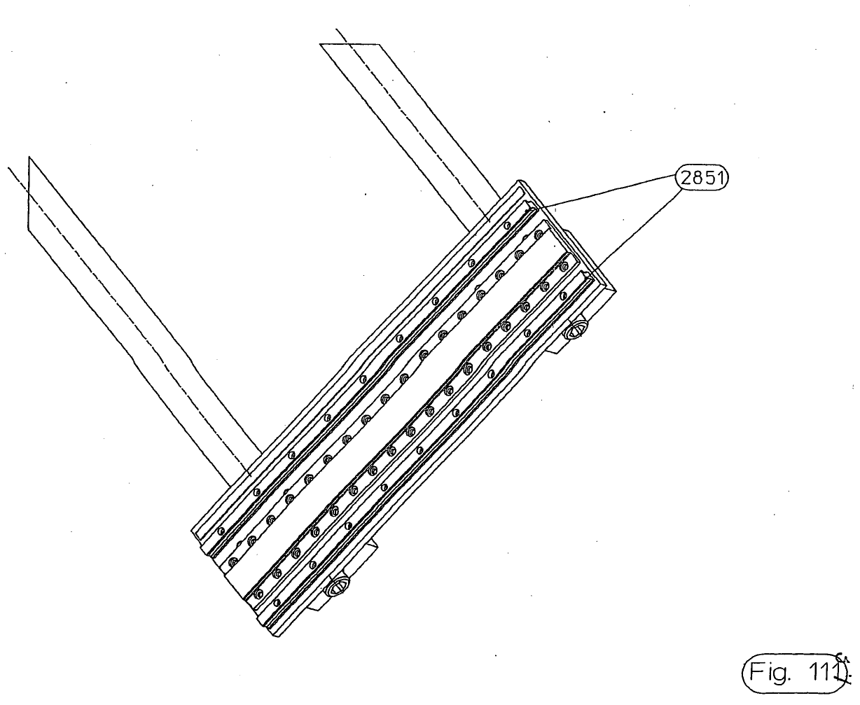

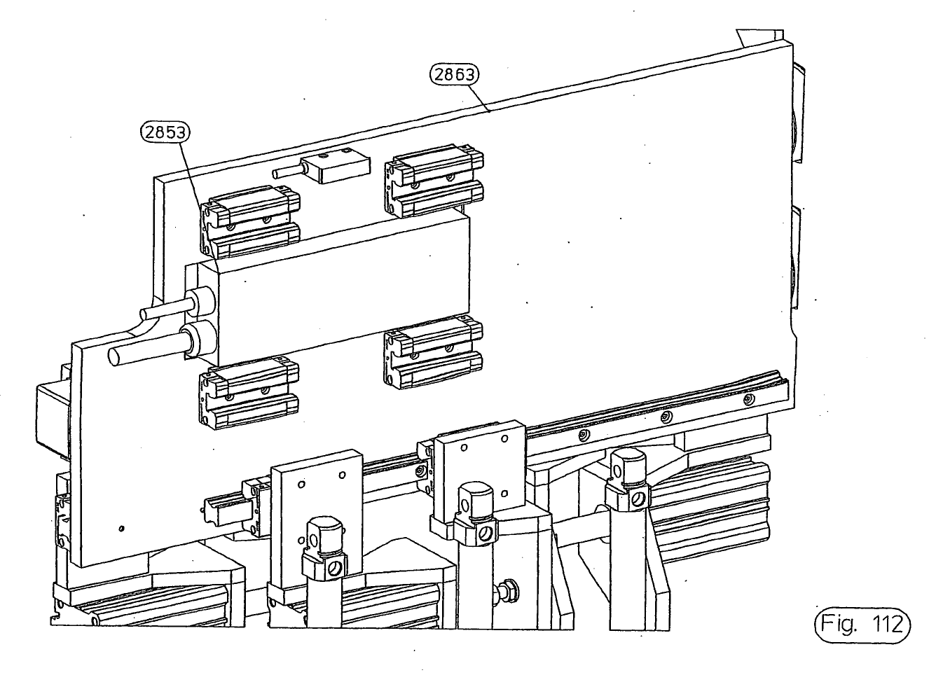

So that the alignment of the middle gripper 2825 of the three grippers 2825 of each set 2823 to the location of the middle compartment 22 (compartments “3” and “4”) in a battery case 20 (first of all the compartments 3 [sic], then when the battery plates are deposited the second time, compartment 4), the entire gripper set 2823 with its three grippers 2825 can be moved. To do this, the entire gripper set 2825 can be moved via its gripper holding plate 2863 on a linear guide 2851 (FIG. 111) by a linear actuator 2853 (FIG. 112).

Each gripper 2825 has a stationary gripper tongue 2855 and a movable gripper tongue 2857 which can be actuated by a linear drive 2865 (hydraulic motor), each stationary gripper tongue 2855 being assigned an ejector or hold-down 2859 which is actuated by a hydraulic cylinder 2861 in order to place them against the plate pack 10 from overhead when the grippers 2825 are raised out of the compartment 22 of the battery case 20 after the gripper 2825 is opened. Thus the plate pack 10 is held in the compartment 22 of the battery case 20.

When the plate packs 10 which are held in the cassettes 30 are grasped, the process is as follows.

After lowering the opened grippers 2825 into the cassette 30, first the stationary gripper tongues 2855 is pushed laterally by moving the gripper set 2823 until they laterally adjoin the plate pack 10. Then the movable gripper tongues 2857 are moved toward the rigid gripper tongues 2855 of each gripper 2823, the grippers 2823 therefore closed, and a plate pack 10 is clamped between the gripper tongues 2855, 2857, therefore is grasped by the gripper 2823.

Subsequently the gripper sets 2823 are raised, matching of the spacing is done, the gripper holding plate 2863 is moved to the base position using a linear actuator 2853, and the two gripper sets 2823 are pivoted by 90°. Then the grippers 2825 are lowered through the insertion aids 2813 (FIGS. 91 and 92) and the plate packs 10 are lowered into the compartments 22 of the battery case 20 which are under consideration at the time. After lowering the plate packs 10 into the compartments 22 of the battery case 20, the grippers 2825 are opened. This is done by the corresponding actuation of the drives 2865 for the movable gripper tongues 2857. After raising the grippers 2825, as mentioned, the retention of the plate packs 10 in the compartments 22 of the battery case 20 is ensured by the ejectors 2859 coming to rest against the cast-on bridges 16, 18 of the plate packs 10 and holding them down. Then, the grippers 2825 are moved again into their original position, i.e. the distance from one another is matched to the spacing in a cassette 30 for plate packs 10. The ejector 2859 is also now moved back again.

Within the framework of the invention, using one or more of the stations of the embodiment of the system as claimed in the invention which is shown in FIGS. 4 to 52 in the embodiment of the system as claimed in the invention which is shown in FIGS. 56 to 119 and vice versa was also considered.

In summary, one embodiment of the invention can be described as follows:

A system is described in which the bridges 16, 18 with the flanges 17, 19 for intercell connectors 24, which bridges connect the positive lugs 12 on the one hand and the negative lugs 14 on the other, are cast on the lugs 12, 14 of the positive and negative battery plates which have been combined into packs 10 after pretreatment of the lugs 12, 14 by brushing and with a flux in the casting station 270. The packs 10 of battery plates provided with bridges 16, 18 are inserted in groups of three packs at a time into the compartments 22 for the cells in battery cases 20. For moving the packs 10 out of the battery plates cassettes 30 are used in which the packs 10 are held by clamping between fixed and movable intermediate walls 305, 307. In these cassettes 30 the packs 10 have been inserted such that on one lengthwise side there are only lugs 12 of positive plates and on the other lengthwise side there are only lugs 14 of negative plates.

1. Process for insertion of plate packs (10) into compartments (22) for cells in battery cases (20), characterized in that the plate packs (10) are inserted into cassettes (30), in the cassettes (30) the plate packs (10) being aligned such that the lugs (12) of positive plates are located on one lengthwise side and the lugs (14) of negative plates are located on the other lengthwise side, and that after casting the bridges (16, 18) onto the lugs (12, 14) a first group of plate packs (10) is removed from the cassettes (30) and is inserted into compartments (22) for cells in a battery case (20), and that then the second group of plate packs (10) with an alignment of plate packs (10) turned by 180° is inserted into the remaining compartments (22) for cells in the battery case (20).

2. Process as claimed in claimed in claim 1, wherein the battery case (20) is turned around a vertical axis by 180° after inserting the first group of plate packs (10) and wherein then the second group of plate packs (10) is inserted into the remaining compartments (22) of the battery case (20).

3. Process as claimed in claimed in claim 1, wherein as the first groups three plate packs (10) and as the second group likewise three plate packs (10) are inserted into the battery case (20).

4. Process as claimed in claimed in claim 2, wherein the first group of plate packs (10) is inserted into the compartments (22) for cells “1”, “3” and “5” and the second group of plate packs (10) is inserted into the compartments (22) for cells “2”, “4” and “6” of the battery case (20).

5. Process as claimed in claimed in claim 1, wherein when the plate packs (10) are inserted into compartments (22) for cells in the battery case (20) both the plate packs (10) are lowered and the battery case (20) is raised.

6. Process as claimed in claimed in claim 1, wherein the cassettes (30) for plate packs (10) are moved along an inherently closed path of movement.

7. Process as claimed in claimed in claim 6, wherein the path of movement has several, preferably four, straight segments.

8. Process as claimed in claimed in claim 7, wherein the cassettes (30) are moved (transferred) without turning around an essentially vertical axis to the segment of the path of movement which is the next segment at the time.

9. Process as claimed in claimed in claim 6, wherein the cassettes (30) in the first segment of the path of movement in which the cassettes (30) are supplied with plate packs (10) are moved parallel to their lengthwise extension.

10. Process as claimed in claimed in claim 6, wherein the cassettes (30) in the second segment of the path of movement in which the lugs (12, 14) are pretreated, especially brushed and/or fluxed, for casting and the bridges are cast on, are moved transversely to their lengthwise extension.

11. Process as claimed in claimed in claim 6, wherein the cassettes (30) for plate packs (10) in the third segment of the path of movement in which the plate packs (10) are removed from the cassettes (30) and are inserted into battery cases (20) are moved parallel to their lengthwise extension.

12. Process as claimed in claimed in claim 6, wherein the empty cassettes (30) are moved in the fourth segment of the path of movement are moved to the start of the first segment of the path of movement.

13. Process as claimed in claimed in claim 6, wherein cassettes (30) of different dimensions are kept in reserve in the fourth segment of the path of movement.

14. Process as claimed in claimed in claim 13, wherein the cassettes (30) kept in reserve in the fourth segment of the path of movement are moved to the start of the first segment when changing of cassettes (30) is being done.

15. Process as claimed in claimed in claim 6, wherein the cassettes (30) with the plate packs (10) inserted into them which are moved in the first and third segment of the path of movement with the lugs (12, 14) of the plates pointing up are turned around the horizontal axis for pretreatment of the lugs (12, 14) and for casting-on of the bridges (16, 18) so that the lugs (12, 14) in the second segment of the path of movement point down.

16. Process as claimed in claimed in claim 1, wherein the first group of three plate packs (10) and the second group of three plate packs (10) after removal from the cassette (30) and before insertion into compartments (22) for cells in the battery case (30) are pivoted in opposite directions by 90°.

17. Process as claimed in claimed in claim 16, wherein the battery cases (20) into whose compartments (22) for cells “1”, “3” and “5” plate packs (10) are inserted are moved onward on a linear conveyor in their lengthwise direction before the plate packs (10) of the second group are inserted into the compartments (22) for the cells “2”, “4” and “6” of the battery case (20).

18. Process as claimed in claimed in claim 16, wherein one group of three plate packs (10) is removed from one cassette (30) and at the same time another group of three plate packs is inserted into cells (22) of a battery case (20).

19. Process as claimed in claimed in claim 16, wherein plate packs (10) are inserted simultaneously into compartments (22) for cells “1”, “3” and “5” of two battery cases (20).

20. Process as claimed in claimed in claim 16, wherein groups of plate packs (10) are inserted simultaneously into compartments (22) for cells “2”, “4” and “6” of two battery cases (20).

21. Process as claimed in claimed in claim 16, wherein groups of plate packs (10) are simultaneously removed from two opened cassettes (30).

22. System for executing the process as claimed claim 1, characterized by an inherently closed path of movement with preferably four straight segments, by a station (60) for feed of cassettes (30) with plate packs (10) in the first segment of the path of movement, by stations (100, 110) for treatment of lugs (12, 14) before casting-on the bridges (16, 18) in the second segment of the path of movement, by a casting station (120) in the second segment of the path of movement and by a station (130) for removing plate packs (10) from cassettes (30) and for insertion of plate packs (10) in battery cases (30) in the third segment of the path of movement.

23. System as claimed in claim 22, wherein there are at least two storages (40) for cassettes (30) in the fourth segment of the path of movement.

24. System as claimed in claim 23, wherein the storages are made as bucket belt storages (40).

25. System as claimed in claim 22, wherein the station (130) provided in the third segment of the path of movement for removing plate packs (10) from cassettes (30) has two parallel transfer devices with grippers (1301).

26. System as claimed in claim 25, wherein each parallel transfer device has three grippers (1301).

27. System as claimed in claim 25, wherein each gripper (1301) has a stationary gripper tongue (1321) and a gripper tongue (1322) which can be moved parallel to it for opening and closing the gripper (1301).

28. System as claimed in claim 27, wherein the movable gripper tongue (1321) is loaded by at least one spring (1333) into the open position of the gripper (1301).

29. System as claimed in claim 27, wherein there is a linearly adjustable wedge (1351) to move the movable gripper tongue (1322) into the closed position of the gripper (1301) which has approached the stationary gripper tongue (1321).

30. System as claimed in claim 22, wherein the stations for pretreatment of the lugs (12, 14) before casting-on the bridges (16, 18) are a station (100) for brushing the lugs (12, 14) and a station (110) for treating the lugs (12, 14) with flux.

31. System as claimed in claim 30, wherein in front of the stations (100, 110) for pretreating the lugs and before the station (120) for casting-on the bridges (16, 18) and the lugs (12, 14) and after the station (12) for casting-on the lugs (16, 18) there is one turning station (90) at a time in which cassettes (30) provided with plate packs (10) are turned around a horizontal axis in order to first align the lugs (12, 14) pointing down and then to align the lugs (12, 14) with the cast-on bridges (16, 18) again pointing up.

32. System as claimed in claim 22, wherein in the corner regions of the path of movement there is one corner transfer device (50) each, with which cassettes (30) are moved without turning the cassettes (30) around an essentially vertical axis out of the preceding segment into a following segment of the path of movement.

33. System as claimed in claim 22, wherein especially in the second segment of the path of movement following the station (60) for feeding cassettes (30) with plate packs (10) there is a station (70) for alignment of the plates and/or the lugs in the cassettes (30).

34. System as claimed in claim 22, wherein before the station (120) for casting the bridges (16, 18) onto the lugs (12, 14) of the plates, especially in front of the stations (100, 110) for pretreating the lugs (12, 14) there is a station (80) for bending the lug (12, 14) of each plate pack (10), which lug is the outermost at the time.

35. System as claimed in claim 34, wherein there is a station (80) for bending the lugs (12, 14) in front of the station (90) for turning the cassettes with the plate packs (10) inserted.

36. System as claimed in claim 22, wherein in the unloading stations (280) there are two sets (2823) of three grippers (2825) each on a L-shaped carrier (2827) with the capacity to pivot around a vertical axis.

37. System as claimed in claim 36, wherein in the unloading station (280) there are two arrangements with two gripper sets (2823) each, especially with three grippers each.

38. System as claimed in claim 22, wherein a hold-down (2859) is assigned to each gripper (2825).

39. System as claimed in claim 38, wherein the hold-down (2859) is assigned to the stationary gripper tongue (2855) of each gripper (2823).

40. System as claimed in claim 38, wherein the hold-down (2855) can be advanced by a linear motor (2861) when the grippers (2823) are raised.

41. System as claimed in claim 22, wherein there are corner transfer devices or rotary corner transfer devices in the system on the ends of the sections of the conveyor path.

42. System as claimed in claim 41, wherein there are rotary corner transfer devices with a continuous conveyor direction and rotary corner transfer devices with a reversing conveyor direction.

43. System as claimed in claim 41, wherein a device (1711) for sliding the cassettes (30) on or for withdrawing them is assigned to the corner transfer devices.

44. System as claimed in claim 43, wherein the device (111) has a catch (1719) which acts on the cassette (30).

45. System as claimed in claim 44, wherein a control means (1721) which pivots the catch up in a return stroke is assigned to the catch (1719).

46. System as claimed in claim 22, wherein in the station for loading of cassettes (30) with plate packs (10), in the station for alignment of the plates in the cassettes (30) and at least in the station for removing the plate packs (10) from cassettes (30) there is a plate holding table.

47. System as claimed in claim 46, wherein the plate holding table has a detachable adapter plate.

48. System as claimed in claim 47, wherein there is a set of adapter plates of different thicknesses.

49. System as claimed in claim 22, wherein in the station for feeding battery cases (20) with plate packs (10) there is a conveyor device for battery cases (20) to which four means for holding the battery cases fast are assigned.

50. System as claimed in claim 49, wherein above each means for holding the battery cases fast on the conveyor device there are insertion aids (2813) for plate packs (10).

51. Cassette for use in execution of the process as claimed in the invention as claimed in claim 1, characterized by a frame (301) in which there are stationary intermediate walls (305) and movable intermediate walls (307), one plate pack (10) at a time being held fast by clamping between one stationary intermediate wall (305) and one movable intermediate wall (307) at a time.

52. Cassette as claimed in claim 51, wherein the movable intermediate walls (307) are attached to two connecting rods (309) which can be moved in the lengthwise direction of the frame (301) of the cassette (30).

53. Cassette as claimed in claim 52, wherein the connecting rods (309) are loaded by springs (301) for purposes of moving the movable intermediate walls (307) in the direction to the stationary intermediate walls (305).

54. Cassette as claimed in claim 52, wherein the connecting rods can be moved in the lengthwise direction of the frame (301) of the cassette (30).

55. Cassette as claimed in claim 51, wherein on the narrow sides of the frame (301) of the cassette (30) there are receiving openings (321, 322) for cones of the station (90) for turning the cassettes (30) around the axis which is aligned in the direction of their lengthwise extension.

56. Cassette as claimed in claim 51, wherein the springs (301) which load the connecting rods (309) are supported on an intermediate wall (331) which can be moved in the lengthwise direction of the cassette (30).

57. Cassette as claimed in claim 56, wherein the springs (313) are held in the sleeves (315) which are attached to the movable intermediate wall (331).

58. Cassette as claimed in claim 56, wherein the movable intermediate wall (331) is assigned a means for moving its position within the cassette (30).

59. Cassette as claimed in claim 58, wherein the means is a disk which can be turned, with stops (335) of different height to which a stop block (337) is assigned.
